SEQUENCE LISTING (2 sequences)

SEQ ID NO: 1 - DNA, 1471 bp, Bacillus pumilus
gacgaacgctggcggcgtgcctaatacatgcaagtcgagcgaacagaagggagcttgctcccggatgttagcggcggacgggtgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtggggtaatggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcgagagtaactgctcgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcatttagttgggcactctaaggtgactgccggtgacaaaccggaggaaggtggggatgacgtcaaatcatcatgccccttatgacctgggctacacacgtgctacaatggacagaacaaagggctgcgagaccgcaaggtttagccaatcccataaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaacctttatggagccagccgccgaaggtgggacagatgattggggtg

SEQ ID NO: 2 - DNA, 3441 bp, Bacillus pumilus
atgtttcaagatatatccccaattgaggattttactggtaacctttctcttgaattcattgattacagcctaggggatcctaagtatcctgtagcagaatcaaaagaacgtgatgtaacttactctgctccactaagagtgaaagttcgtttaattaacaaagaaactggagaagtaaaagaccaagatgtgttcatgggtgatttcccaatcatgacagacacaggtacttttatcattaacggtgcggaacgtgtaatcgtttctcagttagtacgttctccaagtgtatatttcagtggtaaagtagacaaaaacggtaaaaaaggttttactgcgactgtcattccaaaccgtggcgcatggttagaatacgaaactgatgcgaaggatgtagtctatgtacgcatcgatcgcacacgtaagttgccggttacggttcttttgcgtgctctcggcttcagctctgatcaagagattcttgacctcattggcgagaatgaatacttacgcaacacgctggaaaaagacaatacagagaatgcggataaagcacttctcgaaatctacgagcgcctccgtcctggagagccgccaactgttgaaaatgcgaaaagcctgctagactctcgcttcttcgatccgaagagatatgacctagcaaatgttggacgctacaagattaataaaaagcttcatattaaaaatagactgttcaatcaaaaattggctgaaacgttagttgaccctgaaacaggtgaaattctagcagaaaaaggtcaaattttagacagaagagttcttgataaagttcttccatacttagaaaacggcatcggatttagaaagctttatccaaatggtggcgtagtagaagatgaagtagaacttcaatctattaagatttatgcaccgtctgatcaagaaggcgagcaagtgatcaacgtgatcgggaatgcatacgtagaggaagctgtgaaaaacatcacgccttctgacatcattgcatcgatcagttacttcttcaaccttcttcatggtgtaggtgacacagatgatatcgatcaccttggtaaccgtcgcctgcgttctgtaggtgagcttctgcaaaaccaattccgtattggtttaagcagaatggagcgtgttgttcgtgaaagaatgtcgatccaagacacaaacacgatcacacctcagcaactgatcaacatccgtcctgtgatcgcttctatcaaagagttctttggtagctctcagctttctcagttcatggatcaaacaaacccgcttgctgaattgacgcacaaacgtcgtctgtcagcgcttgggcctggtggtttgacacgtgagcgtgcaggaatggaagttcgtgacgttcactactctcactatggccgtatgtgtccgattgaaacaccagagggtccaaacattggtttgatcaactctctatcttcatttgcaaaagtgaatcgtttcggctttattgaaacaccttaccgccgggttgatcctgaaacaggtaaagtgacaccgagaatcgattacttaactgctgatgaagaggataactacgttgtagcacaagcgaatgctatattaggtgaagatggttcgtttatcgatgataatatcattgctcgtttcagaggggaaaacaccgttgttcctcgaaaccgtgttgactacatggacgtttcgccaaagcaggttgtttctgcagcgacagcatgtatcccattcttagaaaacgatgactctaaccgtgctctaatgggagcgaacatgcaacgtcaggctgtgcctttgatgcagccagaatcaccgattgttggtacaggtatggagtatgtatcaggtaaagactctggtgctgctgtcatctgccgttacccaggtgttgtagaacgtgttgaagcaaaaaatatttgggttcgccgctatgaagatgtcgacggacaacaagtcaaaggaaacctagacaaatacagcttgctgaaatttgtccgctctaaccaagggacttgctacaaccagcgtccaatcgtaagtgttggagatgaagtcgtaaaaggagaaatccttgcagacggtccttcaatggaaaaaggtgaattggctctaggacgtaacgttatggtcggcttcatgacttgggacggttataactacgaggatgcgatcatcatgagtgagcgccttgtaaaagatgacgtctacacatctattcatattgaagaatatgaatcagaagctcgtgatacaaagcttggaccggaagaaatcactcgtgatattccaaacgttggggaagatgctttgcgcaaccttgacgagcgtggaatcatccgtattggtgcagaagtaaaagacggagaccttcttgtagggaaagtaacgcctaaaggtgtaacagaactaacagctgaagaacgtctattacatgcaatcttcggtgaaaaggctcgtgaagtacgtgatacatctctacgtgttccacacggcggcggcggaattatccacgacgtcaaagtctttaaccgtgaagatggagatgaattacctccaggtgttaaccagttagtccgcgtatacatcgttcagaagcgtaaaatttctgaaggtgacaaaatggctggacgacatggtaacaaaggggttatctctaaaatccttccagaagaagatatgccgtatcttccagatggaacaccgattgatatcatgttaaaccctctaggggtaccatctcgtatgaacatcggtcaggtacttgagcttcatatgggtatggctgcacgttaccttggcatccacattgcgtcaccagtatttgatggtgcgcgtgaggaagatgtttgggaaacgcttgaagaagcaggtatgtcccgtgatgcgaaaacagtcctttatgacggtcgaactggtgaaccattcgataaccgtgtatcagtcggaatcatgtacatgatcaaactggctcacatggttgacgacaaacttcacgctcgttcaactggaccatactcacttgttacgcagcagccacttggcggtaaagcacagtttggtggtcagcgtttcggagagatggaagtatgggcacttgaagcttacggtgcagcatacacacttcaagagatcttaacagttaaatcggatgacgtggtgggtcgtgtgaaaacatacgaagccatcgtcaaaggggataacgtccctgaaccaggtgtccctgaatcattcaaagtgttaatcaaagaacttcaaagtttaggtatggatgtcaaaatcctatctggcgatgaagaagagatagaaatgagagatttagaagacgatgaggaaacgaagaaagcagacggattagcgttatctaatgacgaagatgctgcagacctcgcacctgtcgatcttgaacgtgacgcagtcacaaaagaatag

(19) United States
(12) Patent Application Publication
(10) Pub. No.: US 2016/0183532 A1
(43) Pub. Date: Jun. 30, 2016

(54) MICROBIAL COMPOSITIONS FOR USE IN COMBINATION WITH SOIL INSECTICIDES FOR BENEFITING PLANT GROWTH

(71) Applicant: FMC CORPORATION, Philadelphia, PA (US)

(72) Inventors: Safiyh Taghavi, Chapel Hill, NC (US); Daniel van der Lelie, Chapel Hill, NC (US); Mark R. Walmsley, Morristown, NJ (US); Nathan Caldwell, Morrisville, PA (US); Thomas E. Anderson, Clayton, NC (US); Vincent J. Spadafora, Yardley, PA (US); Lamar Buckelew, Davenport, IA (US)

(21) Appl. No.: 14/870,349

(22) Filed: Sep. 30, 2015

Related U.S. Application Data
(60) Provisional application No. 62/171,582, filed on Jun. 5, 2015.
(60) Provisional application No. 62/097,198, filed on Dec. 29, 2014.

(51) Int. Cl. A01N 63/00; C05G 3/02; A01N 53/00

(52) U.S. Cl. CPC A01N 63/00; A01N 53/00; C05G 3/02

(57) ABSTRACT

Compositions and methods are provided for benefiting plant growth. The compositions contain isolated bacterial or fungal strains having properties beneficial to plant growth and development that can provide beneficial growth effects when delivered in a liquid fertilizer in combination with a soil insecticide to plants, seeds, or the soil or other growth medium surrounding the plant or seed. The beneficial growth effects include one or a combination of improved seedling vigor, improved root development, improved plant health, increased plant mass, increased yield, improved appearance, improved resistance to osmotic stress, improved resistance to abiotic stresses, or improved resistance to plant pathogens. The isolated bacterial strains include those of the Bacillus species including species such as Bacillus pumilus, Bacillus licheniformis, and Bacillus subtilis.

### CROSS-REFERENCE TO RELATED APPLICATIONS

This application claims the benefit of U.S. provisional application No. 62/097,198 filed Dec. 29, 2014 and U.S. provisional application No. 62/171,582 filed Jun. 5, 2015, the disclosures of which are each hereby incorporated herein by reference in their entireties.

### TECHNICAL FIELD

The presently disclosed subject matter relates to compositions and products comprising isolated microbial strains and methods of use thereof to benefit plant growth.

### BACKGROUND OF THE INVENTION

A number of microorganisms having beneficial effects on plant growth and health are known to be present in the soil, to live in association with plants specifically in the root zone (Plant Growth Promoting Rhizobacteria “PGPR”), or to reside as endophytes within the plant. Their beneficial plant growth promoting properties include nitrogen fixation, iron chelation, phosphate solubilization, inhibition of non-beneficial microrganisms, resistance to pests, Induced Systemic Resistance (ISR), Systemic Acquired Resistance (SAR), decomposition of plant material in soil to increase useful soil organic matter, and synthesis of phytohormones such as indole-acetic acid (IAA), acetoin and 2,3-butanediol that stimulate plant growth, development and responses to environmental stresses such as drought. In addition, these microorganisms can interfere with a plant's ethylene stress response by breaking down the precursor molecule, 1-aminocyclopropane-1-carboxylate (ACC), thereby stimulating plant growth and slowing fruit ripening. These beneficial microorganisms can improve soil quality, plant growth, yield, and quality of crops. Various microorganisms exhibit biological activity such as to be useful to control plant diseases. Such biopesticides (living organisms and the compounds naturally produced by these organisms) can be safer and more biodegradable than synthetic fertilizers and pesticides.

Fungal phytopathogens, including but not limited to Botrytis spp. (e.g. Botrytis cinerea), Fusarium spp. (e.g. F. oxysporum and F. graminearum), Rhizoctonia spp. (e.g. R. solani), Magnaporthe spp., Mycosphaerella spp., Puccinia spp. (e.g. P. recondita), Phytopthora spp. and Phakopsora spp. (e.g. P. pachyrhizi), are one type of plant pest that can cause severe economic losses in the agricultural and horticultural industries. Chemical agents can be used to control fungal phytopathogens, but the use of chemical agents suffers from disadvantages including high cost, lack of efficacy, emergence of resistant strains of the fungi, and undesirable environmental impacts. In addition, such chemical treatments tend to be indiscriminant and may adversely affect beneficial bacteria, fungi, and arthropods in addition to the plant pathogen at which the treatments are targeted. A second type of plant pest are bacterial pathogens, including but not limited to Erwinia spp. (such as Erwinia chrysanthemi), Pantoea spp. (such as P. citrea), Xanthomonas (e.g. Xanthomonas campestris), Pseudomonas spp. (such as P. syringae) and Ralstonia spp. (such as R. soleacearum) that cause severe economic losses in the agricultural and horticultural industries. Similar to pathogenic fungi, the use of chemical agents to treat these bacterial pathogens suffers from disadvantages. Viruses and virus-like organisms comprise a third type of plant disease-causing agent that is hard to control, but to which bacterial microorganisms can provide resistance in plants via induced systemic resistance (ISR). Thus, microorganisms that can be applied as biofertilizer and/or biopesticide to control pathogenic fungi, viruses, and bacteria are desirable and in high demand to improve agricultural sustainability. A final type of plant pathogen includes plant pathogenic nematodes and insects, which can cause severe damage and loss of plants.

Some members of the species Bacillus have been reported as biocontrol strains, and some have been applied in commercial products (Kloepper, J. W. et al., Phytopathology Vol. 94, No. 11, 2004 1259-1266). For example, strains currently being used in commercial biocontrol products include: Bacillus pumilus strain QST2808, used as active ingredient in SONATA and BALLAD-PLUS, produced by BAYER CROP SCIENCE; Bacillus pumilus strain GB34, used as active ingredient in YIELDSHIELD, produced by BAYER CROP SCIENCE; Bacillus subtilis strain QST713, used as the active ingredient of SERENADE, produced by BAYER CROP SCIENCE; Bacillus subtilis strain GBO3, used as the active ingredient in KODIAK and SYSTEM3, produced by HELENA CHEMICAL COMPANY. Various strains of Bacillus thuringiensis and Bacillus firmus have been applied as biocontrol agents against nematodes and vector insects and these strains serve as the basis of numerous commercially available biocontrol products, including NORTICA and PONCHO-VOTIVO, produced by BAYER CROP SCIENCE. In addition, Bacillus strains currently being used in commercial biostimulant products include: Bacillus amyloliquefaciens strain FZB42 used as the active ingredient in RHIZOVITAL 42, produced by ABiTEP GmbH, as well as various other Bacillus subtilis species that are included as whole cells including their fermentation extract in biostimulant products, such as FULZYME produced by JHBiotech Inc.

The presently disclosed subject matter provides microbial products, compositions and methods for their use in benefiting plant growth.

### SUMMARY OF THE INVENTION

In one embodiment of the present invention a composition is provided for benefiting plant growth, the composition comprising: a biologically pure culture of a bacterial or a fungal strain having properties beneficial to plant growth and one or more microbial or chemical pesticides, in a formulation suitable as a liquid fertilizer, wherein each of the bacterial or fungal strains and the one or more microbial or chemical pesticide is present in an amount suitable to benefit plant growth.

In one embodiment of the present invention a composition is provided for benefiting plant growth, the composition comprising: a biologically pure culture of a bacterial or a fungal strain having properties beneficial to plant growth and a soil insecticide in a formulation suitable as a liquid fertilizer, wherein each of the bacterial or fungal strains and the soil insecticide is present in an amount suitable to benefit plant growth.

In one embodiment of the present invention a composition is provided, the composition comprising: a) a biologically pure culture of a bacterial strain having plant growth promoting properties; and b) at least one pesticide, wherein the composition is in a formulation compatible with a liquid fertilizer.

In one embodiment of the present invention a product is provided, the product comprising: a first component comprising a first composition having a biologically pure culture of a bacterial or a fungal strain having properties beneficial to plant growth; a second component comprising a second composition having a soil insecticide, wherein the first and second components are separately packaged, wherein each component is in a formulation suitable as a liquid fertilizer, and wherein each component is in an amount suitable to benefit plant growth; and instructions for delivering in a liquid fertilizer and in an amount suitable to benefit plant growth, a combination of the first and second compositions to: seed of the plant, roots of the plant, a cutting of the plant, a graft of the plant, callus tissue of the plant; soil or growth medium surrounding the plant; soil or growth medium before sowing seed of the plant in the soil or growth medium; or soil or growth medium before planting the plant, the plant cutting, the plant graft, or the plant callus tissue in the soil or growth medium.

In one embodiment of the present invention a product is provided, the product comprising: a first container containing a first composition comprising a biologically pure culture of a bacterial strain having plant growth promoting properties; and a second container containing a second composition comprising at least one pesticide, wherein each of the first and second compositions is in a formulation compatible with a liquid fertilizer.

In one embodiment of the present invention a method is provided for benefiting plant growth, the method comprising: delivering to a plant in a liquid fertilizer a composition having a growth promoting microorganism and a soil insecticide, wherein the composition comprises: a biologically pure culture of a bacterial or a fungal strain having properties beneficial to plant growth and a soil insecticide in a formulation suitable as a liquid fertilizer, wherein each of the bacterial or fungal strains and the soil insecticide is present in an amount sufficient to benefit plant growth, wherein the composition is delivered in the liquid fertilizer in an amount suitable for benefiting plant growth to: seed of the plant, roots of the plant, a cutting of the plant, a graft of the plant, callus tissue of the plant, soil or growth medium surrounding the plant, soil or growth medium before sowing seed of the plant in the soil or growth medium, or soil or growth medium before planting the plant, the plant cutting, the plant graft, or the plant callus tissue in the soil or growth medium.

In one embodiment of the present invention a method is provided for benefiting plant growth, the method comprising: delivering in a liquid fertilizer in an amount suitable for benefiting plant growth a combination of: a first component comprising a first composition having a biologically pure culture of a bacterial or a fungal strain having properties beneficial to plant growth; and a second component comprising a second composition having a soil insecticide, wherein each component is in a formulation suitable as a liquid fertilizer and wherein each component is in an amount suitable to benefit plant growth, and wherein the combination is delivered to: seed of the plant, roots of the plant, a cutting of the plant, a graft of the plant, callus tissue of the plant; soil or growth medium surrounding the plant; soil or growth medium before sowing seed of the plant in the soil or growth medium; or soil or growth medium before planting the plant, the plant cutting, the plant graft, or the plant callus tissue in the soil or growth medium.

In one embodiment of the present invention a method for benefiting plant growth is provided, the method comprising delivering to a plant or a part thereof in a liquid fertilizer a composition comprising: a) a biologically pure culture of a bacterial strain having plant growth promoting properties, and b) a soil insecticide, wherein each of the bacterial strain and the soil insecticide is present in an amount sufficient to benefit plant growth, wherein the composition is delivered in the liquid fertilizer in an amount suitable for benefiting plant growth to: seed of the plant, roots of the plant, a cutting of the plant, a graft of the plant, callus tissue of the plant, soil or growth medium surrounding the plant, soil or growth medium before sowing seed of the plant in the soil or growth medium, or soil or growth medium before planting the seed of the plant, the plant cutting, the plant graft, or the plant callus tissue in the soil or growth medium.

In one embodiment of the present invention a composition is provided for benefiting plant growth, the composition comprising: a biologically pure culture of spores of Bacillus pumilus RTI279 deposited as PTA-121164 and a bifentrhin insecticide in a formulation suitable as a liquid fertilizer, wherein each of the Bacillus pumilus RTI279 and the bifenthrin insecticide is present in an amount suitable to benefit plant growth.

In one embodiment of the present invention a composition is provided for benefiting plant growth, the composition comprising: a biologically pure culture of spores of Bacillus licheniformis CH200 deposited as accession No. DSM 17236 and a bifentrhin insecticide in a formulation suitable as a liquid fertilizer, wherein each of the Bacillus licheniformis CH200 and the bifentrhin insecticide is present in an amount suitable to benefit plant growth.

In one embodiment of the present invention a product is provided, the product comprising: a first composition having a biologically pure culture of spores of Bacillus licheniformis CH200 deposited as accession No. DSM 17236; a second composition having a bifenthrin insecticide formulated as a liquid fertilizer, wherein the first and second compositions are separately packaged, and wherein each component is in an amount suitable to benefit plant growth; and instructions for delivering in a liquid fertilizer and in an amount suitable to benefit plant growth, a combination of the first and second compositions to: seed of the plant, roots of the plant, a cutting of the plant, a graft of the plant, callus tissue of the plant; soil or growth medium surrounding the plant; soil or growth medium before sowing seed of the plant in the soil or growth medium; or soil or growth medium before planting the plant, the plant cutting, the plant graft, or the plant callus tissue in the soil or growth medium.

In one embodiment of the present invention a product is provided, the product comprising: a first composition having a biologically pure culture of spores of Bacillus pumilus RTI279 deposited as PTA-121164; a second composition having a bifenthrin insecticide formulated as a liquid fertilizer, wherein the first and second compositions are separately packaged, and wherein each component is in an amount suitable to benefit plant growth; and instructions for delivering in a liquid fertilizer and in an amount suitable to benefit plant growth, a combination of the first and second compositions to: seed of the plant, roots of the plant, a cutting of the plant, a graft of the plant, callus tissue of the plant; soil or growth medium surrounding the plant; soil or growth medium before sowing seed of the plant in the soil or growth medium; or soil or growth medium before planting the plant, the plant cutting, the plant graft, or the plant callus tissue in the soil or growth medium.

In one embodiment of the present invention a method is provided for benefiting plant growth, the method comprising: delivering to a plant in a liquid fertilizer a composition having a growth promoting microorganism and a soil insecticide, wherein the composition comprises: spores of a biologically pure culture of a Bacillus pumilus RTI279 deposited as PTA-121164 and a bifenthrin insecticide in a formulation suitable as a liquid fertilizer, wherein each of the Bacillus pumilus RTI279 and the bifenthrin insecticide is present in an amount sufficient to benefit plant growth, wherein the composition is delivered in the liquid fertilizer in an amount suitable for benefiting plant growth to: seed of the plant, roots of the plant, a cutting of the plant, a graft of the plant, callus tissue of the plant, soil or growth medium surrounding the plant, soil or growth medium before sowing seed of the plant in the soil or growth medium, or soil or growth medium before planting the plant, the plant cutting, the plant graft, or the plant callus tissue in the soil or growth medium.

In one embodiment of the present invention a method is provided for benefiting plant growth, the method comprising: delivering to a plant in a liquid fertilizer a composition having a growth promoting microorganism and a soil insecticide, wherein the composition comprises: spores of a biologically pure culture of a Bacillus licheniformis CH200 deposited as accession No. DSM 17236 and a bifenthrin insecticide in a formulation suitable as a liquid fertilizer, wherein each of the Bacillus licheniformis CH200 and the bifenthrin insecticide is present in an amount sufficient to benefit plant growth, wherein the composition is delivered in the liquid fertilizer in an amount suitable for benefiting plant growth to: seed of the plant, roots of the plant, a cutting of the plant, a graft of the plant, callus tissue of the plant, soil or growth medium surrounding the plant, soil or growth medium before sowing seed of the plant in the soil or growth medium, or soil or growth medium before planting the plant, the plant cutting, the plant graft, or the plant callus tissue in the soil or growth medium.

In one embodiment of the present invention a method is provided for benefiting plant growth, the method comprising: delivering in a liquid fertilizer in an amount suitable for benefiting plant growth a combination of: a first composition having a biologically pure culture of Bacillus licheniformis CH200 deposited as accession No. DSM 17236; and a second composition having a bifenthrin insecticide, wherein each composition is in a formulation suitable as a liquid fertilizer and wherein each component is in an amount suitable to benefit plant growth, and wherein the combination is delivered to: seed of the plant, roots of the plant, a cutting of the plant, a graft of the plant, callus tissue of the plant; soil or growth medium surrounding the plant; soil or growth medium before sowing seed of the plant in the soil or growth medium; or soil or growth medium before planting the plant, the plant cutting, the plant graft, or the plant callus tissue in the soil or growth medium.

In one embodiment of the present invention a method is provided for benefiting plant growth, the method comprising: delivering in a liquid fertilizer in an amount suitable for benefiting plant growth a combination of: a first composition having a biologically pure culture of Bacillus pumilus RTI279 deposited as PTA-121164; and a second composition having a bifenthrin insecticide, wherein each composition is in a formulation suitable as a liquid fertilizer and wherein each component is in an amount suitable to benefit plant growth, and wherein the combination is delivered to: seed of the plant, roots of the plant, a cutting of the plant, a graft of the plant, callus tissue of the plant; soil or growth medium surrounding the plant; soil or growth medium before sowing seed of the plant in the soil or growth medium; or soil or growth medium before planting the plant, the plant cutting, the plant graft, or the plant callus tissue in the soil or growth medium.

### BRIEF DESCRIPTION OF THE DRAWINGS

FIGS. 1A-1D show A) a schematic diagram of the genomic organization surrounding and including the osmotic stress response operon found in Bacillus pumilus strain RTI279 as compared to the corresponding regions for two Bacillus pumilus reference strains, ATCC7061 and SAFR-032 according to one or more embodiments of the present invention. B) A legend showing the gene name abbreviations; C) a legend indicating the percentage degree of amino acid identity of the proteins encoded by the genes of the RTI279 strain as compared to the two reference strains (the exact percent identity is represented numberically underneath each arrow symbol in (A)); and D) an enlarged version of the osmotic stress response operon inset from (A).

FIG. 2 shows photographs showing the positive effects on root hair development in soybean seedlings after inoculation of seed with Bacillus pumilus strain RTI279 at B) 1.04×10⁶ CFU/ml; C) 1.04×10⁵ CFU/ml; and D) 1.04×10⁴ CFU/ml after 7 days of growth as compared to untreated control A) according to one or more embodiments of the present invention.

FIGS. 3A-3B are bar graphs showing a comparison of the average seminal root length per corn plant 12 days after planting corn seeds treated with spores of a growth promoting bacterial strain in combination with an insecticide and a liquid fertilizer as compared to unfertilized seeds in each of Pennington soil and Midwestern soil soil types according to one or more embodiments of the present invention. Insecticide plus liquid fertilizer and liquid fertilizer alone treatments are also shown. The negative effect observed in the graph is a temporary negative effect resulting from osmotic stress after the fertilizer has been applied to the seed. A) At planting seeds were simultaneously treated with liquid fertilizer alone (Fertilizer); chemical insecticide CAPTURE LFR+liquid fertilizer (CAPTURE LFR+Fertilizer); chemical insecticide CAPTURE LFR+liquid fertilizer+RTI279 at 6.25×10⁹ CFU (RTI279 (low rate)); chemical insecticide CAPTURE LFR+liquid fertilizer+RTI279 at 1.25×10¹¹ CFU (RTI279 (mid rate)); and chemical insecticide CAPTURE LFR+liquid fertilizer+RTI279 at 2.5×10¹² CFU (RTI279 (high rate)). B) At planting seeds were simultaneously treated with liquid fertilizer alone (Fertilizer); chemical insecticide CAPTURE LFR+liquid fertilizer (CAPTURE LFR+Fertilizer); chemical insecticide CAPTURE LFR+liquid fertilizer+CH200 at 2.5×10¹² CFU (CH200); chemical insecticide CAPTURE LFR+liquid fertilizer+CH201 at 2.5×10¹² CFU (CH201); and chemical insecticide CAPTURE LFR+liquid fertilizer+CH200+CH201 at 2.5×10¹² CFU (CH200+CH201).

FIGS. 4A-4B are bar graphs showing a comparison of the average nodal root length per corn plant 12 days after planting corn seeds treated with spores of a growth promoting bacterial strain in combination with an insecticide and a liquid fertilizer as compared to unfertilized seeds in each of Pennington soil and Midwestern soil soil types according to one or more embodiments of the present invention. Insecticide plus liquid fertilizer and liquid fertilizer alone treatments are also shown. The negative effect observed in the graph is a temporary negative effect resulting from osmotic stress after the fertilizer has been applied to the seed. A) At planting seeds were simultaneously treated with liquid fertilizer alone (Fertilizer); chemical insecticide CAPTURE LFR+liquid fertilizer (CAPTURE LFR+Fertilizer); chemical insecticide CAPTURE LFR+liquid fertilizer+RT1279 at 6.25×10⁹ CFU (RT1279 (low rate)); chemical insecticide CAPTURE LFR+liquid fertilizer+RT1279 at 1.25×10¹¹ CFU (RT1279 (mid rate)); and chemical insecticide CAPTURE LFR+liquid fertilizer+RT1279 at 2.5×10¹² CFU (RT1279 (high rate)). B) At planting seeds were simultaneously treated with liquid fertilizer alone (Fertilizer); chemical insecticide CAPTURE LFR+liquid fertilizer (CAPTURE LFR+Fertilizer); chemical insecticide CAPTURE LFR+liquid fertilizer+CH200 at 2.5×10¹² CFU (CH200); chemical insecticide CAPTURE LFR+liquid fertilizer+CH201 at 2.5×10¹² CFU (CH201); and chemical insecticide CAPTURE LFR+liquid fertilizer+CH200+CH201 at 2.5×10¹² CFU (CH200+CH201).

FIGS. 5A-5B are bar graphs showing a comparison of the average shoot length per corn plant 12 days after planting corn seeds treated with spores of a growth promoting bacterial strain in combination with an insecticide and a liquid fertilizer as compared to unfertilized seeds in each of Pennington soil and Midwestern soil soil types according to one or more embodiments of the present invention. Insecticide plus liquid fertilizer and liquid fertilizer alone treatments are also shown. The negative effect observed in the graph is a temporary negative effect resulting from osmotic stress after the fertilizer has been applied to the seed. A) At planting seeds were simultaneously treated with liquid fertilizer alone (Fertilizer); chemical insecticide CAPTURE LFR+liquid fertilizer (CAPTURE LFR+Fertilizer); chemical insecticide CAPTURE LFR+liquid fertilizer+RT1279 at 6.25×10⁹ CFU (RT1279 (low rate)); chemical insecticide CAPTURE LFR+liquid fertilizer+RT1279 at 1.25×10¹¹ CFU (RT1279 (mid rate)); and chemical insecticide CAPTURE LFR+liquid fertilizer+RT1279 at 2.5×10¹² CFU (RT1279 (high rate)). B) At planting seeds were simultaneously treated with liquid fertilizer alone (Fertilizer); chemical insecticide CAPTURE LFR+liquid fertilizer (CAPTURE LFR+Fertilizer); chemical insecticide CAPTURE LFR+liquid fertilizer+CH200 at 2.5×10¹² CFU (CH200); chemical insecticide CAPTURE LFR+liquid fertilizer+CH201 at 2.5×10¹² CFU (CH201); and chemical insecticide CAPTURE LFR+liquid fertilizer+CH200+CH201 at 2.5×10¹² CFU (CH200+CH201).

FIGS. 6A-6B are bar graphs showing a comparison of the average dry shoot weight per corn plant 12 days after planting corn seeds treated with spores of a growth promoting bacterial strain in combination with an insecticide and a liquid fertilizer as compared to unfertilized seeds in each of Pennington soil and Midwestern soil soil types according to one or more embodiments of the present invention. Insecticide plus liquid fertilizer and liquid fertilizer alone treatments are also shown. The negative effect observed in the graph is a temporary negative effect resulting from osmotic stress after the fertilizer has been applied to the seed. A) At planting seeds were simultaneously treated with liquid fertilizer alone (Fertilizer); chemical insecticide CAPTURE LFR+liquid fertilizer (CAPTURE LRF+Fertilizer); chemical insecticide CAPTURE LFR+liquid fertilizer+RT1279 at 6.25×10⁹ CFU (RT1279 (low rate)); chemical insecticide CAPTURE LFR+liquid fertilizer+RT1279 at 1.25×10¹¹ CFU (RT1279 (mid rate)); and chemical insecticide CAPTURE LFR+liquid fertilizer+RT1279 at 2.5×10¹² CFU (RT1279 (high rate)). B) At planting seeds were simultaneously treated with liquid fertilizer alone (Fertilizer); chemical insecticide CAPTURE LFR+liquid fertilizer (CAPTURE LFR+Fertilizer); chemical insecticide CAPTURE LFR+liquid fertilizer+CH200 at 2.5×10¹² CFU (CH200); chemical insecticide CAPTURE LFR+liquid fertilizer+CH201 at 2.5×10¹² CFU (CH201); and chemical insecticide CAPTURE LFR+liquid fertilizer+CH200+CH201 at 2.5×10¹² CFU (CH200+CH201).

FIGS. 7A-7B are bar graphs showing a comparison of the average dry root weight per corn plant 12 days after planting corn seeds treated with spores of a growth promoting bacterial strain in combination with an insecticide and a liquid fertilizer as compared to unfertilized seeds in each of Pennington soil and Midwestern soil soil types according to one or more embodiments of the present invention. Insecticide plus liquid fertilizer and liquid fertilizer alone treatments are also shown. The negative effect observed in the graph is a temporary negative effect resulting from osmotic stress after the fertilizer has been applied to the seed. A) At planting seeds were simultaneously treated with liquid fertilizer alone (Fertilizer); chemical insecticide CAPTURE LFR+liquid fertilizer (CAPTURE LFR+Fertilizer); chemical insecticide CAPTURE LFR+liquid fertilizer+RT1279 at 6.25×10⁹ CFU (RT1279 (low rate)); chemical insecticide CAPTURE LFR+liquid fertilizer+RT1279 at 1.25×10¹¹ CFU (RT1279 (mid rate)); and chemical insecticide CAPTURE LFR+liquid fertilizer+RT1279 at 2.5×10¹² CFU (RT1279 (high rate)). B) At planting seeds were simultaneously treated with liquid fertilizer alone (Fertilizer); chemical insecticide CAPTURE LFR+liquid fertilizer (CAPTURE LFR+Fertilizer); chemical insecticide CAPTURE LFR+liquid fertilizer+CH200 at 2.5×10¹² CFU (CH200); chemical insecticide CAPTURE LFR+liquid fertilizer+CH201 at 2.5×10¹² CFU (CH201); and chemical insecticide CAPTURE LFR+liquid fertilizer+CH200+CH201 at 2.5×10¹² CFU (CH200+CH201).

FIG. 8 is a bar graph showing the increase in corn yield that resulted at 10 of the 20 trial sites for application of the high rate of Bacillus pumilus RTI279 (2.5×10¹³ cfu/Ha) in combination with CAPTURE LFR plus liquid fertilizer over the application of CAPTURE LFR plus liquid fertilizer alone according to one or more embodiments of the present invention. The increase in yield (bushel/acre) is shown on the y axis and the bars on the x axis represent the 10 different sites that resulted in an increase in yield.

FIG. 9 is a bar graph showing the increase in corn yield that resulted at 12 of the 20 trial sites for application of the medium rate of Bacillus pumilus RTI279 (2.5×10¹² cfu/Ha) in combination with CAPTURE LFR plus liquid fertilizer over the application of CAPTURE LFR plus liquid fertilizer alone according to one or more embodiments of the present invention. The increase in yield (bushel/acre) is shown on the y axis and the bars on the x axis represent the 12 different sites that resulted in an increase in yield.

FIG. 10 is a bar graph showing the increase in corn yield that resulted at 12 of the 20 trial sites for application of the low rate of Bacillus pumilus RTI279 (2.5×10¹¹ cfu/Ha) in combination with CAPTURE LFR plus liquid fertilizer over the application of CAPTURE LFR plus liquid fertilizer alone according to one or more embodiments of the present invention. The increase in yield (bushel/acre) is shown on the y axis and the bars on the x axis represent the 12 different sites that resulted in an increase in yield.

FIG. 11 is a bar graph showing the increase in corn yield that resulted at 9 of the 20 trial sites for application of the high rate of Bacillus licheniformis CH200 (2.5×10¹³ cfu/Ha) in combination with CAPTURE LFR plus liquid fertilizer over the application of CAPTURE LFR plus liquid fertilizer alone according to one or more embodiments of the present invention. The increase in yield (bushel/acre) is shown on the y axis and the bars on the x axis represent the 9 different sites that resulted in an increase in yield.

FIG. 12 is a bar graph showing the increase in corn yield that resulted at 13 of the 20 trial sites for application of the medium rate of Bacillus licheniformis CH200 (2.5×10¹² cfu/Ha) in combination with CAPTURE LFR plus liquid fertilizer over the application of CAPTURE LFR plus liquid fertilizer alone according to one or more embodiments of the present invention. The increase in yield (bushel/acre) is shown on the y axis and the bars on the x axis represent the 13 different sites that resulted in an increase in yield.

FIG. 13 is a bar graph showing the increase in corn yield that resulted at 14 of the 20 trial sites for application of the low rate of Bacillus licheniformis CH200 (2.5×10¹¹ cfu/Ha) in combination with CAPTURE LFR plus liquid fertilizer over the application of CAPTURE LFR plus liquid fertilizer alone according to one or more embodiments of the present invention. The increase in yield (bushel/acre) is shown on the y axis and the bars on the x axis represent the 14 different sites that resulted in an increase in yield.

FIG. 14 shows line drawings of images of corn plants 32 days after seed was planted showing the positive effect on growth under water stressed soil conditions of in-furrow co-application at planting of Bacillus licheniformis CH200 with CAPTURE LFR (bifenthrin 17.15%) plus 8-24-0 fertilizer (NUCLEUS O-PHOS) (C), as compared to applications of CAPTURE LFR plus fertilizer alone (B), and a non-treated check (A) according to one or more embodiments of the present invention.

FIG. 15 is a table showing the percent improvement in various growth parameters for corn in a greenhouse study where B. Licheniformis CH200 spores were co-applied with CAPTURE LFR (bifenthrin 17.15%) plus 8-24-0 fertilizer (NUCLEUS O-PHOS) at the time of seed planting and compared to applications of CAPTURE LFR plus fertilizer alone and an untreated control under both optimal and drought stress conditions according to one or more embodiments of the present invention.

FIGS. 16A-16C are line drawings of images of V6 stage corn with the 8^{th} leaf cut at the whorl from the study described above in FIG. 15 under the drought stress conditions according to one or more embodiments of the present invention. A) Untreated control; B) CAPTURE LFR+fertilizer; and C) CAPTURE LFR+fertilizer+CH200.

FIGS. 17A-17C are line drawings of images of V6 stage corn with the 9^{th} leaf cut at the whorl from the study described above in FIG. 15 under the optimal soil moisture conditions according to one or more embodiments of the present invention. A) Untreated control; B) CAPTURE LFR+fertilizer; and C) CAPTURE LFR+fertilizer+CH200.

FIG. 18 shows line drawings of photographs showing the positive effects on yield in squash plants where drip irrigation was used to apply 2.5×10¹² CFU/hectare of B. pumilus RTI279 spores at the time of planting, and again 2 weeks later, according to one or more embodiments of the present invention. (A) Untreated control plants, and (B) plants treated with RTI279 spores at 2.5×10¹² CFU/ha RTI279 by drip irrigation.

FIG. 19 shows images showing the positive effects on tomato growth as a result of addition of Bacillus licheniformis CH200 spores to SCOTTS MIRACLE-GRO (SCOTTS MIRACLE GRO, Co; Marysville, Ohio) soil at a pH of 5.5 according to one or more embodiments of the present invention. A) Plants grown in soil with added Bacillus licheniformis CH200 spores at 1×10⁷ spores/g soil. B) Control plants grown in the same soil without added Bacillus licheniformis CH200.

FIG. 20 shows images showing the positive effects on cucumber growth in SCOTTS MIRACLE-GRO (SCOTTS MIRACLE GRO, Co; Marysville, Ohio) soil at pH 5.5 after addition of Bacillus licheniformis CH200 spores to the soil according to one or more embodiments of the present invention. A) Control plants grown in soil without addition of Bacillus spp. spores; and B) Plants grown in soil with added Bacillus licheniformis CH200 spores at 1×10⁷ spores/g soil.

FIG. 21 shows line drawings of photographs showing the positive effects on corn seed germination and root development after treatment of the seeds in-furrow with spores of growth promoting bacterial strain Bacillus licheniformis CH200 in combination with the insecticide, CAPTURE LFR, and a liquid fertilizer according to one or more embodiments of the present invention. A) Seeds treated at planting with CAPTURE LFR, liquid fertilizer, and Bacillus licheniformis CH200 spores at 2.5×10¹² CFU/hectare at 7 days after planting, as compared to, B) control seeds treated at planting with with CAPTURE LFR and liquid fertilizer. C) Seeds treated at planting with CAPTURE LFR, liquid fertilizer, and Bacillus licheniformis CH200 spores at 2.5×10¹² CFU/hectare at 14 days after planting, as compared to, D) control seeds treated at planting with CAPTURE LFR and liquid fertilizer.

FIG. 22 shows line drawings of photographs showing the positive effects on root development in corn seedlings in a field trial after treatment of the corn seeds in-furrow upon planting with spores of growth promoting bacterial strain Bacillus licheniformis CH200 in combination with the insecticide, CAPTURE LFR, and a liquid fertilizer according to one or more embodiments of the present invention. A) Control plants treated with CAPTURE LFR and liquid fertilizer at planting, as compared to, B) plants treated at planting with CAPTURE LFR, liquid fertilizer, and Bacillus licheniformis CH200 spores at 2.5×10¹² CFU/hectare. Images were taken 24 days after planting.

FIG. 23 shows the positive effects on root development in corn in a field trial after treatment of the corn seeds in-furrow upon planting with spores of growth promoting bacterial strain Bacillus licheniformis CH200 in combination with the insecticide, CAPTURE LFR, and a liquid fertilizer, according to one or more embodiments of the present invention. A) Roots of an uprooted corn plant 35 days after in-furrow treatment of the corn seed at planting with liquid fertilizer; B) Roots of an uprooted corn plant 35 days after in-furrow treatment of the corn seed at planting with liquid fertilizer and CAPTURE LFR; and C) Roots of an uprooted corn plant 35 days after in-furrow treatment of the corn seed at planting with liquid fertilizer, CAPTURE LFR, and Bacillus licheniformis CH200 spores at 2.5×10¹² CFU/hectare.

FIG. 24 shows the positive effects on growth in corn in a field trial after treatment of the corn seeds in-furrow upon planting with spores of growth promoting bacterial strain Bacillus licheniformis CH200 in combination with the insecticide, CAPTURE LFR, and a liquid fertilizer according to one or more embodiments of the present invention. A) A leaf of a corn plant 35 days after in-furrow treatment of seed at planting with CAPTURE LFR, liquid fertilizer, and Bacillus licheniformis CH200 spores at 2.5×10¹² CFU/hectare, as compared to, B) a leaf of a control plant after the same in-furrow treatment of seed at planting, but without Bacillus licheniformis CH200 spores. C) An uprooted corn plant 35 days after in-furrow treatment of seed at planting with CAPTURE LFR, liquid fertilizer, and Bacillus licheniformis CH200 spores at 2.5×10¹² CFU/hectare, as compared to, D) an uprooted control corn plant after the same in-furrow treatment of seed at planting, but without Bacillus licheniformis CH200 spores. E) A stalk of a corn plant 35 days after in-furrow treatment of seed at planting with CAPTURE LFR, liquid fertilizer, and Bacillus licheniformis CH200 spores at 2.5×10¹² CFU/hectare, as compared to, F) a stalk of a control corn plant after the same in-furrow treatment of seed at planting, but without Bacillus licheniformis CH200 spores.

FIG. 25 shows photographic images showing the positive growth effects of treatment of potato plants grown in Globodera-infected soil with spores of Bacillus licheniformis strain CH200 according to one or more embodiments of the present invention. Potato plants after 48 days growth are shown in the figure. A) Plants treated with CH200 spores; and B) Control plants.

FIG. 26 shows photographs taken 14 days after planting and showing the positive effects on growth in soybean seedlings in a field trial after treatment of the soy seeds in-furrow upon planting with spores of growth promoting bacterial strain Bacillus licheniformis CH200 in combination with the insecticide, CAPTURE LFR, and a liquid fertilizer according to one or more embodiments of the present invention. A) Three plants on the left were treated with CAPTURE LFR, liquid fertilizer, and Bacillus licheniformis CH200 spores at 2.5×10¹² CFU/hectare; and B) Three control plants on the right were treated with CAPTURE LFR and liquid fertilizer.

### DETAILED DESCRIPTION OF THE INVENTION

The terms “a,” “an,” and “the” refer to “one or more” when used in this application, including the claims. Thus, for example, reference to “a plant” includes a plurality of plants, unless the context clearly is to the contrary, and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and claims, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

In certain embodiments of the present invention, compositions and methods are provided for benefiting plant growth. The compositions contain isolated bacterial or fungal strains having properties beneficial to plant growth and development that can provide beneficial growth effects when delivered in a liquid fertilizer to plants, seeds, or the soil or other growth medium surrounding the plant or seed in combination with a soil insecticide.

The phrases “plant growth promoting” and “plant growth benefit” and “benefiting plant growth” and “properties beneficial to plant growth” and “properties beneficial to plant growth and development” are intended to mean and to be exhibited by for purposes of the specification and claims one or a combination of: improved seedling vigor, improved root development, improved plant health, increased plant mass, increased yield, improved appearance, improved resistance to osmotic stress, or improved resistance to plant pathogens. The phrase “improved resistance to osmotic stress” as it is used herein throughout the claims and specification, is intended to mean improved resistance to conditions such as drought, low moisture, and/or osmotic stress due to application of liquid fertilizer.

The phrase “a biologically pure culture of a bacterial strain” refers to one or a combination of: spores of the biologically pure fermentation culture of a bacterial strain, vegetative cells of the biologically pure fermentation culture of a bacterial strain, one or more products of the biologically pure fermentation culture of a bacterial strain, a culture solid of the biologically pure fermentation culture of a bacterial strain, a culture supernatant of the biologically pure fermentation culture of a bacterial strain, an extract of the biologically pure fermentation culture of the bacterial strain, and one or more metabolites of the biologically pure fermentation culture of a bacterial strain.

The compositions and methods of the present invention are useful for benefiting plant growth in a wide range of plant species. In particular, for example, the plant can include food crops, monocots, dicots, fiber crops, cotton, biofuel crops, cereals, Corn, Sweet Corn, Popcorn, Seed Corn, Silage Corn, Field Corn, Rice, Wheat, Barley, Sorghum, Brassica Vegetables, Broccoli, Cabbage, Cauliflower, Brussels Sprouts, Collards, Kale, Mustard Greens, Kohlrabi, Bulb Vegetables, Onion, Garlic, Shallots, Fruiting Vegetables, Pepper, Tomato, Eggplant, Ground Cherry, Tomatillo, Okra, Grape, Herbs/Spices, Cucurbit Vegetables, Cucumber, Cantaloupe, Melon, Muskmelon, Squash, Watermelon, Pumpkin, Eggplant, Leafy Vegetables, Lettuce, Celery, Spinach, Parsley, Radicchio, Legumes/Vegetables (succulent and dried beans and peas), Beans, Green beans, Snap beans, Shell beans, Soybeans, Dry Beans, Garbanzo beans, Lima beans, Peas, Chick peas, Split peas, Lentils, Oil Seed Crops, Canola, Castor, Cotton, Flax, Peanut, Rapeseed, Safflower, Sesame, Sunflower, Soybean, Root/Tuber and Corm Vegetables, Carrot, Potato, Sweet Potato, Beets, Ginger, Horseradish, Radish, Ginseng, Turnip, sugarcane, sugarbeet, Grass, or Turf grass. The plant can be a corn plant.

The term “liquid fertilizer” refers to a fertilizer in a fluid or liquid form containing various ratios of nitrogen, phosphorous and potassium (for example, but not limited to, 10% nitrogen, 34% phosphorous and 0% potassium) and micronutrients, commonly known as starter fertilizers that are high in phosphorus and promote rapid and vigorous root growth.

The compositions can be delivered to seed of the plant, roots of the plant, a cutting of the plant, a graft of the plant, callus tissue of the plant, soil or growth medium surrounding the plant, soil or growth medium before sowing seed of the plant in the soil or growth medium, or soil or growth medium before planting the plant, the plant cutting, the plant graft, or the plant callus tissue in the soil or growth medium.

Surprisingly, the results provided in the present disclosure show that delivery of the compositions of the present invention containing the isolated bacteria to the soil surrounding seed at planting in a liquid fertilizer in combination with a soil insectide can ameliorate the growth inhibitory effects the fertilizer can have on the plant. In addition, delivery of the compositions of the present invention containing the isolated bacteria to the soil surrounding seed at planting in a liquid fertilizer in combination with a soil insectide can provide significant improvements in plant growth and development and significant increases in plant yield.

One of the strains of the present invention having properties beneficial to plant growth is Bacillus pumilus RT1279. This strain was isolated from the rhizosphere soil of grape vines growing in NY and subsequently tested for plant growth promoting properties. The isolated bacterial strain was identified as a new strain of Bacillus pumilus (see EXAMPLE 1). The strain of B. pumilus RT1279 was deposited on 17 Apr. 2014 under the terms of the Budapest Treaty on the International Recognition of the Deposit of Microorganisms for the Purposes of Patent Procedure at the American Type Culture Collection (ATCC) in Manassas, Va., USA and bears the Patent Accession No. PTA-121164. Sequence analysis of the genome of the RT1279 Bacillus pumilus strain revealed that the strain has genes related to osmotic stress response for which homologues are lacking in the other closely related B. pumilus strains (see EXAMPLE 2).

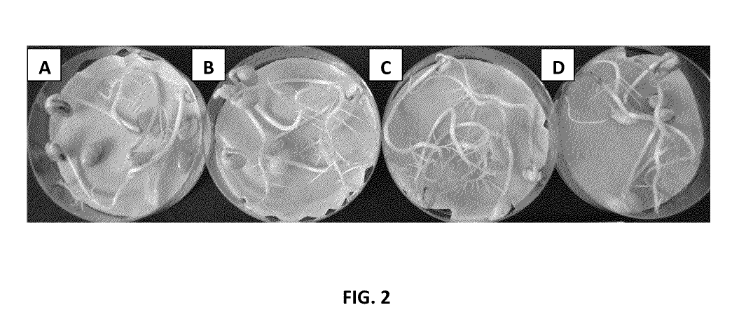

Experiments were performed to determine the growth promoting activity of the Bacillus pumilus RT1279 strain in various plants. The experimental results are provided in FIG. 2 and in EXAMPLES 3-7 hereinbelow. In particular, EXAMPLE 7 describes positive effects of inoculation of seed and/or coating of seed from a variety of plants with vegetative cells and spores of the Bacillus pumilus RT1279 strain on seed germination and root development and architecture. As an illustration, FIGS. 2A-2D are images of soy showing the positive effects on root hair development after inoculation by vegetative cells of RT1279 at (B) 1.04×10⁶ CFU/ml, (C) 1.04×10⁵ CFU/ml, and (D) 1.04×10⁴ CFU/ml after 7 days of growth as compared to untreated control (A). The data show that addition of the RT1279 cells stimulated formation of fine root hairs compared to non-inoculated control seeds. Fine root hairs are important in the uptake of water, nutrients and plant interaction with other microorganisms in the rhizosphere.

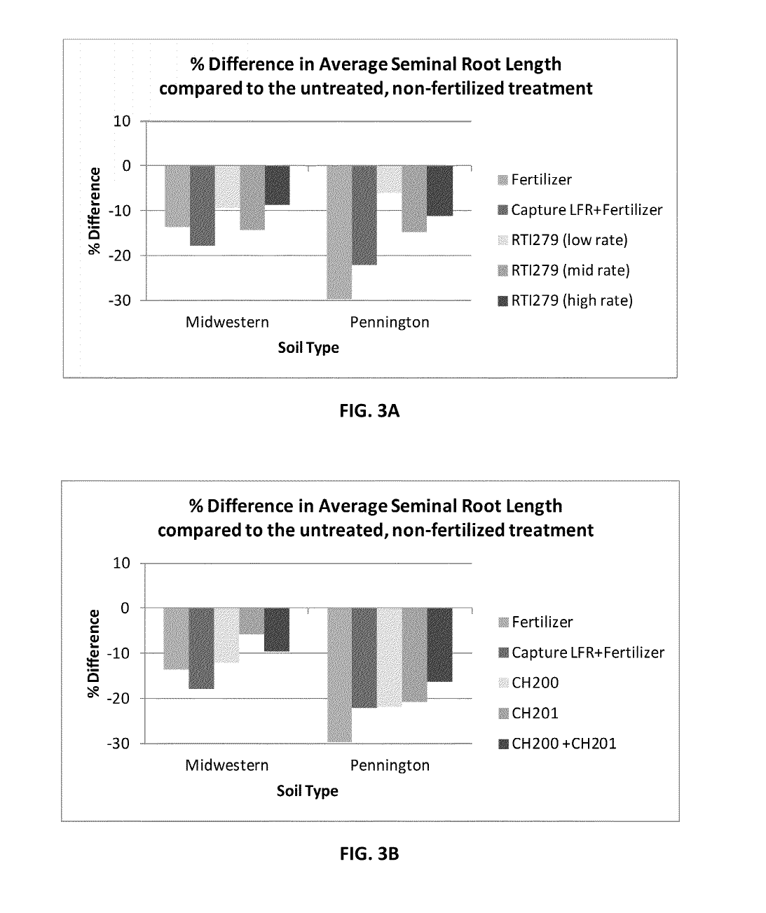

Experiments with the Bacillus pumilus RT1279 strain were also performed under conditions of osmotic stress induced by application of liquid fertilizer upon planting of seed. These experiments were expanded to include addition of a number of other microbial strains having growth promoting properties. Specifically, in-furrow experiments were performed in a greenhouse to measure the ability of bacterial strains having plant growth promoting properties to enhance plant growth when delivered to the soil in a liquid fertilizer in combination with a soil insecticide at the time of planting seed. The experimental results are provided in FIGS. 3-7 and in EXAMPLE 8 herein below. The experiments were performed with Bacillus pumilus RT1279, Bacillus licheniformis CH200 deposited 2005-04-07 at Deutsche Sammlung von Mikroorganismen und Zellkulturen GmbH, Mascheroder Weg 1 b, D-38124 Braunschweig (DSMZ) and given the accession No. DSM 17236, Bacillus subtilis CH201 deposited 2005-04-07 at Deutsche Sammlung von Mikroorganismen und Zellkulturen GmbH, Mascheroder Weg 1 b, D-38124 10 Braunschweig (DSMZ) and given the accession No. DSM 17231, and a combination of the strains CH200 and CH201.

The experiments were performed using two types of soil, Pennington soil and Midwestern soil. Delayed plant emergence and reduced dry root weight with the utilization of the fertilizer was observed in the Pennington soil but not the Midwestern soil. The positive effects of treatment with the growth promoting strains for both soil types on seminal root length, nodal root length, shoot length, dry shoot weight, and dry root weight are illustrated in FIGS. 3-7. The results surprisingly showed that the addition of these growth promoting bacterial strains ameliorated the temporary growth inhibitory effect that can be caused by application of a liquid fertilizer to seed in sandy, acidic soils. The results further showed significant improvements in plant growth and development in both soil types as a result of treatment with the growth promoting strain. For example, in Midwestern soil a 10-20% increase in shoot height within the first week after emergence and a 20-48% increase in the longest nodal root length. In summary, the seed treated with the growth promoting bacterial spores resulted in plants having longer nodal roots and longer and heavier shoots, independent of the soil type. In addition, these plants were larger than the fertilizer-free and insecticide plus fertilizer controls. The addition of the growth promoting bacterial treatments had an immediate at-planting effect and apparently helped to protect the young seedlings against fertilizer burn.

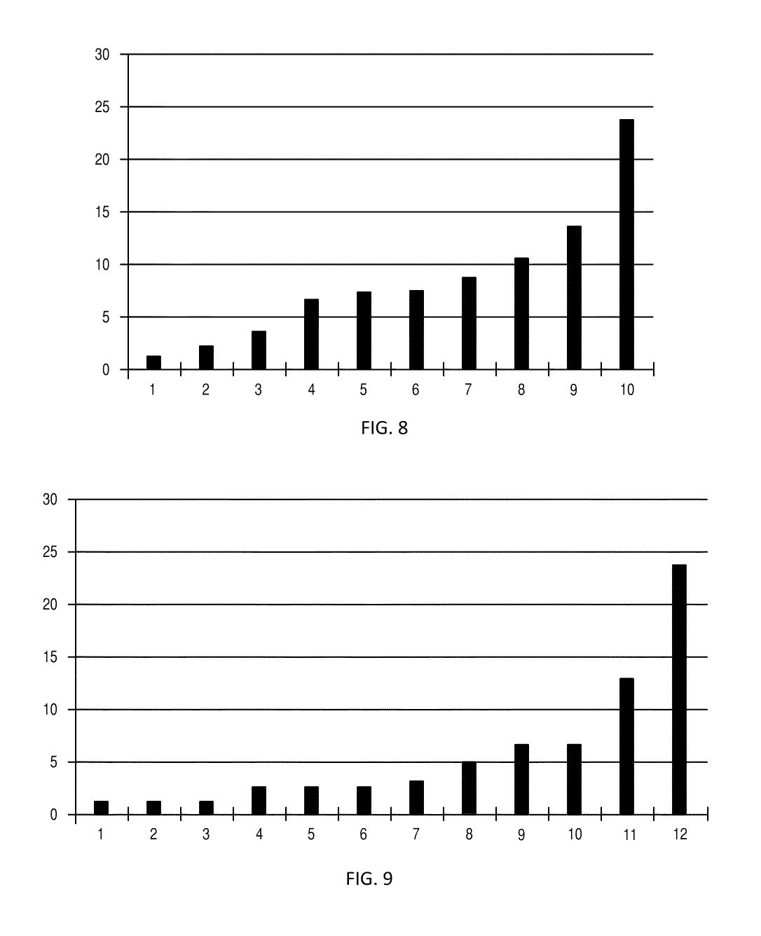

In addition, field trial experiments on corn at a variety of Midwestern sites are described in EXAMPLE 9 for Bacillus pumilus RTI279 and in EXAMPLE 10 for Bacillus licheniformis CH200 which show the positive effect these strains had on yield when applied in a liquid fertilizer in furrow with seed planting in combination with an insecticide. The increased corn yield resulting from delivery of three different concentrations of spores of Bacillus pumilus RTI279 is illustrated in FIGS. 8-10. In summary, the average increase in yield over the 20 field trials as a function of application rate of RTI279 in liquid fertilizer plus insecticide over liquid fertilizer plus insecticide alone was 3.65, 2.1, and 2.2 bushels per acre for the high, medium and low application rate, respectively. The increased corn yield resulting from delivery of a single concentration of Bacillus licheniformis CH200, Bacillus subtilis CH201, and a combination of the CH200 and CH201 strains is shown in FIGS. 11-13, respectively. In summary, the average increase in yield over the 20 field trials as a function of application rate of CH200 in liquid fertilizer plus insecticide over liquid fertilizer plus insecticide alone was 4.65, 4.1, and 2.2 bushels per acre for the high, medium and low application rate, respectively.

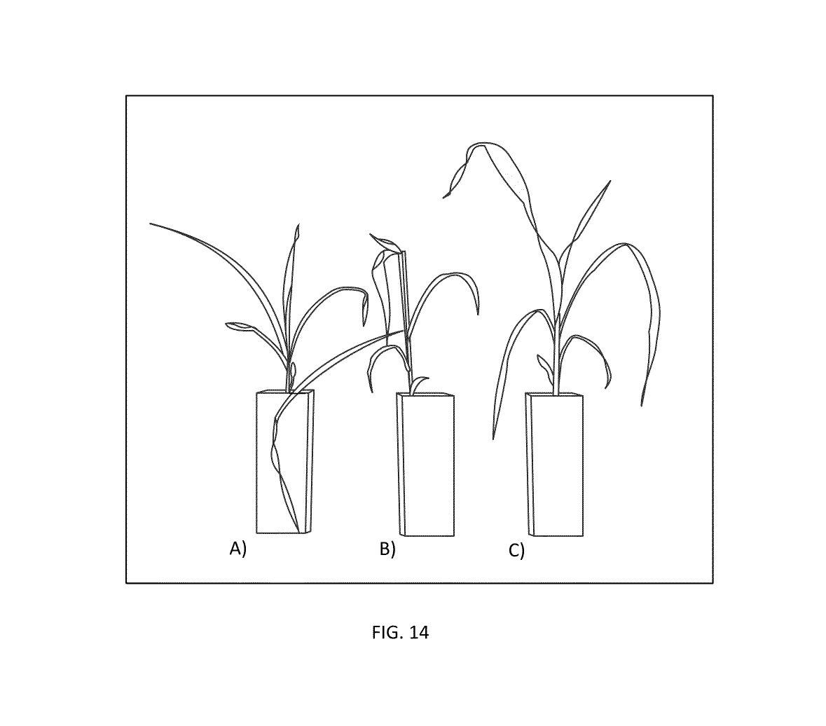

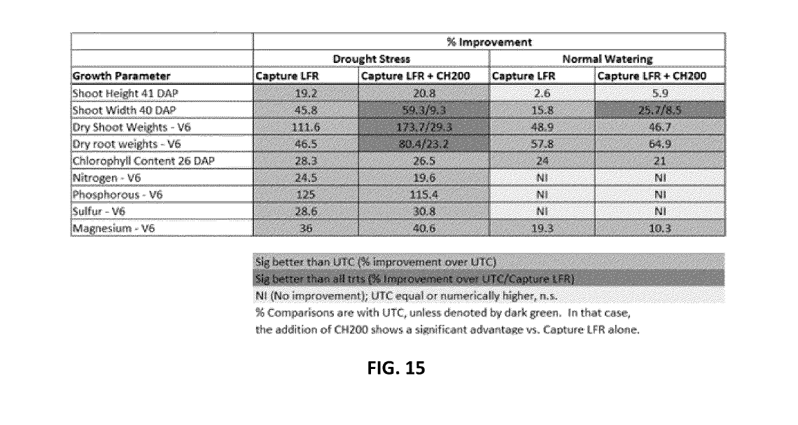

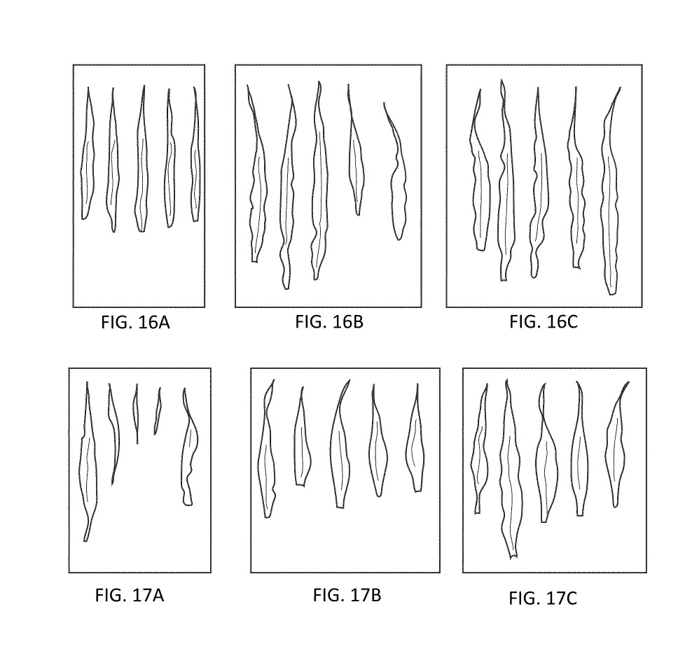

EXAMPLE 11 describes a greenhouse study conducted to evaluate in-furrow application of bacterial strain CH200 along with CAPTURE LFR and liquid fertilizer (8-24-0) on corn growth under under optimal moisture and drought stress conditions. Results of these studies showed that in water stressed soil conditions, fertilizer negatively impacted early developing root systems; however, by 41DAP (V6 stage) those plants treated with CAPTURE LFR+CH200 in addition to liquid fertilizer had statistically thicker stalks, statistically heavier dry shoot weights, and statistically heavier dry root weights (see, FIGS. 14A-14C and FIG. 15). In optimal watering conditions, limited statistical differences were detected between CAPTURE LFR and CAPTURE LFR+CH200; with the exception that statistically thicker stalks were measured at 41DAP when corn was treated with the CH200 strain. Plants growing in optimal soil conditions containing CH200 were further along in development. In general, plants growing in either optimal or drought soil conditions containing CH200 possessed an additional leaf coupled with a wider and longer 8^{th} or 9^{th} leaf (FIGS. 16A-16C and FIGS. 17A-17C).

EXAMPLE 12 describes a field trial for broccoli and turnip plants where drip irrigation was used to apply 1.5×10¹¹, 2.5×10¹², or 2.5×10¹³ CFU/hectare of B. licheniformis CH200 spores at the time of planting, and again 2 weeks later. As compared to control plants in which B. licheniformis CH200 spores were not included in the irrigation, addition of the CH200 spores to the broccoli resulted in an increase in fresh weight yield broccoli from 3 kg (control) to 3.6 kg and 3.8 kg at each of the 2.5×10¹³ CFU/hectare and 2.5×10¹² CFU/hectare applications of CH200, which represents a 20% to 26% increase in weight, respectively. As compared to control plants in which B. licheniformis CH200 spores were not included in the irrigation, addition of the CH200 spores to the turnip plants resulted in an increase in tuber weight yield from 3.3 kgs (control) to 5.8 kg (2.5×10¹³ CFU/hectare CH200), 4.2 kg (2.5×10¹² CFU/hectare CH200), and 4.9 kg (1.5×10¹¹ CFU/hectare CH200) or a 76%, 27%, and 48% increase in weight, respectively.

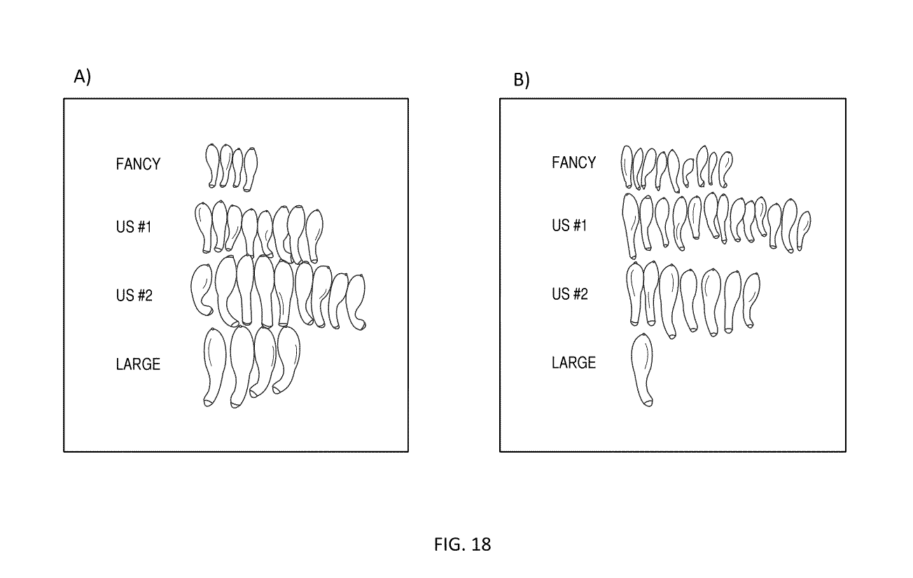

EXAMPLE 13 describes a field trial for squash and turnip plants where drip irrigation was used to apply 1.5×10¹¹ or 2.5×10¹² CFU/hectare of B. pumilus RT1279 spores at the time of planting, and again 2 weeks later. As compared to control squash plants in which B. pumilus RT1279 spores were not included in the irrigation, addition of the RT1279 spores resulted in an increase in yield for both total and marketable squash. Specifically, RT1279 treated plants (application rate 2.5×10¹² CFU/hectare) resulted in an average of 36 kg of total squash of which 30 kg was marketable, as compared to 22 kg of total squash of which 17 kg was marketable for the untreated control plants (FIG. 18A (control plants) & FIG. 18B (RT1279 at application rate 2.5×10¹² CFU/hectare)). As compared to control turnip plants in which B. pumilus RT1279 spores were not included in the irrigation, addition of the RT1279 spores at both concentrations resulted in an increase in yield of 67% as measured in tuber weight.

EXAMPLE 14 describes the positive effects on yield as a result of coating corn seed with spores of the B. pumilus RT1279 strain in addition to a typical chemical control. In one experiment, seed treatment was performed by mixing corn seeds with a solution containing spores of B. pumilus RT1279 and chemical control MAXIM+Metalaxyl+PONCHO 250. Untreated seed and treated corn seed were planted in three separate field trials in Wisconsin and analyzed by length of time to plant emergence, plant stand, plant vigor, and grain yield in bushels/acre. Inclusion of the B. pumilus RT1279 in the seed treatment as compared to the seed treated with chemical control alone did not have a statistically significant effect on time to plant emergence, plant stand, or plant vigor, but did result in an increase of 12 bushels/acre of grain (from 231 to 243 bushels/acre) representing a 5.2 increase in grain yield. A related trial was performed as described above, except that the corn plants were challenged separately with the pathogens Rhizoctonia and Fusarium graminearum. Treatment of the seed with B. pumilus RT1279 as compared to seed treated with chemical control alone resulted in a statistically significant decrease in disease severity for Fusarium graminearum. In a separate experiment, seed treatment was performed by mixing corn seeds with a solution containing spores of B. pumilus RT1279 and chemical control Ipconazole+Metalaxyl+PONCHO 500. Nineteen trials were performed with the untreated seed and each of the treated corn seeds in 11 locations across 7 states and analyzed by grain yield in bushels/acre. Inclusion of the B. pumilus RT1279 in the seed treatment as compared to the seed treated with chemical control alone resulted in an increase of 3 bushels/acre of grain representing a 1.5% increase in grain yield.

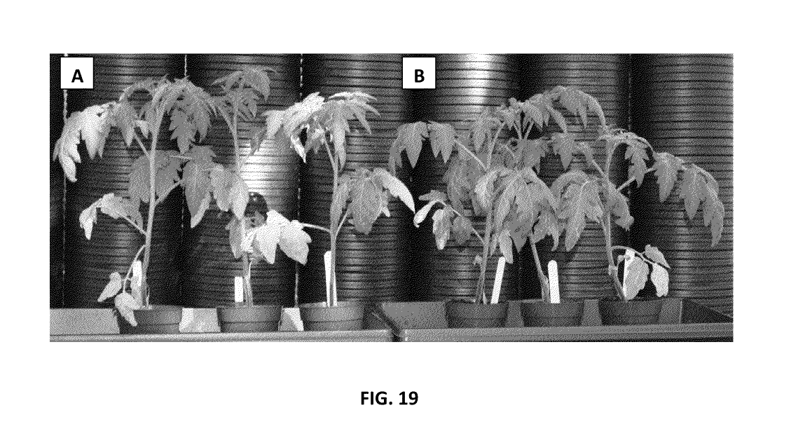

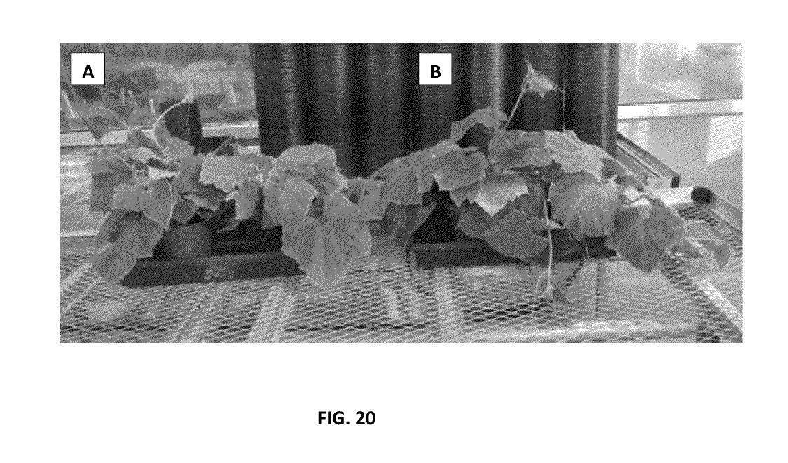

EXAMPLE 15 describes the ability of the isolated strain of Bacillus licheniformis CH200 to improve growth and health of tomato and cucumber when seeds are planted in potting soil containing spores of the Bacillus licheniformis CH200. The positive effects of the CH200 strain on growth are shown in the images in FIGS. 19A & 19B for tomato and for cucumber in FIGS. 20A & 20B.

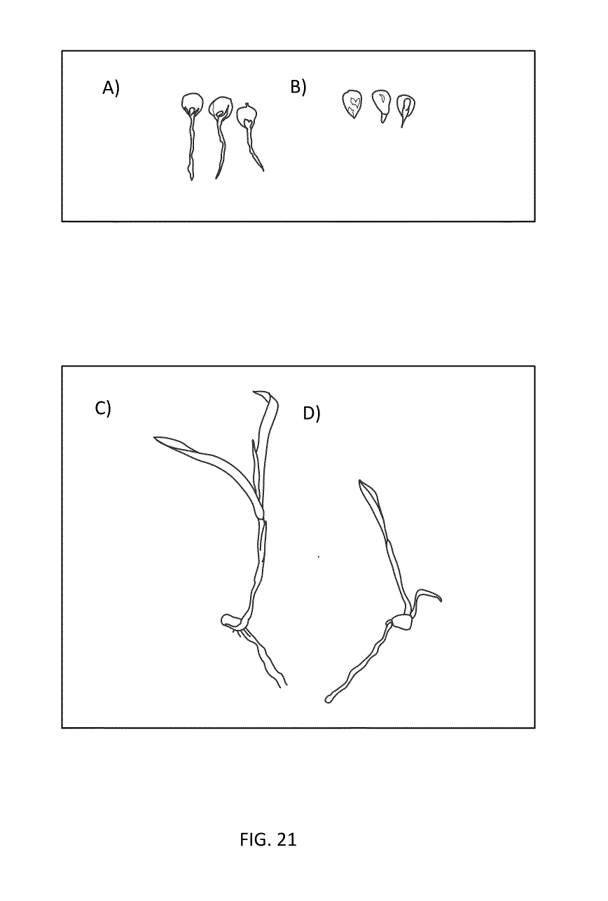

EXAMPLE 16 describes field trials conducted to evaluate in-furrow application of bacterial strain CH200 along with CAPTURE LFR and liquid fertilizer on corn growth. FIGS. 21A-21D are line drawings of photographs showing the positive effects on corn seed germination and root development after treatment of the seeds with spores of growth promoting bacterial strain Bacillus licheniformis CH200 in-furrow in combination with the insecticide, CAPTURE LFR, and a liquid fertilizer. A) Seeds treated at planting with CAPTURE LFR, liquid fertilizer, and Bacillus licheniformis CH200 spores at 2.5×10¹² CFU/hectare at 7 days; B) Control seeds treated at planting with CAPTURE LFR and liquid fertilizer 7 days after planting; C) Seeds treated at planting with CAPTURE LFR, liquid fertilizer, and Bacillus licheniformis CH200 spores at 2.5×10¹² CFU/hectare 14 days after planting; and D) Control seeds treated at planting with CAPTURE LFR and liquid fertilizer 14 days after planting. The substantially increased root growth and the substantially increased size of the plant treated with CH200 in combination with CAPTURE LFR in FIG. 21A and FIG. 21C, respectively, relative to the control plants demonstrates the positive growth effect on seed germination and early plant growth and vigor provided by treatment with the CH200 spores.

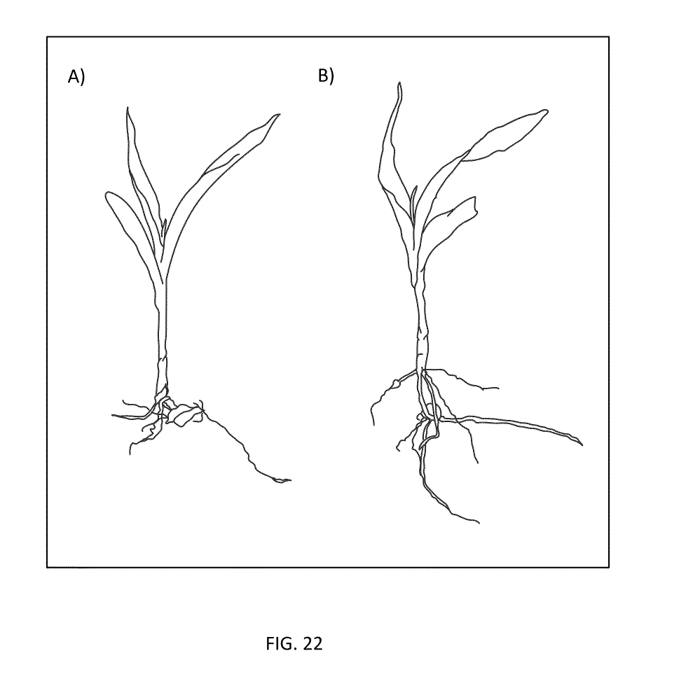

FIGS. 22A-22B are line drawings of photographs showing the positive effects on root development in corn seedlings in a field trial after treatment of the corn seeds in-furrow upon planting with spores of growth promoting bacterial strain Bacillus licheniformis CH200 in combination with the insecticide, CAPTURE LFR, and a liquid fertilizer. A) Control plants treated with CAPTURE LFR and liquid fertilizer; and B) Plants treated with CAPTURE LFR, liquid fertilizer, and Bacillus licheniformis CH200 spores at 2.5×10¹² CFU/hectare at. Images were taken 24 days after planting. The substantially increased root growth and the substantially increased size of the plant treated with CH200 in combination with CAPTURE LFR shown in FIG. 22B relative to the control plant demonstrates the positive growth effect on plant growth and vigor provided by treatment with the CH200 spores.

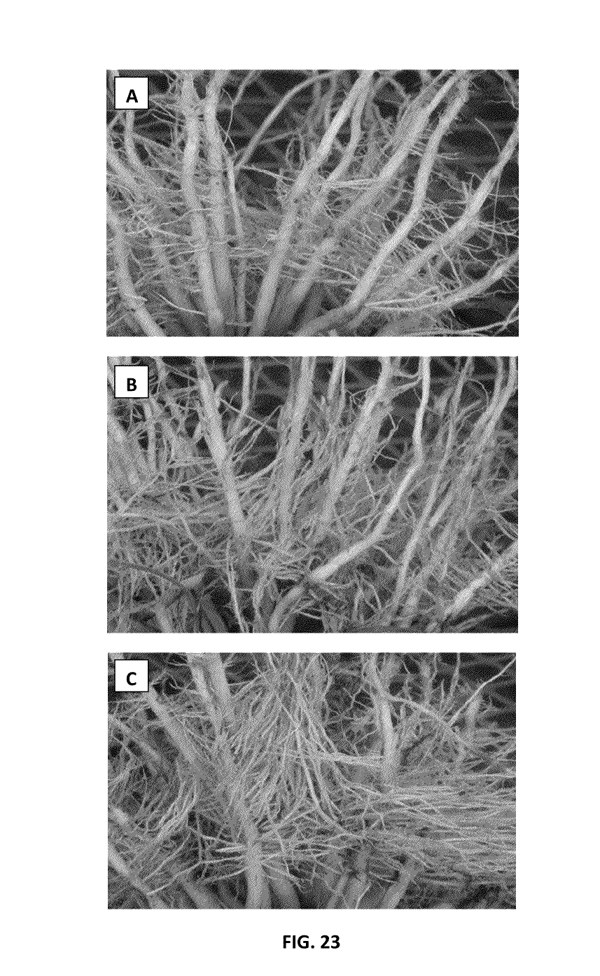

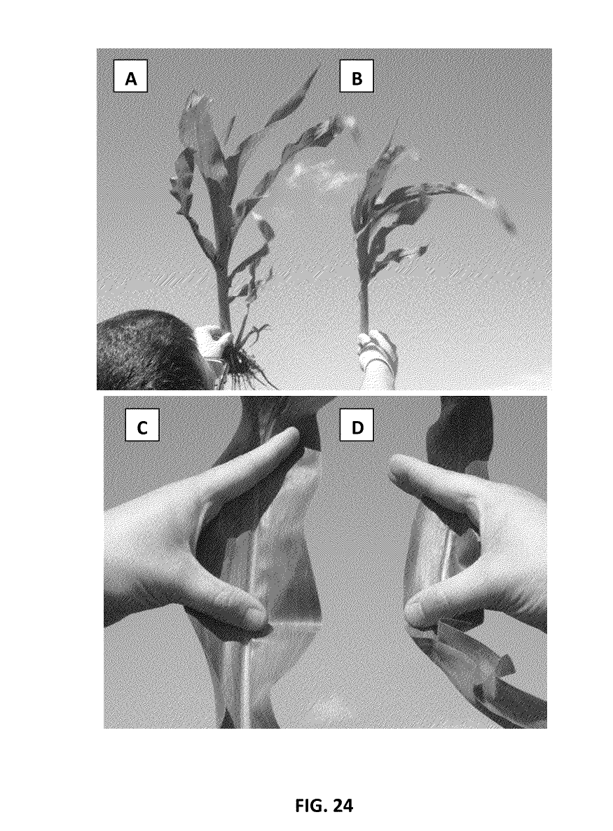

FIGS. 23A-23C are images showing the positive effects on root development in corn in a field trial after treatment of the corn seeds in-furrow upon planting with spores of growth promoting bacterial strain Bacillus licheniformis CH200 in combination with the insecticide, CAPTURE LFR, and a liquid fertilizer. A) Roots of an uprooted corn plant 35 days after in-furrow treatment of the corn seed at planting with liquid fertilizer; B) Roots of an uprooted corn plant 35 days after in-furrow treatment of the corn seed at planting with liquid fertilizer and CAPTURE LFR; and C) Roots of an uprooted corn plant 35 days after in-furrow treatment of the corn seed at planting with liquid fertilizer, CAPTURE LFR, and Bacillus licheniformis CH200 spores at 2.5×10¹² CFU/hectare. The substantially increased root mass, especially with regard to the secondary roots, for the plant treated with CH200 in combination with CAPTURE LFR shown in FIG. 23C relative to the control plants demonstrates the positive growth effect provided by treatment with the CH200 spores.

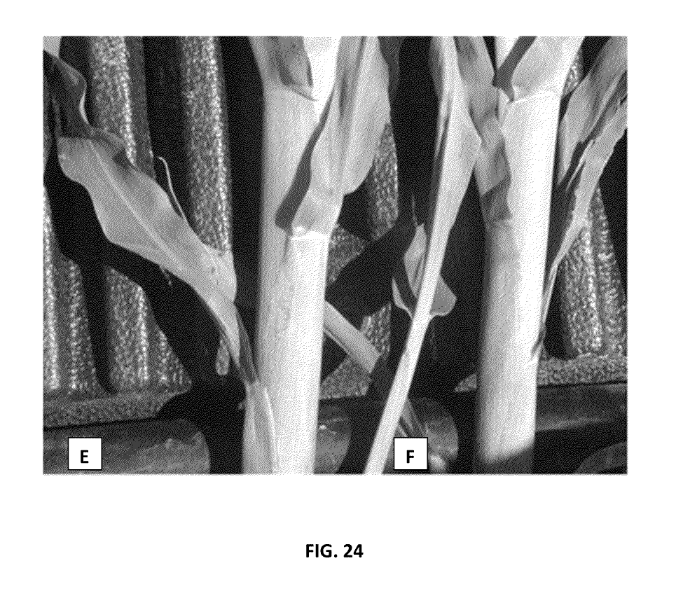

FIGS. 24A-24F are line drawings of photographs showing the positive effects on growth in corn in a field trial after treatment of the corn seeds upon planting with spores of growth promoting bacterial strain Bacillus licheniformis CH200 in combination with the insecticide, CAPTURE LFR, and a liquid fertilizer. A) A leaf of a corn plant 35 days after in-furrow treatment of seed at planting with CAPTURE LFR, liquid fertilizer, and Bacillus licheniformis CH200 spores, as compared to, B) a leaf of a control plant after the same in-furrow treatment of seed at planting, but without Bacillus licheniformis CH200 spores. C) An uprooted corn plant 35 days after in-furrow treatment of seed at planting with CAPTURE LFR, liquid fertilizer, and Bacillus licheniformis CH200 spores, as compared to, D) an uprooted control corn plant after the same in-furrow treatment of seed at planting, but without Bacillus licheniformis CH200 spores. E) A stalk of a corn plant 35 days after in-furrow treatment of seed at planting with CAPTURE LFR, liquid fertilizer, and Bacillus licheniformis CH200 spores, as compared to, F) a stalk of a control corn plant after the same in-furrow treatment of seed at planting, but without Bacillus licheniformis CH200 spores. The substantial increase in leaf size, overall plant size, and plant stalk width for the plants treated with CH200 in combination with CAPTURE LFR shown in FIGS. 24A, 24C, and 24E, respectively, relative to the control plants demonstrates the positive effect on plant growth and vigor provided by treatment with the CH200 spores.

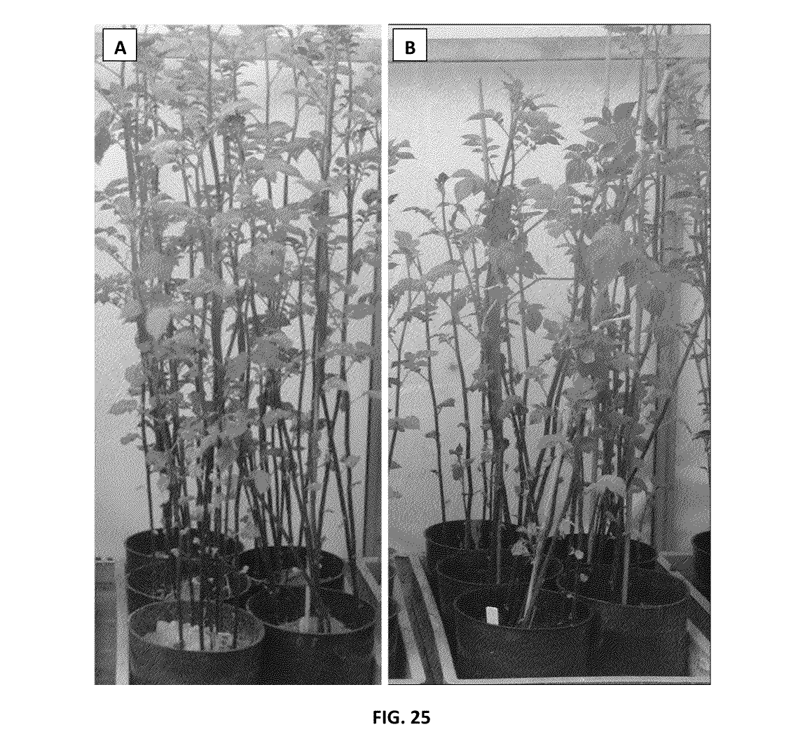

EXAMPLE 17 describes the effect of application of the bacterial isolate Bacillus Licheniformis CH200 on growth and vigor for potato plants grown in nematode infected soil (Globedera sp.). Potatoes (variety “Bintje”) were planted in soil infected with Globodera sp. and enhanced with or drip irrigated with 10E⁺⁹ cfu spores per liter soil of Bacillus licheniformis strain CH200. Images of the plants after 48 days of growth in a greenhouse are shown in FIGS. 25A-25B. FIG. 25A shows the plants treated with CH200 and FIG. 25B shows the control plants that were not treated with the CH200 spores. The increased size of the plants treated with CH200 relative to the control plants demonstrates the positive growth effect provided by treatment with the CH200 spores.

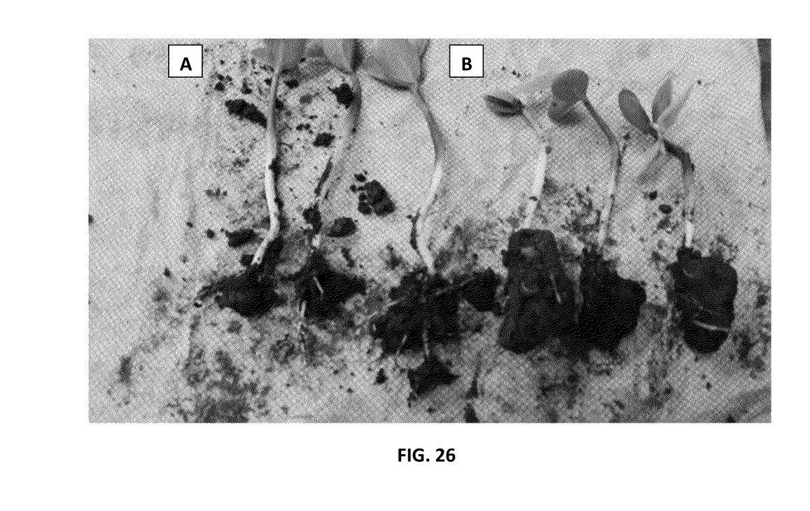

EXAMPLE 18 describes the effect of Bacillus Licheniformis CH200 on soy-bean seedling growth when applied in-furrow with seed at planting in combination with application of a liquid insecticide and a liquid fertilizer in field conditions. FIGS. 26A-26B are photographs taken 14 days after planting and showing the positive effects on growth in soy-bean seedlings in the field trial after treatment with Bacillus licheniformis CH200 in combination with the insecticide, CAPTURE LFR, and a liquid fertilizer. FIG. 26A shows three plants on the left that were treated with CAPTURE LFR, liquid fertilizer, and Bacillus licheniformis CH200 spores at 2.5×10¹² CFU/hectare; and FIG. 26B shows three control plants on the right that were treated with CAPTURE LFR and liquid fertilizer. The substantially increased size of the plants treated with CH200 relative to the control plants demonstrates the positive effect on early growth and vigor provided by treatment with the CH200 spores.

In one embodiment, the present invention provides a composition for benefiting plant growth, the composition including a biologically pure culture of a bacterial or a fungal strain having properties beneficial to plant growth and one or more microbial or chemical pesticides, in a formulation suitable as a liquid fertilizer, wherein each of the bacterial or fungal strains and the one or more microbial or chemical pesticides is present in an amount suitable to benefit plant growth. In another embodiment, the present invention provides a composition comprising a) a biologically pure culture of a bacterial strain having plant growth promoting properties, and b) at least one pesticide, wherein the composition is in a formulation compatible with a liquid fertilizer. The terms “in a formulation suitable as a liquid fertilizer” and “in a formulation compatible with a liquid fertilizer” are herein used interchangeably throughout the specification and claims and are intended to mean that the formulation is capable of dissolution or dispersion or emulsion in an aqueous solution to allow for mixing with a fertilizer for delivery to plants in a liquid formulation.

The pesticide can be a chemical pesticide. The chemical pesticide can be an insecticide. The chemical pesticide can be a fungicide. The chemical pesticide can be an herbicide. The chemical pesticide can be a nematicide. The composition can be in the form of a liquid, a dust, a spreadable granule, a dry wettable powder, or a dry wettable granule. The bacterial strain can be in the form of spores or vegetative cells. The bacterial strain can be a strain of Bacillus. The Bacillus can be a Bacillus pumilus, a Bacillus licheniformis, a Bacillus subtilis, or a combination thereof. The Bacillus pumilus can be Bacillus pumilus RTI279 deposited as PTA-121164. The Bacillus licheniformis can be Bacillus licheniformis CH200 deposited as accession No. DSM 17236. The bacterial strain can be Bacillus pumilus RT1279 deposited as PTA-121164 present at a concentration ranging from 1.0×10⁹ CFU/g to 1.0×10¹² CFU/g or Bacillus licheniformis CH200 deposited as accession No. DSM 17236 present in an amount ranging from 1.0×10⁹ CFU/g to 1.0×10¹² CFU/g.

The chemical insecticide can be selected from the group consisting of A0) various insecticides, including agrigata, al-phosphide, amblyseius, aphelinus, aphidius, aphidoletes, artimisinin, autographa californica NPV, azocyclotin, bacillus-subtilis, bacillus-thur.-aizawai, bacillus-thur.-kurstaki, bacillus-thuringiensis, beauveria, beauveria-bassiana, betacyfluthrin, biologicals, bisultap, brofluthrinate, bromophos-e, bromopropylate, Bt-Corn-GM, Bt-Soya-GM, capsaicin, cartap, celastrus-extract, chlorantraniliprole, chlorbenzuron, chlorethoxyfos, chlorfluazuron, chlorpyrifos-e, cnidiadin, cryolite, cyanophos, cyantraniliprole, cyhalothrin, cyhexatin, cypermethrin, dacnusa, DCIP, dichloropropene, dicofol, diglyphus, diglyphus+dacnusa, dimethacarb, dithioether, dodecyl-acetate, emamectin, encarsia, EPN, eretmocerus, ethylene-dibromide, eucalyptol, fatty-acids, fatty-acids/salts, fenazaquin, fenobucarb (BPMC), fenpyroximate, flubrocythrinate, flufenzine, formetanate, formothion, furathiocarb, gamma-cyhalothrin, garlic-juice, granulosis-virus, harmonia, heliothis armigera NPV, inactive bacterium, indol-3-ylbutyric acid, iodomethane, iron, isocarbofos, isofenphos, isofenphos-m, isoprocarb, isothioate, kaolin, lindane, liuyangmycin, matrine, mephosfolan, metaldehyde, metarhizium-anisopliae, methamidophos, metolcarb (MTMC), mineral-oil, mirex, m-isothiocyanate, monosultap, myrothecium verrucaria, naled, neochrysocharis formosa, nicotine, nicotinoids, oil, oleic-acid, omethoate, orius, oxymatrine, paecilomyces, paraffin-oil, parathion-e, pasteuria, petroleum-oil, pheromones, phosphorus-acid, photorhabdus, phoxim, phytoseiulus, pirimiphos-e, plant-oil, plutella xylostella GV, polyhedrosis-virus, polyphenol-extracts, potassium-oleate, profenofos, prosuler, prothiofos, pyraclofos, pyrethrins, pyridaphenthion, pyrimidifen, pyriproxifen, quillay-extract, quinomethionate, rape-oil, rotenone, saponin, saponozit, sodium-compounds, sodium-fluosilicate, starch, steinernema, streptomyces, sulfluramid, sulphur, tebupirimfos, tefluthrin, temephos, tetradifon, thiofanox, thiometon, transgenics (e.g., Cry3Bb1), triazamate, trichoderma, trichogramma, triflumuron, verticillium, vertrine, isomeric insecticides (e.g., kappa-bifenthrin, kappa-tefluthrin), dichoromezotiaz, broflanilide, pyraziflumid; A1) the class of carbamates, including aldicarb, alanycarb, benfuracarb, carbaryl, carbofuran, carbosulfan, methiocarb, methomyl, oxamyl, pirimicarb, propoxur and thiodicarb; A2) the class of organophosphates, including acephate, azinphos-ethyl, azinphos-methyl, chlorfenvinphos, chlorpyrifos, chlorpyrifos-methyl, demeton-S-methyl, diazinon, dichlorvos/DDVP, dicrotophos, dimethoate, disulfoton, ethion, fenitrothion, fenthion, isoxathion, malathion, methamidaphos, methidathion, mevinphos, monocrotophos, oxymethoate, oxydemeton-methyl, parathion, parathion-methyl, phenthoate, phorate, phosalone, phosmet, phosphamidon, pirimiphos-methyl, quinalphos, terbufos, tetrachlorvinphos, triazophos and trichlorfon; A3) the class of cyclodiene organochlorine compounds such as endosulfan; A4) the class of fiproles, including ethiprole, fipronil, pyrafluprole and pyriprole; A5) the class of neonicotinoids, including acetamiprid, clothianidin, dinotefuran, imidacloprid, nitenpyram, thiacloprid and thiamethoxam; A6) the class of spinosyns such as spinosad and spinetoram; A7) chloride channel activators from the class of mectins, including abamectin, emamectin benzoate, ivermectin, lepimectin and milbemectin; A8) juvenile hormone mimics such as hydroprene, kinoprene, methoprene, fenoxycarb and pyriproxyfen; A9) selective homopteran feeding blockers such as pymetrozine, flonicamid and pyrifluquinazon; A10) mite growth inhibitors such as clofentezine, hexythiazox and etoxazole; A11) inhibitors of mitochondrial ATP synthase such as diafenthiuron, fenbutatin oxide and propargite; uncouplers of oxidative phosphorylation such as chlorfenapyr; A12) nicotinic acetylcholine receptor channel blockers such as bensultap, cartap hydrochloride, thiocyclam and thiosultap sodium; A13) inhibitors of the chitin biosynthesis type 0 from the benzoylurea class, including bistrifluron, diflubenzuron, flufenoxuron, hexaflumuron, lufenuron, novaluron and teflubenzuron; A14) inhibitors of the chitin biosynthesis type 1 such as buprofezin; A15) moulting disruptors such as cyromazine; A16) ecdyson receptor agonists such as methoxyfenozide, tebufenozide, halofenozide and chromafenozide; A17) octopamin receptor agonists such as amitraz; A18) mitochondrial complex electron transport inhibitors pyridaben, tebufenpyrad, tolfenpyrad, flufenerim, cyenopyrafen, cyflumetofen, hydramethylnon, acequinocyl or fluacrypyrim; A19) voltage-dependent sodium channel blockers such as indoxacarb and metaflumizone; A20) inhibitors of the lipid synthesis such as spirodiclofen, spiromesifen and spirotetramat; A21) ryanodine receptor-modulators from the class of diamides, including flubendiamide, the phthalamide compounds (R)-3-Chlor-N1-{2-methyl-4-[1,2,2,2-tetrafluor-1-(trifluormethyl)ethyl]phenyl}-N2-(1-methyl-2-methylsulfonylethyl)phthalamid and (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, chloranthraniliprole and cy-anthraniliprole; A22) compounds of unknown or uncertain mode of action such as azadirachtin, amidoflumet, bifenazate, fluensulfone, piperonyl butoxide, pyridalyl, sulfoxaflor; or A23) sodium channel modulators from the class of pyrethroids, including acrinathrin, allethrin, bifenthrin, cyfluthrin, lambda-cyhalothrin, cypermethrin, alpha-cypermethrin, beta-cypermethrin, zeta-cypermethrin, deltamethrin, esfenvalerate, etofenprox, fenpropathrin, fenvalerate, flucythrinate, tau-fluvalinate, permethrin, silafluofen and tralomethrin.

The chemical fungicide can be selected from the group consisting of: B0) benzovindiflupyr, anitiperonosporic, ametoctradin, amisulbrom, copper salts (e.g., copper hydroxide, copper oxychloride, copper sulfate, copper persulfate), boscalid, thiflumazide, flutianil, furalaxyl, thiabendazole, benodanil, mepronil, isofetamid, fenfuram, bixafen, fluxapyroxad, penflufen, sedaxane, coumoxystrobin, enoxastrobin, flufenoxystrobin, pyraoxystrobin, pyrametostrobin, triclopyricarb, fenaminstrobin, metominostrobin, pyribencarb, meptyldinocap, fentin acetate, fentin chloride, fentin hydroxide, oxytetracycline, chlozolinate, chloroneb, tecnazene, etridiazole, iodocarb, prothiocarb, Bacillus subtilis syn., Bacillus amyloliquefaciens (e.g., strains QST 713, FZB24, MB1600, D747), extract from Melaleuca alternifolia, pyrisoxazole, oxpoconazole, etaconazole, fenpyrazamine, naftifine, terbinafine, validamycin, pyrimorph, valifenalate, fthalide, probenazole, isotianil, laminarin, estract from Reynoutria sachalinensis, phosphorous acid and salts, teclofthalam, triazoxide, pyriofenone, organic oils, potassium bicarbonate, chlorothalonil, fluoroimide; B1) azoles, including bitertanol, bromuconazole, cyproconazole, difenoconazole, diniconazole, enilconazole, epoxiconazole, fluquinconazole, fenbuconazole, flusilazole, flutriafol, hexaconazole, imibenconazole, ipconazole, metconazole, myclobutanil, penconazole, propiconazole, prothioconazole, simeconazole, triadimefon, triadimenol, tebuconazole, tetraconazole, triticonazole, prochloraz, pefurazoate, imazalil, triflumizole, cyazofamid, benomyl, carbendazim, thia-bendazole, fuberidazole, ethaboxam, etridiazole and hymexazole, azaconazole, diniconazole-M, oxpoconazol, paclobutrazol, uniconazol, 1-(4-chloro-phenyl)-2-([1,2,4]triazol-1-yl)-cycloheptanol and imazalilsulfphate; B2) strobilurins, including azoxystrobin, dimoxystrobin, enestroburin, fluoxastrobin, kresoxim-methyl, methominostrobin, orysastrobin, picoxystrobin, pyraclostrobin, trifloxystrobin, enestroburin, methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate and methyl 2-(ortho-(2,5-dimethylphenyloxymethylene)-phenyl)-3-methoxyacrylate, 2-(2-(6-(3-chloro-2-methyl-phenoxy)-5-fluoro-pyrimidin-4-yloxy)-phenyl)-2-methoxyimino-N-methyl-acetamide and 3-methoxy-2-(2-(N-(4-methoxy-phenyl)-cyclopropanecarboximidoylsulfanylmethyl)-phenyl)-acrylic acid methyl ester; B3) carboxamides, including carboxin, benalaxyl, benalaxyl-M, fenhexamid, flutolanil, furametpyr, mepronil, metalaxyl, mefenoxam, ofurace, oxadixyl, oxycarboxin, penthiopyrad, isopyrazam, thifluzamide, tiadinil, 3,4-dichloro-N-(2-cyanophenyl)isothiazole-5-carboxamide, dimethomorph, flumorph, flumetover, fluopicolide (picobenzamid), zoxamide, carpropamid, diclocymet, mandipropamid, N-(2-(4-[3-(4-chlorophenyl)prop-2-ynyloxy]-3-methoxyphenyl)ethyl)-2-methanesulfonyl-amino-3-methylbutyramide, N-(2-(4-[3-(4-chloro-phenyl)prop-2-ynyloxy]-3-methoxy-phenyl)ethyl)-2-ethanesulfonylamino-3-methylbutyramide, methyl 3-(4-chlorophenyI)-3-(2-isopropoxycarbonyl-amino-3-methyl-butyrylamino)propionate, N-(4′-bromobiphenyl-2-yl)-4-difluoromethyl̂-methylthiazole-δ-carboxamide, N-(4′-trifluoromethyl-biphenyl-2-yl)-4-difluoromethyl-2-methylthiazole-5-carboxamide, N-(4′-chloro-3′-fluorobiphenyl-2-yl)-4-difluoromethyl-2-methyl-thiazole-5-carboxamide, N-(3\4′-dichloro-4-fluorobiphenyl-2-yl)-3-difluoro-methyl-1-methyl-pyrazole-4-carboxamide, N-(3′,4′-dichloro-5-fluorobiphenyl-2-yl)-3-difluoromethyl-1-methylpyrazole-4-carboxamide, N-(2-cyano-phenyl)-3,4-dichloroisothiazole-5-carboxamide, 2-amino-4-methyl-thiazole-5-carboxanilide, 2-chloro-N-(1,1,3-trimethyl-indan-4-yl)-nicotinamide, N-(2-(1,3-dimethylbutyl)-phenyl)-1,3-dimethyl-5-fluoro-1H-pyrazole-4-carboxamide, N-(4′-chloro-3′,5-difluoro-biphenyl-2-yl)-3-difluoromethyl-1-methyl-1H-pyrazole-4-carboxamide, N-(4′-chloro-3′,5-difluoro-biphenyl-2-yl)-3-trifluoromethyl-1-methyl-1H-pyrazole-4-carboxamide, N-(3′,4′-dichloro-5-fluoro-biphenyl-2-yl)-3-trifluoromethyl-1-methyl-1H-pyrazole-4-carboxamide, N-(3′,5-difluoro-4′-methyl-biphenyl-2-yl)-3-difluoromethyl-1-methyl-1H-pyrazole-4-carboxamide, N-(3′,5-difluoro-4′-methyl-biphenyl-2-yl)-3-trifluoromethyl-1-methyl-1H-pyrazole-4-carboxamide, N-(cis-2-bicyclopropyl-2-yl-phenyl)-3-difluoromethyl-1-methyl-1H-pyrazole-4-carboxamide, N-(trans-2-bicyclopropyl-2-yl-phenyl)-3-difluoro-methyl-1-methyl-1H-pyrazole-4-carboxamide, fluopyram, N-(3-ethyl-3,5-5-trimethyl-cyclohexyl)-3-formylamino-2-hydroxy-benzamide, oxytetracyclin, silthiofam, N-(6-methoxy-pyridin-3-yl) cyclopropanecarboxamide, 2-iodo-N-phenyl-benzamide, N-(2-bicyclo-propyl-2-yl-phenyl)-3-difluormethyl-1-methylpyrazol-4-ylcarboxamide, N-(3′,4′,5′-trifluorobiphenyl-2-yl)-1,3-dimethylpyrazol-4-ylcarboxamide, N-(3′,4′,5′-trifluorobiphenyl-2-yl)-1,3-dimethyl-5-fluoropyrazol-4-yl-carboxamide, N-(3′,4′,5′-trifluorobiphenyl-2-yl)-5-chloro-1,3-dimethylpyrazol-4-ylcarboxamide, N-(3′,4′,5′-trifluorobiphenyl-2-yl)-3-fluoromethyl-1-methylpyrazol-4-ylcarboxamide, N-(3′,4′,5′-trifluorobiphenyl-2-yl)-3-(chlorofluoromethyl)-1-methylpyrazol-4-ylcarboxamide, N-(3′,4′,5′-trifluorobiphenyl-2-yl)-3-difluoromethyl-1-methylpyrazol-4-ylcarboxamide, N-(3′,4′,5′-trifluorobiphenyl-2-yl)-3-difluoromethyl-5-fluoro-1-methylpyrazol-4-ylcarboxamide, N-(3′,4′,5′-trifluorobiphenyl-2-yl)-5-chloro-3-difluoromethyl-1-methylpyrazol-4-ylcarboxamide, N-(3′,4′,5′-trifluorobiphenyl-2-yl)-3-(chlorodifluoromethyl)-1-methylpyrazol-4-ylcarboxamide, N-(3′,4′,5′-trifluorobiphenyl-2-yl)-1-methyl-3-trifluoromethylpyrazol-4-ylcarboxamide, N-(3′,4′,5′-trifluorobiphenyl-2-yl)-5-fluoro-1-methyl-3-trifluoromethylpyrazol-4-ylcarboxamide, N-(3′,4′,5′-trifluorobiphenyl-2-yl)-5-chloro-1-methyl-3-trifluoromethylpyrazol-4-ylcarboxamide, N-(2′,4′,5′-trifluorobiphenyl-2-yl)-1,3-dimethylpyrazol-4-ylcarboxamide, N-(2′,4′,5′-trifluorobiphenyl-2-yl)-1,3-dimethyl-5-fluoropyrazol-4-ylcarboxamide, N-(2′,4′,5′-trifluorobiphenyl-2-yl)-5-chloro-1,3-dimethylpyrazol-4-ylcarboxamide, N-(2′,4′,5′-trifluorobiphenyl-2-yl)-3-fluoromethyl-1-methylpyrazol-4-ylcarboxamide, N-(2′,4′,5′-trifluorobiphenyl-2-yl)-3-(chlorofluoromethyl)-1-methylpyrazol-4-ylcarboxamide, N-(2′,4′,5′-trifluorobiphenyl-2-yl)-3-difluoromethyl-1-methylpyrazol-4-ylcarboxamide, N-(2′,4′,5′-trifluorobiphenyl-2-yl)-3-difluoromethyl-5-fluoro-1-methylpyrazol-4-ylcarboxamide, N-(2′,4′,5′-trifluorobiphenyl-2-yl)-5-chloro-3-difluoromethyl-1-methylpyrazol-4-ylcarboxamide, N-(2′,4′,5′-trifluorobiphenyl-2-yl)-3-(chlorodifluoromethyl)-1-methylpyrazol-4-ylcarboxamide, N-(2′,4′,5′-trifluorobiphenyl-2-yl)-1-methyl-3-trifluoromethylpyrazol-4-ylcarboxamide, N-(2′,4′,5′-trifluorobiphenyl-2-yl)-5-fluoro-1-methyl-3-trifluoromethylpyrazol-4-ylcarboxamide, N-(2′,4′,5′-trifluorobiphenyl-2-yl)-5-chloro-1-methyl-3-trifluoromethylpyrazol-4-ylcarboxamide, N-(3′,4′-dichloro-3-fluorobiphenyl-2-yl)-1-methyl-3-trifluoromethyl-1H-pyrazole-4-carboxamide, N-(3′,4′-dichloro-3-fluorobiphenyl-2-yl)-1-methyl-3-difluoromethyl-1H-pyrazole-4-carboxamide, N-(3′,4′-difluoro-3-fluorobiphenyl-2-yl)-1-methyl-3-trifluoromethyl-1H-pyrazole-4-carboxamide, N-(3′,4′-difluoro-3-fluorobiphenyl-2-yl)-1-methyl-S-difluoromethyl-1H-pyrazole-4-carboxamide, N-(3′-chloro-4′-fluoro-3-fluorobiphenyl-2-yl)-1-methyl-3-difluoromethyl-1H-pyrazole-4-carboxamide, N-(3′,4′-dichloro-4-fluorobiphenyl-2-yl)-1-methyl-3-trifluoromethyl-1H-pyrazole-4-carboxamide, N-(3′,4′-difluoro-4-fluorobiphenyl-2-yl)-1-methyl-S-trifluoromethyl-1H-pyrazole-4-carboxamide, N-(3′,4′-dichloro-4-fluorobiphenyl-2-yl)-1-methyl-3-difluoromethyl-1H-pyrazole-4-carboxamide, N-(3′,4′-difluoro-4-fluorobiphenyl-2-yl)-1-methyl-3-difluoromethyl-1H-pyrazole-4-carboxamide, N-(3′-chloro-4′-fluoro-4-fluorobiphenyl-2-yl)-1-methyl-S-difluoromethyl-1H-pyrazole-4-carboxamide, N-(3′,4′-dichloro-5-fluorobiphenyl-2-yl)-1-methyl-3-trifluoromethyl-1H-pyrazole-4-carboxamide, N-(3′,4′-difluoro-5-fluorobiphenyl-2-yl)-1-methyl-3-trifluoromethyl-1H-pyrazole-4-carboxamide, N-(3′,4′-dichloro-5-fluorobiphenyl-2-yl)-1-methyl-S-difluoromethyl-1H-pyrazole-carboxamide, N-(3′,4′-difluoro-5-fluorobiphenyl-2-yl)-1-methyl-3-difluoromethyl-1H-pyrazole-4-carboxamide, N-(3′,4′-dichloro-5-fluorobiphenyl-2-yl)-1,3-dimethyl-1H-pyrazole-4-carboxamide, N-(3′-chloro-4′-fluoro-5-fluorobiphenyl-2-yl)-1-methyl-3-difluoromethyl-1H-pyrazole-4-carboxamide, N-(4′-fluoro-4-fluorobiphenyl-2-yl)-1-methyl-3-trifluoromethyl-1H-pyrazole-4-carboxamide, N-(4′-fluoro-5-fluorobiphenyl-2-yl)-1-methyl-3-trifluoromethyl-1H-pyrazole-4-carboxamide, N-(4′-chloro-5-fluorobiphenyl-2-yl)-1-methyl-3-trifluoromethyl-1H-pyrazole-4-carboxamide, N-(4′-methyl-5-fluorobiphenyl-2-yl)-1-methyl-3-trifluoromethyl-1H-pyrazole-4-carboxamide, N-(4′-fluoro-5-fluorobiphenyl-2-yl)-1,3-dimethyl-1H-pyrazole-4-carboxamide, N-(4′-chloro-5-fluorobiphenyl-2-yl)-1,3-dimethyl-1H-pyrazole-4-carboxamide, N-(4′-methyl-5-fluorobiphenyl-2-yl)-1,3-dimethyl-1H-pyrazole-4-carboxamide, N-(4′-fluoro-6-fluorobiphenyl-2-yl)-1-methyl-3-trifluoromethyl-1H-pyrazole-4-carboxamide, N-(4′-chloro-6-fluorobiphenyl-2-yl)-1-methyl-3-trifluoromethyl-1H-pyrazole-4-carboxamide, N-[2-(1,1,2,3,3,3-hexafluoropropoxy)-phenyl]-3-difluoromethyl-1-methyl-1H-pyrazole-4-carboxamide, N-[4′-(trifluoromethylthio)-biphenyl-2-yl]-3-difluoromethyl-1-methyl-1H-pyrazole-4-carboxamide and N-[4′-(trifluoromethylthio)-biphenyl-2-yl]-1-methyl-3-trifluoromethyl-1-methyl-1H-pyrazole-4-carboxamide; B4) heterocyclic compounds, including fluazinam, pyrifenox, bupirimate, cyprodinil, fenarimol, ferimzone, mepanipyrim, nuarimol, pyrimethanil, triforine, fenpiclonil, fludioxonil, aldimorph, dodemorph, fenpropimorph, tridemorph, fenpropidin, iprodione, procymidone, vinclozolin, famoxadone, fenamidone, octhilinone, proben-azole, 5-chloro-7-(4-methyl-piperidin-1-yl)-6-(2,4,6-trifluorophenyl)-[1,2,4]triazolo[1,5-a]pyrimidine, anilazine, diclomezine, pyroquilon, proquinazid, tricyclazole, 2-butoxy-6-iodo-3-propylchromen-4-one, acibenzolar-S-methyl, captafol, captan, dazomet, folpet, fenoxanil, quinoxyfen, N,N-dimethyl-3-(3-bromo-6-fluoro-2-methylindole-1-sulfonyl)-[1,2,4]triazole-1-sulfonamide, 5-ethyl-6-octyl-[1,2,4]triazolo[1,5-a]pyrimidin-2,7-diamine, 2,3,5,6-tetrachloro-4-methanesulfonyl-pyridine, 3,4,5-trichloro-pyridine-2,6-di-carbonitrile, N-(1-(5-bromo-3-chloro-pyridin-2-yl)-ethyl)-2,4-dichloro-nicotinamide, N-((5-bromo-3-chloro pyridin-2-yl)-methyl)-2,4-dichloro-nicotinamide, diflumetorim, nitrapyrin, dodemorphacetate, fluoroimid, blasticidin-S, chinomethionat, debacarb, difenzoquat, difenzoquat-methylsulphat, oxolinic acid and piperalin; B5) carbamates, including mancozeb, maneb, metam, methasulphocarb, metiram, ferbam, propineb, thiram, zineb, ziram, diethofencarb, iprovalicarb, benthiavalicarb, propamocarb, propamocarb hydrochlorid, 4-fluorophenyl N-(1-(1-(4-cyanophenyl)-ethanesulfonyl)but-2-yl)carbamate, methyl 3-(4-chloro-phenyl)-3-(2-isopropoxycarbonylamino-3-methyl-butyrylamino)propanoate; or B6) other fungicides, including guanidine, dodine, dodine free base, iminoctadine, guazatine, antibiotics: kasugamycin, oxytetracyclin and its salts, streptomycin, polyoxin, validamycin A, nitrophenyl derivatives: binapacryl, dinocap, dinobuton, sulfur-containing heterocyclyl compounds: dithianon, isoprothiolane, organometallic compounds: fentin salts, organophosphorus compounds: edifenphos, iprobenfos, fosetyl, fosetyl-aluminum, phosphorous acid and its salts, pyrazophos, tolclofos-methyl, organochlorine compounds: dichlofluanid, flusulfamide, hexachloro-benzene, phthalide, pencycuron, quintozene, thiophanate, thiophanate-methyl, tolylfluanid, others: cyflufenamid, cymoxanil, dimethirimol, ethirimol, furalaxyl, metrafenone and spiroxamine, guazatine-acetate, iminoc-tadine-triacetate, iminoctadine-tris(albesilate), kasugamycin hydrochloride hydrate, dichlorophen, pentachlorophenol and its salts, N-(4-chloro-2-nitro-phenyl)-N-ethyl-4-methyl-benzenesulfonamide, dicloran, nitrothal-isopropyl, tecnazen, biphenyl, bronopol, diphenylamine, mildiomycin, oxincopper, prohexadione calcium, N-(cyclopropylmethoxyimino-(6-difluoromethoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluormethyl-4-(3-trimethylsilanyl-propoxy)-phenyl)-N-ethyl-N-methylformamidine and N′-(5-difluormethyl-2-methyl-4-(3-trimethylsilanyl-propoxy)-phenyl)-N-ethyl-N-methyl formamidine.

The chemical herbicide can be selected from the group consisting of: C1) acetyl-CoA carboxylase inhibitors (ACC), for example cyclohexenone oxime ethers, such as alloxydim, clethodim, cloproxydim, cycloxydim, sethoxydim, tralkoxydim, butroxydim, clefoxydim or tepraloxydim; phenoxyphenoxypropionic esters, such as clodinafop-propargyl, cyhalofop-butyl, diclofop-methyl, fenoxaprop-ethyl, fenoxaprop-P-ethyl, fenthiapropethyl, fluazifop-butyl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl or quizalofop-tefuryl; or arylaminopropionic acids, such as flamprop-methyl or flamprop-isopropyl; C2 acetolactate synthase inhibitors (ALS), for example imidazolinones, such as imazapyr, imazaquin, imazamethabenz-methyl (imazame), imazamox, imazapic or imazethapyr; pyrimidyl ethers, such as pyrithiobac-acid, pyrithiobac-sodium, bispyribac-sodium. KIH-6127 or pyribenzoxym; sulfonamides, such as florasulam, flumetsulam or metosulam; or sulfonylureas, such as amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, halosulfuron-methyl, imazosulfuron, metsulfuron-methyl, nicosulfuron, primisulfuron-methyl, prosulfuron, pyrazosulfuron-ethyl, rimsulfuron, sulfometuron-methyl, thifensulfuron-methyl, triasulfuron, tribenuron-methyl, triflusulfuron-methyl, tritosulfuron, sulfosulfuron, foramsulfuron or iodosulfuron; C3) amides, for example allidochlor (CDAA), benzoylprop-ethyl, bromobutide, chiorthiamid. diphenamid, etobenzanidibenzchlomet), fluthiamide, fosamin or monalide; C4) auxin herbicides, for example pyridinecarboxylic acids, such as clopyralid or picloram; or 2,4-D or benazolin; C5) auxin transport inhibitors, for example naptalame or diflufenzopyr; C6) carotenoid biosynthesis inhibitors, for example benzofenap, clomazone (dimethazone), diflufenican, fluorochloridone, fluridone, pyrazolynate, pyrazoxyfen, isoxaflutole, isoxachlortole, mesotrione, sulcotrione (chlormesulone), ketospiradox, flurtamone, norflurazon or amitrol; C7) enolpyruvylshikimate-3-phosphate synthase inhibitors (EPSPS), for example glyphosate or sulfosate; C8) glutamine synthetase inhibitors, for example bilanafos (bialaphos) or glufosinate-ammonium; C9) lipid biosynthesis inhibitors, for example anilides, such as anilofos or mefenacet; chloroacetanilides, such as dimethenamid, S-dimethenamid, acetochlor, alachlor, butachlor, butenachlor, diethatyl-ethyl, dimethachlor, metazachlor, metolachlor, S-metolachlor, pretilachlor, propachlor, prynachlor, terbuchlor, thenylchlor or xylachlor; thioureas, such as butylate, cycloate, di-allate, dimepiperate, EPTC. esprocarb, molinate, pebulate, prosulfocarb, thiobencarb (benthiocarb), tri-allate or vemolate; or benfuresate or perfluidone; C10) mitosis inhibitors, for example carbamates, such as asulam, carbetamid, chlorpropham, orbencarb, pronamid (propyzamid), propham or tiocarbazil; dinitroanilines, such as benefin, butralin, dinitramin, ethalfluralin, fluchloralin, oryzalin, pendimethalin, prodiamine or trifluralin; pyridines, such as dithiopyr or thiazopyr; or butamifos, chlorthal-dimethyl (DCPA) or maleic hydrazide; C11) protoporphyrinogen IX oxidase inhibitors, for example diphenyl ethers, such as acifluorfen, acifluorfen-sodium, aclonifen, bifenox, chlomitrofen (CNP), ethoxyfen, fluorodifen, fluoroglycofen-ethyl, fomesafen, furyloxyfen, lactofen, nitrofen, nitrofluorfen or oxyfluorfen; oxadiazoles, such as oxadiargyl or oxadiazon; cyclic imides, such as azafenidin, butafenacil, carfentrazone-ethyl, cinidon-ethyl, flumiclorac-pentyl, flumioxazin, flumipropyn, flupropacil, fluthiacet-methyl, sulfentrazone or thidiazimin; or pyrazoles, such as ET-751.JV 485 or nipyraclofen; C12) photosynthesis inhibitors, for example propanil, pyridate or pyridafol; benzothiadiazinones, such as bentazone; dinitrophenols, for example bromofenoxim, dinoseb, dinoseb-acetate, dinoterb or DNOC; dipyridylenes, such as cyperquat-chloride, difenzoquat-methylsulfate, diquat or paraquat-dichloride; ureas, such as chlorbromuron, chlorotoluron, difenoxuron, dimefuron, diuron, ethidimuron, fenuron, fluometuron, isoproturon, isouron, linuron, methabenzthiazuron, methazole, metobenzuron, metoxuron, monolinuron, neburon, siduron or tebuthiuron; phenols, such as bromoxynil or ioxynil; chloridazon; triazines, such as ametryn, atrazine, cyanazine, desmein, dimethamethryn, hexazinone, prometon, prometryn, propazine, simazine, simetryn, terbumeton, terbutryn, terbutylazine or trietazine; triazinones, such as metamitron or metribuzin; uracils, such as bromacil, lenacil or terbacil; or biscarbamates, such as desmedipham or phenmedipham; C13) synergists, for example oxiranes, such as tridiphane; C14) CIS cell wall synthesis inhibitors, for example isoxaben or dichlobenil; C16) various other herbicides, for example dichloropropionic acids, such as dalapon; dihydrobenzofurans, such as ethofumesate; phenylacetic acids, such as chlorfenac (fenac); or aziprotryn, barban, bensulide, benzthiazuron, benzofluor, buminafos, buthidazole, buturon, cafenstrole, chlorbufam, chlorfenprop-methyl, chloroxuron, cinmethylin, cumyluron, cycluron, cyprazine, cyprazole, dibenzyluron, dipropetryn, dymron, eglinazin-ethyl, endothall, ethiozin, flucabazone, fluorbentranil, flupoxam, isocarbamid, isopropalin, karbutilate, mefluidide, monuron, napropamide, napropanilide, nitralin, oxaciclomefone, phenisopham, piperophos, procyazine, profluralin, pyributicarb, secbumeton, sulfallate (CDEC), terbucarb, triaziflam, triazofenamid or trimeturon; and their environmentally compatible salts.

The chemical pesticide can be a nematicide selected from the group consisting of: benomyl, cloethocarb, aldoxycarb, tirpate, diamidafos, fenamiphos, cadusafos, dichlofenthion, ethoprophos, fensulfothion, fosthiazate, heterophos, isamidofof, isazofos, phosphocarb, thionazin, imicyafos, mecarphon, acetoprole, benclothiaz, chloropicrin, dazomet, fluensulfone, 1,3-dichloropropene (telone), dimethyl disulfide, metam sodium, metam potassium, metam salt (all M ITC generators), methyl bromide, soil amendments (e.g., mustard seeds, mustard seed extracts), steam fumigation of soil, allyl isothiocyanate (AITC), dimethyl sulfate, and furfual (aldehyde).

The pesticide can be a soil insecticide. The soil insecticides of the present invention can include, but are not limited to, Abamectin, Acephate, Acequinocyl, Acetamiprid, Acrinathrin, Agrigata, Alanycarb, Aldicarb, Alphacypermethrin, A1-phosphide, Amblyseius, Amitraz, Aphelinus, Aphidius, Aphidoletes, Artimisinin, Autographa californica NPV, Azadirachtin, Azinphos-m, Azocyclotin, Bacillus-subtilis, Bacillus-thur.-aizawai, Bacillus-thur.-kurstaki, Bacillus-thuringiensis, Beauveria, Beauveria-bassiana, Benfuracarb, Bensultap, Betacyfluthrin, Betacypermethrin, Bifenazate, Bifenthrin, Biologicals, Bispyribac-sodium, Bistrifluron, Bisultap, Brofluthrinate, Bromophos-e, Bromopropylate, Bt-Corn-GM, Bt-Soya-GM, Buprofezin, Cadusafos, Calcium-cyanamide, Capsaicin, Carbaryl, Carbofuran, Carbosulfan, Cartap, Celastrus-extract, Chlorantraniliprole, Chlorbenzuron, Chlorethoxyfos, Chlorfenapyr, Chlorfenvinphos, Chlorfluazuron, Chloropicrin, Chlorpyrifos, Chlorpyrifos-e, Chlorpyrifos-m, Chromafenozide, Clofentezine, Clothianidin, Cnidiadin, Cryolite, Cyanophos, Cyantraniliprole, Cyenopyrafen, Cyflumetofen, Cyfluthrin, Cyhalothrin, Cyhexatin, Cypermethrin, Cyromazine, Cytokinin, Dacnusa, Dazomet, DCIP, Deltamethrin, Demeton-S-m, Diafenthiuron, Diazinon, Dichloropropene, Dichlorvos (DDVP), Dicofol, Diflubenzuron, Diglyphus, Diglyphus+Dacnusa, Dimethacarb, Dimethoate, Dinotefuran, Disulfoton, Dithioether, Dodecyl-acetate, Emamectin, Emamectin-benzoate, Encarsia, Endosulfan, EPN, Eretmocerus, Esfenvalerate, Ethion, Ethiprole, Ethoprophos, Ethylene-dibromide, Etofenprox, Etoxazole, Eucalyptol, Fatty-acids, Fatty-acids/Salts, Fenamiphos, Fenazaquin, Fenbutatin-oxide, Fenitrothion, Fenobucarb (BPMC), Fenoxycarb, Fenpropathrin, Fenpyroximate, Fenthion, Fenvalerate, Fiproles, Fipronil, Flonicamid, Flubendiamide, Flubrocythrinate, Flucythrinate, Flufenoxuron, Flufenzine, Formetanate, Formothion, Fosthiazate, Furathiocarb, Gamma-cyhalothrin, Garlic-juice, Granulosis-virus, Harmonia, Heliothis armigera NPV, Hexaflumuron, Hexythiazox, Imicyafos, Imidacloprid, Inactive bacterium, Indol-3-ylbutyric acid, Indoxacarb, Iodomethane, Iprodione, Iron, Isazofos, Isocarbofos, Isofenphos, Isofenphos-m, Isoprocarb, Isothioate, Isoxathion, Kaolin, Lambda-cyhalothrin, Lepimectin, Lindane, Liuyangmycin, Lufenuron, Malathion, Matrine, Mephosfolan, Metaflumizone, Metaldehyde, Metam-potassium, Metam-sodium, Metarhizium-anisopliae, Methamidophos, Methidathion, Methiocarb, Methomyl, Methoxyfenozide, Methyl-bromide, Metolcarb (MTMC), Mevinphos, Milbemectin, Mineral-oil, Mirex, M-isothiocyanate, Monocrotophos, Monosultap, Myrothecium verrucaria, Naled, Neochrysocharis formosa, Nicotine, Nicotinoids, Nitenpyram, Novaluron, Oil, Oleic-acid, Omethoate, Organophosphates, Orius, Other pyrethroids, Oxamyl, Oxydemeton-m, Oxymatrine, Paecilomyces, Paraffin-oil, Parathion-e, Parathion-m, Pasteuria, Permethrin, Petroleum-oil, Phenthoate, Pheromones, Phorate, Phosalone, Phosmet, Phosphamidon, Phosphorus-acid, Photorhabdus, Phoxim, Phytoseiulus, Piperonyl-butoxide, Pirimicarb, Pirimiphos-e, Pirimiphos-m, Plant-oil, Plutella xylostella GV, Polyhedrosis-virus, Polyphenol-extracts, Potassium-oleate, Pyrethroids, Profenofos, Propargite, Propoxur, Prosuler, Prothiofos, Pymetrozine, Pyraclofos, Pyrethrins, Pyridaben, Pyridalyl, Pyridaphenthion, Pyrifluquinazon, Pyrimidifen, Pyriproxifen, Quillay-extract, Quinalphos, Quinomethionate, Rape-oil, Rotenone, Saponin, Saponozit, Silafluofen, Sodium-compounds, Sodium-fluosilicate, Spinetoram, Spinosad, Spirodiclofen, Spiromesifen, Spirotetramat, Starch, Steinernema, Streptomyces, Sulfluramid, Sulfoxaflor, Sulphur, Tau-fluvalinate, Tebufenozide, Tebufenpyrad, Tebupirimfos, Teflubenzuron, Tefluthrin, Temephos, Terbufos, Tetradifon, Thiacloprid, Thiamethoxam, Thiocyclam, Thiodicarb, Thiofanox, Thiometon, Thiosultap-sodium, Tolfenpyrad, Tralomethrin, Transgenic (Cry3Bb1), Triazamate, Triazophos, Trichlorfon, Trichoderma, Trichogramma, Triflumuron, Verticillium, Vertrine, and Zeta-cypermethrin.

In various embodiments, the soil insecticides can be Corn Insecticides including: Chlorpyrifos-e, Cypermethrin, Tefluthrin, Imidacloprid, Bifenthrin, Chlorantraniliprole, Thiodicarb, Tebupirimfos, Carbofuran, Fipronil, Zeta-cypermethrin, Terbufos, Phorate, Acetamiprid, Thiamethoxam, Carbosulfan, and Chlorethoxyfos. Potato Insecticides including: Imidacloprid, Oxamyl, Thiamethoxam, Chlorpyrifos-e, Chlorantraniliprole, Carbofuran, Fipronil, Acetamiprid, Ethoprophos, Tefluthrin, Clothianidin, Fenamiphos, Phorate, Bifenthrin, Carbosulfan, Cadusafos, and Terbufos. Soybean Insecticides: Chlorantraniliprole, Thiamethoxam, Flubendiamide, Imidacloprid, Chlorpyrifos-e, Bifenthrin, Thiodicarb, Fipronil, Cypermethrin, Acetamiprid, Carbosulfan, Carbofuran, and Phorate. Sugarcane Insecticides including: Fipronil, Imidacloprid, Thiamethoxam, Chlorantraniliprole, Ethiprole, Carbofuran, Chlorpyrifos-e, Cadusafos, Phorate, Terbufos, Bifenthrin, Abamectin, Carbosulfan, Cypermethrin, Oxamyl, and Acetamiprid. Tomato Insecticides including: Chlorantraniliprole, Imidacloprid, Thiamethoxam, Chlorpyrifos-e, Acetamiprid, Oxamyl, Flubendiamide, Carbofuran, Bifenthrin, Zeta-cypermethrin, Cadusafos, and Tefluthrin. Vegetable Crop Insecticides including: Abamectin, Chlorantraniliprole, Imidacloprid, Chlorpyrifos-e, Acetamiprid, Thiamethoxam, Flubendiamide, Cypermethrin, Fipronil, Oxamyl, Bifenthrin, Clothianidin, Tefluthrin, Terbufos, Phorate, Cadusafos, and Carbosulfan. Banana Insecticides including: Oxamyl, Chlorpyrifos-e, Terbufos, Cadusafos, Carbofuran, Ethoprophos, Acetamiprid, Cypermethrin, Bifenthrin, Fipronil, and Carbosulfan.

The soil insecticide can be Pyrethroids, bifenthrin, tefluthrin, cypermethrin, zeta-cypermethrin, lambda-cyhalothrin, gamma-cyhalothrin, deltamethrin, cyfluthrin, alphacypermethrin, permethrin; Organophosphates, chlorpyrifos-ethyl, tebupirimphos, terbufos, ethoprophos, cadusafos; Nicotinoids, imidacloprid, thiamethoxam, clothianidin, Carbamates, thiodicarb, oxamyl, carbofuran, carbosulfan, Fiproles, fipronil, ethiprole.

In one or more embodiments, the soil insecticide can be one or a combination of bifenthrin, pyrethroids, bifenthrin, tefluthrin, zeta-cypermethrin, organophosphates, chlorethoxyphos, chlorpyrifos-e, tebupirimphos, cyfluthrin, fiproles, fipronil, nicotinoids, or clothianidin. The soil insecticide can include bifenthrin and clothianidin. The soil insecticide can include bifenthrin or zeta-cypermethrin.

The insecticide can be bifenthrin and the composition formulation can further comprise a hydrated aluminum-magnesium silicate, and at least one dispersant selected from the group consisting of a sucrose ester, a lignosulfonate, an alkylpolyglycoside, a naphthalenesulfonic acid formaldehyde condensate and a phosphate ester. The bifenthrin insecticide can be present at a concentration ranging from 0.1 g/ml to 0.2 g/ml. The bifenthrin insecticide can be present at a concentration of about 0.1715 g/ml. The rate of application of the bifenthrin insecticide can be in the range of from about 0.1 gram of bifenthrin per hectare (g ai/ha) to about 1000 g ai/ha, more preferably in a range of from about 1 g ai/ha to about 100 g ai/ha.

In one embodiment, a composition is provided for benefiting plant growth, the composition having a biologically pure culture of a bacterial or a fungal strain having properties beneficial to plant growth and a soil insecticide in a formulation suitable as a liquid fertilizer, wherein each of the bacterial or fungal strains and the soil insecticide is present in an amount suitable to benefit plant growth. The composition can be in the form of a liquid, a dust, a spreadable granule, a dry wettable powder, or a dry wettable granule. The bacterial strain can be in the form of spores or vegetative cells. The bacterial strain can be a strain of Bacillus. The Bacillus can be a Bacillus pumilus, a Bacillus licheniformis, a Bacillus subtilis, or a combination thereof. The Bacillus pumilus can be Bacillus pumilus RT1279 deposited as PTA-121164. The Bacillus licheniformis can be Bacillus licheniformis CH200 deposited as accession No. DSM 17236. The bacterial strain can be Bacillus pumilus RT1279 deposited as PTA-121164 present at a concentration ranging from 1.0×10⁹ CFU/g to 1.0×10¹² CFU/g or Bacillus licheniformis CH200 deposited as accession No. DSM 17236 present in an amount ranging from 1.0×10⁹ CFU/g to 1.0×10¹² CFU/g.

In another embodiment, a product is provided for benefiting plant growth, the product composition including a first component comprising a first composition having a biologically pure culture of a bacterial or a fungal strain having properties beneficial to plant growth and a second component comprising a second composition having a soil insecticide. In this embodiment, each component is in a formulation suitable as a liquid fertilizer. In another embodiment a product is provided, the product comprising: a first container containing a first composition comprising a biologically pure culture of a bacterial strain having plant growth promoting properties; and a second container containing a second composition comprising at least one pesticide, wherein each of the first and second compositions is in a formulation compatible with a liquid fertilizer. In one preferred embodiment, the pesticide is a soil insecticide. Soil insectides are disclosed hereinabove. In these embodiments, the first and second components or containers can be contained within one package or separately packaged and combined in a single product. Each composition is in an amount suitable to benefit plant growth. Instructions can be provided for delivering in a liquid fertilizer and in an amount suitable to benefit plant growth, a combination of the first and second compositions to seed of the plant, roots of the plant, a cutting of the plant, a graft of the plant, callus tissue of the plant; soil or growth medium surrounding the plant; soil or growth medium before sowing seed of the plant in the soil or growth medium; or soil or growth medium before planting the plant, the plant cutting, the plant graft, or the plant callus tissue in the soil or growth medium. Each of the first and second compositions can be in the form of a liquid, a dust, a spreadable granule, a dry wettable powder, or a dry wettable granule. The bacterial strain can be in the form of spores or vegetative cells. The bacterial strain can be a strain of Bacillus. The Bacillus can be a Bacillus pumilus, a Bacillus licheniformis, a Bacillus subtilis, or a combination thereof. The Bacillus pumilus can be Bacillus pumilus RTI279 deposited as PTA-121164. The Bacillus licheniformis can be Bacillus licheniformis CH200 deposited as accession No. DSM 17236. The bacterial strain can be Bacillus pumilus RTI279 deposited as PTA-121164 present at a concentration ranging from 1.0×10⁹ CFU/g to 1.0×10¹² CFU/g or Bacillus licheniformis CH200 deposited as accession No. DSM 17236 present in an amount ranging from 1.0×10⁹ CFU/g to 1.0×10¹² CFU/g.

In one embodiment, a method is provided for benefiting plant growth that includes delivering to a plant in a liquid fertilizer a composition having a growth promoting microorganism and a soil insecticide. The composition includes a biologically pure culture of a bacterial or a fungal strain having properties beneficial to plant growth and a soil insecticide in a formulation suitable as a liquid fertilizer. Each of the bacterial or fungal strains and the soil insecticide is present in an amount sufficient to benefit plant growth. The composition can be delivered in the liquid fertilizer in an amount suitable for benefiting plant growth to: seed of the plant, roots of the plant, a cutting of the plant, a graft of the plant, callus tissue of the plant, soil or growth medium surrounding the plant, soil or growth medium before sowing seed of the plant in the soil or growth medium, or soil or growth medium before planting the plant, the plant cutting, the plant graft, or the plant callus tissue in the soil or growth medium.

In one embodiment a method for benefiting plant growth is provided, the method comprising delivering to a plant or a part thereof in a liquid fertilizer a composition comprising: a) a biologically pure culture of a bacterial strain having plant growth promoting properties, and b) a soil insecticide, wherein each of the bacterial strain and the soil insecticide is present in an amount sufficient to benefit plant growth, wherein the composition is delivered in the liquid fertilizer in an amount suitable for benefiting plant growth to: seed of the plant, roots of the plant, a cutting of the plant, a graft of the plant, callus tissue of the plant, soil or growth medium surrounding the plant, soil or growth medium before sowing seed of the plant in the soil or growth medium, or soil or growth medium before planting the seed of the plant, the plant cutting, the plant graft, or the plant callus tissue in the soil or growth medium.

In another embodiment, a method is provided for benefiting plant growth that includes delivering in a liquid fertilizer in an amount suitable for benefiting plant growth a combination of a first component comprising a first composition having a biologically pure culture of a bacterial or a fungal strain having properties beneficial to plant growth and a second component comprising a second composition having a soil insecticide. Each component is in a formulation suitable as a liquid fertilizer and each component is in an amount suitable to benefit plant growth. The composition can be delivered to: seed of the plant, roots of the plant, a cutting of the plant, a graft of the plant, callus tissue of the plant; soil or growth medium surrounding the plant, soil or growth medium before sowing seed of the plant in the soil or growth medium, or soil or growth medium before planting the plant, the plant cutting, the plant graft, or the plant callus tissue in the soil or growth medium

The isolated bacterial strains of the present invention can include those of the Bacillus species, including species such as, for example, Bacillus pumilus, Bacillus licheniformis, and Bacillus subtilis, and combinations thereof. The Bacillus pumilus can be, for example, Bacillus pumilus RT1279 deposited as PTA-121164. The Bacillus licheniformis can be, for example, Bacillus licheniformis CH200 deposited as accession No. DSM 17236. The Bacillus licheniformis can be, for example, Bacillus subtilis CH201 deposited as accession No. DSM 17231.

The bacterial strain can be in the form of spores or in the form of vegetative cells. The amount of the bacterial strain suitable for benefiting plant growth can range from 1.0×10⁸ CFU/ha to 1.0×10¹³ CFU/ha. The amount of Bacillus pumilus RT1279 suitable for benefiting plant growth can range from 1.0×10⁸ CFU/ha to 1.0×10¹³ CFU/ha. The amount of Bacillus licheniformis CH200 suitable for benefiting plant growth can range from 1.0×10⁸ CFU/ha to 1.0×10¹³ CFU/ha.

The soil insecticides of the present invention can include, but are not limited to, Abamectin, Acephate, Acequinocyl, Acetamiprid, Acrinathrin, Agrigata, Alanycarb, Aldicarb, Alphacypermethrin, A1-phosphide, Amblyseius, Amitraz, Aphelinus, Aphidius, Aphidoletes, Artimisinin, Autographa californica NPV, Azadirachtin, Azinphos-m, Azocyclotin, Bacillus-subtilis, Bacillus-thur.-aizawai, Bacillus-thur.-kurstaki, Bacillus-thuringiensis, Beauveria, Beauveria-bassiana, Benfuracarb, Bensultap, Betacyfluthrin, Betacypermethrin, Bifenazate, Bifenthrin, Biologicals, Bispyribac-sodium, Bistrifluron, Bisultap, Brofluthrinate, Bromophos-e, Bromopropylate, Bt-Corn-GM, Bt-Soya-GM, Buprofezin, Cadusafos, Calcium-cyanamide, Capsaicin, Carbaryl, Carbofuran, Carbosulfan, Cartap, Celastrus-extract, Chlorantraniliprole, Chlorbenzuron, Chlorethoxyfos, Chlorfenapyr, Chlorfenvinphos, Chlorfluazuron, Chloropicrin, Chlorpyrifos, Chlorpyrifos-e, Chlorpyrifos-m, Chromafenozide, Clofentezine, Clothianidin, Cnidiadin, Cryolite, Cyanophos, Cyantraniliprole, Cyenopyrafen, Cyflumetofen, Cyfluthrin, Cyhalothrin, Cyhexatin, Cypermethrin, Cyromazine, Cytokinin, Dacnusa, Dazomet, DCIP, Deltamethrin, Demeton-S-m, Diafenthiuron, Diazinon, Dichloropropene, Dichlorvos (DDVP), Dicofol, Diflubenzuron, Diglyphus, Diglyphus+Dacnusa, Dimethacarb, Dimethoate, Dinotefuran, Disulfoton, Dithioether, Dodecyl-acetate, Emamectin, Emamectin-benzoate, Encarsia, Endosulfan, EPN, Eretmocerus, Esfenvalerate, Ethion, Ethiprole, Ethoprophos, Ethylene-dibromide, Etofenprox, Etoxazole, Eucalyptol, Fatty-acids, Fatty-acids/Salts, Fenamiphos, Fenazaquin, Fenbutatin-oxide, Fenitrothion, Fenobucarb (BPMC), Fenoxycarb, Fenpropathrin, Fenpyroximate, Fenthion, Fenvalerate, Fiproles, Fipronil, Flonicamid, Flubendiamide, Flubrocythrinate, Flucythrinate, Flufenoxuron, Flufenzine, Formetanate, Formothion, Fosthiazate, Furathiocarb, Gamma-cyhalothrin, Garlic-juice, Granulosis-virus, Harmonia, Heliothis armigera NPV, Hexaflumuron, Hexythiazox, Imicyafos, Imidacloprid, Inactive bacterium, Indol-3-ylbutyric acid, Indoxacarb, Iodomethane, Iprodione, Iron, Isazofos, Isocarbofos, Isofenphos, Isofenphos-m, Isoprocarb, Isothioate, Isoxathion, Kaolin, Lambda-cyhalothrin, Lepimectin, Lindane, Liuyangmycin, Lufenuron, Malathion, Matrine, Mephosfolan, Metaflumizone, Metaldehyde, Metam-potassium, Metam-sodium, Metarhizium-anisopliae, Methamidophos, Methidathion, Methiocarb, Methomyl, Methoxyfenozide, Methyl-bromide, Metolcarb (MTMC), Mevinphos, Milbemectin, Mineral-oil, Mirex, M-isothiocyanate, Monocrotophos, Monosultap, Myrothecium verrucaria, Naled, Neochrysocharis formosa, Nicotine, Nicotinoids, Nitenpyram, Novaluron, Oil, Oleic-acid, Omethoate, Organophosphates, Orius, Other pyrethroids, Oxamyl, Oxydemeton-m, Oxymatrine, Paecilomyces, Paraffin-oil, Parathion-e, Parathion-m, Pasteuria, Permethrin, Petroleum-oil, Phenthoate, Pheromones, Phorate, Phosalone, Phosmet, Phosphamidon, Phosphorus-acid, Photorhabdus, Phoxim, Phytoseiulus, Piperonyl-butoxide, Pirimicarb, Pirimiphos-e, Pirimiphos-m, Plant-oil, Plutella xylostella GV, Polyhedrosis-virus, Polyphenol-extracts, Potassium-oleate, Pyrethroids, Profenofos, Propargite, Propoxur, Prosuler, Prothiofos, Pymetrozine, Pyraclofos, Pyrethrins, Pyridaben, Pyridalyl, Pyridaphenthion, Pyrifluquinazon, Pyrimidifen, Pyriproxifen, Quillay-extract, Quinalphos, Quinomethionate, Rape-oil, Rotenone, Saponin, Saponozit, Silafluofen, Sodium-compounds, Sodium-fluosilicate, Spinetoram, Spinosad, Spirodiclofen, Spiromesifen, Spirotetramat, Starch, Steinernema, Streptomyces, Sulfluramid, Sulfoxaflor, Sulphur, Tau-fluvalinate, Tebufenozide, Tebufenpyrad, Tebupirimfos, Teflubenzuron, Tefluthrin, Temephos, Terbufos, Tetradifon, Thiacloprid, Thiamethoxam, Thiocyclam, Thiodicarb, Thiofanox, Thiometon, Thiosultap-sodium, Tolfenpyrad, Tralomethrin, Transgenic (Cry3Bb1), Triazamate, Triazophos, Trichlorfon, Trichoderma, Trichogramma, Triflumuron, Verticillium, Vertrine, and Zeta-cypermethrin.

In various embodiments, the soil insecticides can be Corn Insecticides including: Chlorpyrifos-e, Cypermethrin, Tefluthrin, Imidacloprid, Bifenthrin, Chlorantraniliprole, Thiodicarb, Tebupirimfos, Carbofuran, Fipronil, Zeta-cypermethrin, Terbufos, Phorate, Acetamiprid, Thiamethoxam, Carbosulfan, and Chlorethoxyfos. Potato Insecticides including: Imidacloprid, Oxamyl, Thiamethoxam, Chlorpyrifos-e, Chlorantraniliprole, Carbofuran, Fipronil, Acetamiprid, Ethoprophos, Tefluthrin, Clothianidin, Fenamiphos, Phorate, Bifenthrin, Carbosulfan, Cadusafos, and Terbufos. Soybean Insecticides: Chlorantraniliprole, Thiamethoxam, Flubendiamide, Imidacloprid, Chlorpyrifos-e, Bifenthrin, Thiodicarb, Fipronil, Cypermethrin, Acetamiprid, Carbosulfan, Carbofuran, and Phorate. Sugarcane Insecticides including: Fipronil, Imidacloprid, Thiamethoxam, Chlorantraniliprole, Ethiprole, Carbofuran, Chlorpyrifos-e, Cadusafos, Phorate, Terbufos, Bifenthrin, Abamectin, Carbosulfan, Cypermethrin, Oxamyl, and Acetamiprid. Tomato Insecticides including: Chlorantraniliprole, Imidacloprid, Thiamethoxam, Chlorpyrifos-e, Acetamiprid, Oxamyl, Flubendiamide, Carbofuran, Bifenthrin, Zeta-cypermethrin, Cadusafos, and Tefluthrin. Vegetable Crop Insecticides including: Abamectin, Chlorantraniliprole, Imidacloprid, Chlorpyrifos-e, Acetamiprid, Thiamethoxam, Flubendiamide, Cypermethrin, Fipronil, Oxamyl, Bifenthrin, Clothianidin, Tefluthrin, Terbufos, Phorate, Cadusafos, and Carbosulfan. Banana Insecticides including: Oxamyl, Chlorpyrifos-e, Terbufos, Cadusafos, Carbofuran, Ethoprophos, Acetamiprid, Cypermethrin, Bifenthrin, Fipronil, and Carbosulfan.

In one or more embodiments, the soil insecticide can be one or a combination of bifenthrin, pyrethroids, bifenthrin, tefluthrin, zeta-cypermethrin, organophosphates, chlorethoxyphos, chlorpyrifos-e, tebupirimphos, cyfluthrin, fiproles, fipronil, nicotinoids, or clothianidin. The soil insecticide can include bifenthrin and clothianidin. The soil insecticide can include bifenthrin or zeta-cypermethrin.

The insecticide can be bifenthrin and the composition formulation can further comprise a hydrated aluminum-magnesium silicate, and at least one dispersant selected from the group consisting of a sucrose ester, a lignosulfonate, an alkylpolyglycoside, a naphthalenesulfonic acid formaldehyde condensate and a phosphate ester. The bifenthrin insecticide can be present at a concentration ranging from 0.1 g/ml to 0.2 g/ml. The bifenthrin insecticide can be present at a concentration of about 0.1715 g/ml. The rate of application of the bifenthrin insecticide can be in the range of from about 0.1 gram of bifenthrin per hectare (g ai/ha) to about 1000 g ai/ha, more preferably in a range of from about 1 g ai/ha to about 100 g ai/ha.

The compositions of the present invention can further include one or a combination of a microbial or a chemical insecticide, fungicide, nematicide, bacteriocide, herbicide, plant extract, or plant growth regulator present in an amount sufficient to benefit plant growth and/or to confer protection against a pathogenic infection in a susceptible plant. The composition can further include a nematicide and the nematicide can include cadusafos.

In addition, suitable insecticides, herbicides, fungicides, and nematicides of the compositions and methods of the present invention can include the following:

Insecticides: A0) agrigata, al-phosphide, amblyseius, aphelinus, aphidius, aphidoletes, artimisinin, autographa californica NPV, azocyclotin, Bacillus subtilis, Bacillus thuringiensis-spp. aizawai, Bacillus thuringiensis spp. kurstaki, Bacillus thuringiensis, Beauveria, Beauveria bassiana, betacyfluthrin, biologicals, bisultap, brofluthrinate, bromophos-e, bromopropylate, Bt-Corn-GM, Bt-Soya-GM, capsaicin, cartap, celastrus-extract, chlorantraniliprole, chlorbenzuron, chlorethoxyfos, chlorfluazuron, chlorpyrifos-e, cnidiadin, cryolite, cyanophos, cyantraniliprole, cyhalothrin, cyhexatin, cypermethrin, dacnusa, DCIP, dichloropropene, dicofol, diglyphus, diglyphus+dacnusa, dimethacarb, dithioether, dodecyl-acetate, emamectin, encarsia, EPN, eretmocerus, ethylene-dibromide, eucalyptol, fatty-acids, fatty-acids/salts, fenazaquin, fenobucarb (BPMC), fenpyroximate, flubrocythrinate, flufenzine, formetanate, formothion, furathiocarb, gamma-cyhalothrin, garlic-juice, granulosis-virus, harmonia, heliothis armigera NPV, inactive bacterium, indol-3-ylbutyric acid, iodomethane, iron, isocarbofos, isofenphos, isofenphos-m, isoprocarb, isothioate, kaolin, lindane, liuyangmycin, matrine, mephosfolan, metaldehyde, metarhizium-anisopliae, methamidophos, metolcarb (MTMC), mineral-oil, mirex, m-isothiocyanate, monosultap, myrothecium verrucaria, naled, neochrysocharis formosa, nicotine, nicotinoids, oil, oleic-acid, omethoate, orius, oxymatrine, paecilomyces, paraffin-oil, parathion-e, pasteuria, petroleum-oil, pheromones, phosphorus-acid, photorhabdus, phoxim, phytoseiulus, pirimiphos-e, plant-oil, plutella xylostella GV, polyhedrosis-virus, polyphenol-extracts, potassium-oleate, profenofos, prosuler, prothiofos, pyraclofos, pyrethrins, pyridaphenthion, pyrimidifen, pyriproxifen, quillay-extract, quinomethionate, rape-oil, rotenone, saponin, saponozit, sodium-compounds, sodium-fluosilicate, starch, steinernema, streptomyces, sulfluramid, sulphur, tebupirimfos, tefluthrin, temephos, tetradifon, thiofanox, thiometon, transgenics (e.g., Cry3Bb1), triazamate, trichoderma, trichogramma, triflumuron, verticillium, vertrine, isomeric insecticides (e.g., kappa-bifenthrin, kappa-tefluthrin), dichoromezotiaz, broflanilide, pyraziflumid; A1) the class of carbamates, including aldicarb, alanycarb, benfuracarb, carbaryl, carbofuran, carbosulfan, methiocarb, methomyl, oxamyl, pirimicarb, propoxur and thiodicarb; A2) the class of organophosphates, including acephate, azinphos-ethyl, azinphos-methyl, chlorfenvinphos, chlorpyrifos, chlorpyrifos-methyl, demeton-S-methyl, diazinon, dichlorvos/DDVP, dicrotophos, dimethoate, disulfoton, ethion, fenitrothion, fenthion, isoxathion, malathion, methamidaphos, methidathion, mevinphos, monocrotophos, oxymethoate, oxydemeton-methyl, parathion, parathion-methyl, phenthoate, phorate, phosalone, phosmet, phosphamidon, pirimiphos-methyl, quinalphos, terbufos, tetrachlorvinphos, triazophos and trichlorfon; A3) the class of cyclodiene organochlorine compounds such as endosulfan; A4) the class of fiproles, including ethiprole, fipronil, pyrafluprole and pyriprole; A5) the class of neonicotinoids, including acetamiprid, clothianidin, dinotefuran, imidacloprid, nitenpyram, thiacloprid and thiamethoxam; A6) the class of spinosyns such as spinosad and spinetoram; A7) chloride channel activators from the class of mectins, including abamectin, emamectin benzoate, ivermectin, lepimectin and milbemectin; A8) juvenile hormone mimics such as hydroprene, kinoprene, methoprene, fenoxycarb and pyriproxyfen; A9) selective homopteran feeding blockers such as pymetrozine, flonicamid and pyrifluquinazon; A10) mite growth inhibitors such as clofentezine, hexythiazox and etoxazole; A11) inhibitors of mitochondrial ATP synthase such as diafenthiuron, fenbutatin oxide and propargite; uncouplers of oxidative phosphorylation such as chlorfenapyr; A12) nicotinic acetylcholine receptor channel blockers such as bensultap, cartap hydrochloride, thiocyclam and thiosultap sodium; A13) inhibitors of the chitin biosynthesis type 0 from the benzoylurea class, including bistrifluron, diflubenzuron, flufenoxuron, hexaflumuron, lufenuron, novaluron and teflubenzuron; A14) inhibitors of the chitin biosynthesis type 1 such as buprofezin; A15) moulting disruptors such as cyromazine; A16) ecdyson receptor agonists such as methoxyfenozide, tebufenozide, halofenozide and chromafenozide; A17) octopamin receptor agonists such as amitraz; A18) mitochondrial complex electron transport inhibitors pyridaben, tebufenpyrad, tolfenpyrad, flufenerim, cyenopyrafen, cyflumetofen, hydramethylnon, acequinocyl or fluacrypyrim; A19) voltage-dependent sodium channel blockers such as indoxacarb and metaflumizone; A20) inhibitors of the lipid synthesis such as spirodiclofen, spiromesifen and spirotetramat; A21) ryanodine receptor-modulators from the class of diamides, including flubendiamide, the phthalamide compounds (R)-3-Chlor-N1-{2-methyl-4-[1,2,2,2-tetrafluor-1-(trifluormethyl)ethyl]phenyl}-N2-(1-methyl-2-methylsulfonylethyl)phthalamid and (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, chloranthraniliprole and cy-anthraniliprole; A22) compounds of unknown or uncertain mode of action such as azadirachtin, amidoflumet, bifenazate, fluensulfone, piperonyl butoxide, pyridalyl, sulfoxaflor; or A23) sodium channel modulators from the class of pyrethroids, including acrinathrin, allethrin, bifenthrin, cyfluthrin, lambda-cyhalothrin, cypermethrin, alpha-cypermethrin, beta-cypermethrin, zeta-cypermethrin, deltamethrin, esfenvalerate, etofenprox, fenpropathrin, fenvalerate, flucythrinate, tau-fluvalinate, permethrin, silafluofen and tralomethrin.

Fungicides: B0) benzovindiflupyr, anitiperonosporic, ametoctradin, amisulbrom, copper salts (e.g., copper hydroxide, copper oxychloride, copper sulfate, copper persulfate), boscalid, thiflumazide, flutianil, furalaxyl, thiabendazole, benodanil, mepronil, isofetamid, fenfuram, bixafen, fluxapyroxad, penflufen, sedaxane, coumoxystrobin, enoxastrobin, flufenoxystrobin, pyraoxystrobin, pyrametostrobin, triclopyricarb, fenaminstrobin, metominostrobin, pyribencarb, meptyldinocap, fentin acetate, fentin chloride, fentin hydroxide, oxytetracycline, chlozolinate, chloroneb, tecnazene, etridiazole, iodocarb, prothiocarb, Bacillus subtilis syn., Bacillus amyloliquefaciens (e.g., strains QST 713, FZB24, MB1600, D747), extract from Melaleuca alternifolia, pyrisoxazole, oxpoconazole, etaconazole, fenpyrazamine, naftifine, terbinafine, validamycin, pyrimorph, valifenalate, fthalide, probenazole, isotianil, laminarin, estract from Reynoutria sachalinensis, phosphorous acid and salts, teclofthalam, triazoxide, pyriofenone, organic oils, potassium bicarbonate, chlorothalonil, fluoroimide; B1) azoles, including bitertanol, bromuconazole, cyproconazole, difenoconazole, diniconazole, enilconazole, epoxiconazole, fluquinconazole, fenbuconazole, flusilazole, flutriafol, hexaconazole, imibenconazole, ipconazole, metconazole, myclobutanil, penconazole, propiconazole, prothioconazole, simeconazole, triadimefon, triadimenol, tebuconazole, tetraconazole, triticonazole, prochloraz, pefurazoate, imazalil, triflumizole, cyazofamid, benomyl, carbendazim, thia-bendazole, fuberidazole, ethaboxam, etridiazole and hymexazole, azaconazole, diniconazole-M, oxpoconazol, paclobutrazol, uniconazol, 1-(4-chloro-phenyl)-2-([1,2,4]triazol-1-yl)-cycloheptanol and imazalilsulfphate; B2) strobilurins, including azoxystrobin, dimoxystrobin, enestroburin, fluoxastrobin, kresoxim-methyl, methominostrobin, orysastrobin, picoxystrobin, pyraclostrobin, trifloxystrobin, enestroburin, methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate and methyl 2-(ortho-(2,5-dimethylphenyloxymethylene)-phenyl)-3-methoxyacrylate, 2-(2-(6-(3-chloro-2-methyl-phenoxy)-5-fluoro-pyrimidin-4-yloxy)-phenyl)-2-methoxyimino-N-methyl-acetamide and 3-methoxy-2-(2-(N-(4-methoxy-phenyl)-cyclopropanecarboximidoylsulfanylmethyl)-phenyl)-acrylic acid methyl ester; B3) carboxamides, including carboxin, benalaxyl, benalaxyl-M, fenhexamid, flutolanil, furametpyr, mepronil, metalaxyl, mefenoxam, ofurace, oxadixyl, oxycarboxin, penthiopyrad, isopyrazam, thifluzamide, tiadinil, 3,4-dichloro-N-(2-cyanophenyl)isothiazole-5-carboxamide, dimethomorph, flumorph, flumetover, fluopicolide (picobenzamid), zoxamide, carpropamid, diclocymet, mandipropamid, N-(2-(4-[3-(4-chlorophenyl)prop-2-ynyloxy]-3-methoxyphenyl)ethyl)-2-methanesulfonyl-amino-3-methylbutyramide, N-(2-(4-[3-(4-chloro-phenyl)prop-2-ynyloxy]-3-methoxy-phenyl)ethyl)-2-ethanesulfonylamino-3-methylbutyramide, methyl 3-(4-chlorophenyl)-3-(2-isopropoxycarbonylamino-3-methyl-butyrylamino)propionate, N-(4′-bromobiphenyl-2-yl)-4-difluoromethyl̂-methylthiazole-δ-carboxamide, N-(4′-trifluoromethyl-biphenyl-2-yl)-4-difluoromethyl-2-methylthiazole-5-carboxamide, N-(4′-chloro-3′-fluorobiphenyl-2-yl)-4-difluoromethyl-2-methyl-thiazole-5-carboxamide, N-(3\4′-dichloro-4-fluorobiphenyl-2-yl)-3-difluoro-methyl-1-methyl-pyrazole-4-carboxamide, N-(3′,4′-dichloro-5-fluorobiphenyl-2-yl)-3-difluoromethyl-1-methylpyrazole-4-carboxamide, N-(2-cyano-phenyl)-3,4-dichloroisothiazole-5-carboxamide, 2-amino-4-methyl-thiazole-5-carboxanilide, 2-chloro-N-(1,1,3-trimethyl-indan-4-yl)-nicotinamide, N-(2-(1,3-dimethylbutyl)-phenyl)-1,3-dimethyl-5-fluoro-1H-pyrazole-4-carboxamide, N-(4′-chloro-3′,5-difluoro-biphenyl-2-yl)-3-difluoromethyl-1-methyl-1H-pyrazole-4-carboxamide, N-(4′-chloro-3′,5-difluoro-biphenyl-2-yl)-3-trifluoromethyl-1-methyl-1H-pyrazole-4-carboxamide, N-(3′,4′-dichloro-5-fluoro-biphenyl-2-yl)-3-trifluoromethyl-1-methyl-1H-pyrazole-4-carboxamide, N-(3′,5-difluoro-4′-methyl-biphenyl-2-yl)-3-difluoromethyl-1-methyl-1H-pyrazole-4-carboxamide, N-(3′,5-difluoro-4′-methyl-biphenyl-2-yl)-3-trifluoromethyl-1-methyl-1H-pyrazole-4-carboxamide, N-(cis-2-bicyclopropyl-2-yl-phenyl)-3-difluoromethyl-1-methyl-1H-pyrazole-4-carboxamide, N-(trans-2-bicyclopropyl-2-yl-phenyl)-3-difluoro-methyl-1-methyl-1H-pyrazole-4-carboxamide, fluopyram, N-(3-ethyl-3,5-5-trimethyl-cyclohexyl)-3-formylamino-2-hydroxy-benzamide, oxytetracyclin, silthiofam, N-(6-methoxy-pyridin-3-yl) cyclopropanecarboxamide, 2-iodo-N-phenyl-benzamide, N-(2-bicyclo-propyl-2-yl-phenyl)-3-difluormethyl-1-methylpyrazol-4-ylcarboxamide, N-(3′,4′,5′-trifluorobiphenyl-2-yl)-1,3-dimethylpyrazol-4-ylcarboxamide, N-(3′,4′,5′-trifluorobiphenyl-2-yl)-1,3-dimethyl-5-fluoropyrazol-4-yl-carboxamide, N-(3′,4′,5′-trifluorobiphenyl-2-yl)-5-chloro-1,3-dimethylpyrazol-4-ylcarboxamide, N-(3′,4′,5′-trifluorobiphenyl-2-yl)-3-fluoromethyl-1-methylpyrazol-4-ylcarboxamide, N-(3′,4′,5′-trifluorobiphenyl-2-yl)-3-(chlorofluoromethyl)-1-methylpyrazol-4-ylcarboxamide, N-(3′,4′,5′-trifluorobiphenyl-2-yl)-3-difluoromethyl-1-methylpyrazol-4-ylcarboxamide, N-(3′,4′,5′-trifluorobiphenyl-2-yl)-3-difluoromethyl-5-fluoro-1-methylpyrazol-4-ylcarboxamide, N-(3′,4′,5′-trifluorobiphenyl-2-yl)-5-chloro-3-difluoromethyl-1-methylpyrazol-4-ylcarboxamide, N-(3′,4′,5′-trifluorobiphenyl-2-yl)-3-(chlorodifluoromethyl)-1-methylpyrazol-4-ylcarboxamide, N-(3′,4′,5′-trifluorobiphenyl-2-yl)-1-methyl-3-trifluoromethylpyrazol-4-ylcarboxamide, N-(3′,4′,5′-trifluorobiphenyl-2-yl)-5-fluoro-1-methyl-3-trifluoromethylpyrazol-4-ylcarboxamide, N-(3′,4′,5′-trifluorobiphenyl-2-yl)-5-chloro-1-methyl-3-trifluoromethylpyrazol-4-ylcarboxamide, N-(2′,4′,5′-trifluorobiphenyl-2-yl)-1,3-dimethylpyrazol-4-ylcarboxamide, N-(2′,4′,5′-trifluorobiphenyl-2-yl)-1,3-dimethyl-5-fluoropyrazol-4-ylcarboxamide, N-(2′,4′,5′-trifluorobiphenyl-2-yl)-5-chloro-1,3-dimethylpyrazol-4-ylcarboxamide, N-(2′,4′,5′-trifluorobiphenyl-2-yl)-3-fluoromethyl-1-methylpyrazol-4-ylcarboxamide, N-(2′,4′,5′-trifluorobiphenyl-2-yl)-3-(chlorofluoromethyl)-1-methylpyrazol-4-ylcarboxamide, N-(2′,4′,5′-trifluorobiphenyl-2-yl)-3-difluoromethyl-1-methylpyrazol-4-ylcarboxamide, N-(2′,4′,5′-trifluorobiphenyl-2-yl)-3-difluoromethyl-5-fluoro-1-methylpyrazol-4-ylcarboxamide, N-(2′,4′,5′-trifluorobiphenyl-2-yl)-5-chloro-3-difluoromethyl-1-methylpyrazol-4-ylcarboxamide, N-(2′,4′,5′-trifluorobiphenyl-2-yl)-3-(chlorodifluoromethyl)-1-methylpyrazol-4-ylcarboxamide, N-(2′,4′,5′-trifluorobiphenyl-2-yl)-1-methyl-3-trifluoromethylpyrazol-4-ylcarboxamide, N-(2′,4′,5′-trifluorobiphenyl-2-yl)-5-fluoro-1-methyl-3-trifluoromethylpyrazol-4-ylcarboxamide, N-(2′,4′,5′-trifluorobiphenyl-2-yl)-5-chloro-1-methyl-3-trifluoromethylpyrazol-4-ylcarboxamide, N-(3′,4′-dichloro-3-fluorobiphenyl-2-yl)-1-methyl-3-trifluoromethyl-1H-pyrazole-4-carboxamide, N-(3′,4′-dichloro-3-fluorobiphenyl-2-yl)-1-methyl-3-difluoromethyl-1H-pyrazole-4-carboxamide, N-(3′,4′-difluoro-3-fluorobiphenyl-2-yl)-1-methyl-3-trifluoromethyl-1H-pyrazole-4-carboxamide, N-(3′,4′-difluoro-3-fluorobiphenyl-2-yl)-1-methyl-S-difluoromethyl-1H-pyrazole-4-carboxamide, N-(3′-chloro-4′-fluoro-3-fluorobiphenyl-2-yl)-1-methyl-3-difluoromethyl-1H-pyrazole-4-carboxamide, N-(3′,4′-dichloro-4-fluorobiphenyl-2-yl)-1-methyl-3-trifluoromethyl-1H-pyrazole-4-carboxamide, N-(3′,4′-difluoro-4-fluorobiphenyl-2-yl)-1-methyl-S-trifluoromethyl-1H-pyrazole-4-carboxamide, N-(3′,4′-dichloro-4-fluorobiphenyl-2-yl)-1-methyl-3-difluoromethyl-1H-pyrazole-4-carboxamide, N-(3′,4′-difluoro-4-fluorobiphenyl-2-yl)-1-methyl-3-difluoromethyl-1H-pyrazole-4-carboxamide, N-(3′-chloro-4′-fluoro-4-fluorobiphenyl-2-yl)-1-methyl-S-difluoromethyl-1H-pyrazole-4-carboxamide, N-(3′,4′-dichloro-5-fluorobiphenyl-2-yl)-1-methyl-3-trifluoromethyl-1H-pyrazole-4-carboxamide, N-(3′,4′-difluoro-5-fluorobiphenyl-2-yl)-1-methyl-3-trifluoromethyl-1H-pyrazole-4-carboxamide, N-(3′,4′-dichloro-5-fluorobiphenyl-2-yl)-1-methyl-S-difluoromethyl-1H-pyrazole-carboxamide, N-(3′,4′-difluoro-5-fluorobiphenyl-2-yl)-1-methyl-3-difluoromethyl-1H-pyrazole-4-carboxamide, N-(3′,4′-dichloro-5-fluorobiphenyl-2-yl)-1,3-dimethyl-1H-pyrazole-4-carboxamide, N-(3′-chloro-4′-fluoro-5-fluorobiphenyl-2-yl)-1-methyl-3-difluoromethyl-1H-pyrazole-4-carboxamide, N-(4′-fluoro-4-fluorobiphenyl-2-yl)-1-methyl-3-trifluoromethyl-1H-pyrazole-4-carboxamide, N-(4′-fluoro-5-fluorobiphenyl-2-yl)-1-methyl-3-trifluoromethyl-1H-pyrazole-4-carboxamide, N-(4′-chloro-5-fluorobiphenyl-2-yl)-1-methyl-3-trifluoromethyl-1H-pyrazole-4-carboxamide, N-(4′-methyl-5-fluorobiphenyl-2-yl)-1-methyl-3-trifluoromethyl-1H-pyrazole-4-carboxamide, N-(4′-fluoro-5-fluorobiphenyl-2-yl)-1,3-dimethyl-1H-pyrazole-4-carboxamide, N-(4′-chloro-5-fluorobiphenyl-2-yl)-1,3-dimethyl-1H-pyrazole-4-carboxamide, N-(4′-methyl-5-fluorobiphenyl-2-yl)-1,3-dimethyl-1H-pyrazole-4-carboxamide, N-(4′-fluoro-6-fluorobiphenyl-2-yl)-1-methyl-3-trifluoromethyl-1H-pyrazole-4-carboxamide, N-(4′-chloro-6-fluorobiphenyl-2-yl)-1-methyl-3-trifluoromethyl-1H-pyrazole-4-carboxamide, N-[2-(1,1,2,3,3,3-hexafluoropropoxy)-phenyl]-3-difluoromethyl-1-methyl-1H-pyrazole-4-carboxamide, N-[4′-(trifluoromethylthio)-biphenyl-2-yl]-3-difluoromethyl-1-methyl-1H-pyrazole-4-carboxamide and N-[4′-(trifluoromethylthio)-biphenyl-2-yl]-1-methyl-3-trifluoromethyl-1-methyl-1H-pyrazole-4-carboxamide; B4) heterocyclic compounds, including fluazinam, pyrifenox, bupirimate, cyprodinil, fenarimol, ferimzone, mepanipyrim, nuarimol, pyrimethanil, triforine, fenpiclonil, fludioxonil, aldimorph, dodemorph, fenpropimorph, tridemorph, fenpropidin, iprodione, procymidone, vinclozolin, famoxadone, fenamidone, octhilinone, proben-azole, 5-chloro-7-(4-methyl-piperidin-1-yl)-6-(2,4,6-trifluorophenyl)-[1,2,4]triazolo[1,5-a]pyrimidine, anilazine, diclomezine, pyroquilon, proquinazid, tricyclazole, 2-butoxy-6-iodo-3-propylchromen-4-one, acibenzolar-S-methyl, captafol, captan, dazomet, folpet, fenoxanil, quinoxyfen, N,N-dimethyl-3-(3-bromo-6-fluoro-2-methylindole-1-sulfonyl)-[1,2,4]triazole-1-sulfonamide, 5-ethyl-6-octyl-[1,2,4]triazolo[1,5-a]pyrimidin-2,7-diamine, 2,3,5,6-tetrachloro-4-methanesulfonyl-pyridine, 3,4,5-trichloro-pyridine-2,6-di-carbonitrile, N-(1-(5-bromo-3-chloro-pyridin-2-yl)-ethyl)-2,4-dichloro-nicotinamide, N-((5-bromo-3-chloro pyridin-2-yl)-methyl)-2,4-dichloro-nicotinamide, diflumetorim, nitrapyrin, dodemorphacetate, fluoroimid, blasticidin-S, chinomethionat, debacarb, difenzoquat, difenzoquat-methylsulphat, oxolinic acid and piperalin; B5) carbamates, including mancozeb, maneb, metam, methasulphocarb, metiram, ferbam, propineb, thiram, zineb, ziram, diethofencarb, iprovalicarb, benthiavalicarb, propamocarb, propamocarb hydrochlorid, 4-fluorophenyl N-(1-(1-(4-cyanophenyl)-ethanesulfonyl)but-2-yl)carbamate, methyl 3-(4-chloro-phenyl)-3-(2-isopropoxycarbonylamino-3-methyl-butyrylamino)propanoate; or B6) other fungicides, including guanidine, dodine, dodine free base, iminoctadine, guazatine, antibiotics: kasugamycin, oxytetracyclin and its salts, streptomycin, polyoxin, validamycin A, nitrophenyl derivatives: binapacryl, dinocap, dinobuton, sulfur-containing heterocyclyl compounds: dithianon, isoprothiolane, organometallic compounds: fentin salts, organophosphorus compounds: edifenphos, iprobenfos, fosetyl, fosetyl-aluminum, phosphorous acid and its salts, pyrazophos, tolclofos-methyl, organochlorine compounds: dichlofluanid, flusulfamide, hexachloro-benzene, phthalide, pencycuron, quintozene, thiophanate, thiophanate-methyl, tolylfluanid, others: cyflufenamid, cymoxanil, dimethirimol, ethirimol, furalaxyl, metrafenone and spiroxamine, guazatine-acetate, iminoc-tadine-triacetate, iminoctadine-tris(albesilate), kasugamycin hydrochloride hydrate, dichlorophen, pentachlorophenol and its salts, N-(4-chloro-2-nitro-phenyl)-N-ethyl-4-methyl-benzenesulfonamide, dicloran, nitrothal-isopropyl, tecnazen, biphenyl, bronopol, diphenylamine, mildiomycin, oxincopper, prohexadione calcium, N-(cyclopropylmethoxyimino-(6-difluoromethoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluormethyl-4-(3-trimethylsilanyl-propoxy)-phenyl)-N-ethyl-N-methylformamidine and N′-(5-difluormethyl-2-methyl-4-(3-trimethylsilanyl-propoxy)-phenyl)-N-ethyl-N-methyl formamidine.

Herbicides: C1) acetyl-CoA carboxylase inhibitors (ACC), for example cyclohexenone oxime ethers, such as alloxydim, clethodim, cloproxydim, cycloxydim, sethoxydim, tralkoxydim, butroxydim, clefoxydim or tepraloxydim; phenoxyphenoxypropionic esters, such as clodinafop-propargyl, cyhalofop-butyl, diclofop-methyl, fenoxaprop-ethyl, fenoxaprop-P-ethyl, fenthiapropethyl, fluazifop-butyl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl or quizalofop-tefuryl; or arylaminopropionic acids, such as flamprop-methyl or flamprop-isopropyl; C2 acetolactate synthase inhibitors (ALS), for example imidazolinones, such as imazapyr, imazaquin, imazamethabenz-methyl (imazame), imazamox, imazapic or imazethapyr; pyrimidyl ethers, such as pyrithiobac-acid, pyrithiobac-sodium, bispyribac-sodium. KIH-6127 or pyribenzoxym; sulfonamides, such as florasulam, flumetsulam or metosulam; or sulfonylureas, such as amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, halosulfuron-methyl, imazosulfuron, metsulfuron-methyl, nicosulfuron, primisulfuron-methyl, prosulfuron, pyrazosulfuron-ethyl, rimsulfuron, sulfometuron-methyl, thifensulfuron-methyl, triasulfuron, tribenuron-methyl, triflusulfuron-methyl, tritosulfuron, sulfosulfuron, foramsulfuron or iodosulfuron; C3) amides, for example allidochlor (CDAA), benzoylprop-ethyl, bromobutide, chiorthiamid. diphenamid, etobenzanidibenzchlomet), fluthiamide, fosamin or monalide; C4) auxin herbicides, for example pyridinecarboxylic acids, such as clopyralid or picloram; or 2,4-D or benazolin; C5) auxin transport inhibitors, for example naptalame or diflufenzopyr; C6) carotenoid biosynthesis inhibitors, for example benzofenap, clomazone (dimethazone), diflufenican, fluorochloridone, fluridone, pyrazolynate, pyrazoxyfen, isoxaflutole, isoxachlortole, mesotrione, sulcotrione (chlormesulone), ketospiradox, flurtamone, norflurazon or amitrol; C7) enolpyruvylshikimate-3-phosphate synthase inhibitors (EPSPS), for example glyphosate or sulfosate; C8) glutamine synthetase inhibitors, for example bilanafos (bialaphos) or glufosinate-ammonium; C9) lipid biosynthesis inhibitors, for example anilides, such as anilofos or mefenacet; chloroacetanilides, such as dimethenamid, S-dimethenamid, acetochlor, alachlor, butachlor, butenachlor, diethatyl-ethyl, dimethachlor, metazachlor, metolachlor, S-metolachlor, pretilachlor, propachlor, prynachlor, terbuchlor, thenylchlor or xylachlor; thioureas, such as butylate, cycloate, di-allate, dimepiperate, EPTC. esprocarb, molinate, pebulate, prosulfocarb, thiobencarb (benthiocarb), tri-allate or vemolate; or benfuresate or perfluidone; C10) mitosis inhibitors, for example carbamates, such as asulam, carbetamid, chlorpropham, orbencarb, pronamid (propyzamid), propham or tiocarbazil; dinitroanilines, such as benefin, butralin, dinitramin, ethalfluralin, fluchloralin, oryzalin, pendimethalin, prodiamine or trifluralin; pyridines, such as dithiopyr or thiazopyr; or butamifos, chlorthal-dimethyl (DCPA) or maleic hydrazide; C11) protoporphyrinogen IX oxidase inhibitors, for example diphenyl ethers, such as acifluorfen, acifluorfen-sodium, aclonifen, bifenox, chlomitrofen (CNP), ethoxyfen, fluorodifen, fluoroglycofen-ethyl, fomesafen, furyloxyfen, lactofen, nitrofen, nitrofluorfen or oxyfluorfen; oxadiazoles, such as oxadiargyl or oxadiazon; cyclic imides, such as azafenidin, butafenacil, carfentrazone-ethyl, cinidon-ethyl, flumiclorac-pentyl, flumioxazin, flumipropyn, flupropacil, fluthiacet-methyl, sulfentrazone or thidiazimin; or pyrazoles, such as ET-751.JV 485 or nipyraclofen; C12) photosynthesis inhibitors, for example propanil, pyridate or pyridafol; benzothiadiazinones, such as bentazone; dinitrophenols, for example bromofenoxim, dinoseb, dinoseb-acetate, dinoterb or DNOC; dipyridylenes, such as cyperquat-chloride, difenzoquat-methylsulfate, diquat or paraquat-dichloride; ureas, such as chlorbromuron, chlorotoluron, difenoxuron, dimefuron, diuron, ethidimuron, fenuron, fluometuron, isoproturon, isouron, linuron, methabenzthiazuron, methazole, metobenzuron, metoxuron, monolinuron, neburon, siduron or tebuthiuron; phenols, such as bromoxynil or ioxynil; chloridazon; triazines, such as ametryn, atrazine, cyanazine, desmein, dimethamethryn, hexazinone, prometon, prometryn, propazine, simazine, simetryn, terbumeton, terbutryn, terbutylazine or trietazine; triazinones, such as metamitron or metribuzin; uracils, such as bromacil, lenacil or terbacil; or biscarbamates, such as desmedipham or phenmedipham; C13) synergists, for example oxiranes, such as tridiphane; C14) CIS cell wall synthesis inhibitors, for example isoxaben or dichlobenil; C16) various other herbicides, for example dichloropropionic acids, such as dalapon; dihydrobenzofurans, such as ethofumesate; phenylacetic acids, such as chlorfenac (fenac); or aziprotryn, barban, bensulide, benzthiazuron, benzofluor, buminafos, buthidazole, buturon, cafenstrole, chlorbufam, chlorfenprop-methyl, chloroxuron, cinmethylin, cumyluron, cycluron, cyprazine, cyprazole, dibenzyluron, dipropetryn, dymron, eglinazin-ethyl, endothall, ethiozin, flucabazone, fluorbentranil, flupoxam, isocarbamid, isopropalin, karbutilate, mefluidide, monuron, napropamide, napropanilide, nitralin, oxaciclomefone, phenisopham, piperophos, procyazine, profluralin, pyributicarb, secbumeton, sulfallate (CDEC), terbucarb, triaziflam, triazofenamid or trimeturon; or their environmentally compatible salts.

Nematicides or bionematicides: Benomyl, cloethocarb, aldoxycarb, tirpate, diamidafos, fenamiphos, cadusafos, dichlofenthion, ethoprophos, fensulfothion, fosthiazate, heterophos, isamidofof, isazofos, phosphocarb, thionazin, imicyafos, mecarphon, acetoprole, benclothiaz, chloropicrin, dazomet, fluensulfone, 1,3-dichloropropene (telone), dimethyl disulfide, metam sodium, metam potassium, metam salt (all MITC generators), methyl bromide, biological soil amendments (e.g., mustard seeds, mustard seed extracts), steam fumigation of soil, allyl isothiocyanate (AITC), dimethyl sulfate, furfual (aldehyde).

Suitable plant growth regulators of the present invention include the following: Plant Growth Regulators: D1) Antiauxins, such as clofibric acid, 2,3,5-tri-iodobenzoic acid; D2) Auxins such as 4-CPA, 2,4-D, 2,4-DB, 2,4-DEP, dichlorprop, fenoprop, IAA, IBA, naphthaleneacetamide, α-naphthaleneacetic acids, 1-naphthol, naphthoxyacetic acids, potassium naphthenate, sodium naphthenate, 2,4,5-T; D3) cytokinins, such as 2iP, benzyladenine, 4-hydroxyphenethyl alcohol, kinetin, zeatin; D4) defoliants, such as calcium cyanamide, dimethipin, endothal, ethephon, merphos, metoxuron, pentachlorophenol, thidiazuron, tribufos; D5) ethylene inhibitors, such as aviglycine, 1-methylcyclopropene; D6) ethylene releasers, such as ACC, etacelasil, ethephon, glyoxime; D7) gametocides, such as fenridazon, maleic hydrazide; D8) gibberellins, such as gibberellins, gibberellic acid; D9) growth inhibitors, such as abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, piproctanyl, prohydrojasmon, propham, tiaojiean, 2,3,5-tri-iodobenzoic acid; D10) morphactins, such as chlorfluren, chlorflurenol, dichlorflurenol, flurenol; D11) growth retardants, such as chlormequat, daminozide, flurprimidol, mefluidide, paclobutrazol, tetcyclacis, uniconazole; D12) growth stimulators, such as brassinolide, brassinolide-ethyl, DCPTA, forchlorfenuron, hymexazol, prosuler, triacontanol; D13) unclassified plant growth regulators, such as bachmedesh, benzofluor, buminafos, carvone, choline chloride, ciobutide, clofencet, cyanamide, cyclanilide, cycloheximide, cyprosulfamide, epocholeone, ethychlozate, ethylene, fuphenthiourea, furalane, heptopargil, holosulf, inabenfide, karetazan, lead arsenate, methasulfocarb, prohexadione, pydanon, sintofen, triapenthenol, trinexapac.

Chemical formulations of the present invention can be in any appropriate conventional form, for example an emulsion concentrate (EC), a suspension concentrate (SC), a suspo-emulsion (SE), a capsule suspension (CS), a water dispersible granule (WG), an emulsifiable granule (EG), a water in oil emulsion (EO), an oil in water emulsion (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a dispersible concentrate (DC), a wettable powder (WP) or any technically feasible formulation in combination with agriculturally acceptable adjuvants.

In one embodiment of the present invention a composition is provided for benefiting plant growth, the composition comprising: a biologically pure culture of spores of Bacillus pumilus RTI279 deposited as PTA-121164 and a bifenthrin insecticide in a formulation suitable as a liquid fertilizer, wherein each of the Bacillus pumilus RTI279 and the bifenthrin insecticide is present in an amount suitable to benefit plant growth.

In one embodiment of the present invention a composition is provided for benefiting plant growth, the composition comprising: a biologically pure culture of spores of Bacillus licheniformis CH200 deposited as accession No. DSM 17236 and a bifenthrin insecticide in a formulation suitable as a liquid fertilizer, wherein each of the Bacillus licheniformis CH200 and the bifenthrin insecticide is present in an amount suitable to benefit plant growth.

In one embodiment of the present invention a product is provided, the product comprising: a first composition having a biologically pure culture of spores of Bacillus licheniformis CH200 deposited as accession No. DSM 17236; a second composition having a bifenthrin insecticide formulated as a liquid fertilizer, wherein the first and second compositions are separately packaged, and wherein each component is in an amount suitable to benefit plant growth; and instructions for delivering in a liquid fertilizer and in an amount suitable to benefit plant growth, a combination of the first and second compositions to: seed of the plant, roots of the plant, a cutting of the plant, a graft of the plant, callus tissue of the plant; soil or growth medium surrounding the plant; soil or growth medium before sowing seed of the plant in the soil or growth medium; or soil or growth medium before planting the plant, the plant cutting, the plant graft, or the plant callus tissue in the soil or growth medium.

In one embodiment, a product is provided comprising: a first container containing a first composition comprising a biologically pure culture of a Bacillus licheniformis CH200 (DSMZ Accession No. DSM 17236); and a second container containing a second composition comprising bifenthrin, wherein each of the first and second compositions is in a formulation compatible with a liquid fertilizer. The Bacillus licheniformis CH200 may be present at a concentration of from 1.0×10⁹ CFU/g to 1.0×10¹² CFU/g. The second composition may further comprise a hydrated aluminum-magnesium silicate, and at least one dispersant selected from the group consisting of a sucrose ester, a lignosulfonate, an alkylpolyglycoside, a naphthalenesulfonic acid formaldehyde condensate and a phosphate ester. The first and second containers can be contained within one package or separately packaged and combined in a single product. Each composition is in an amount suitable to benefit plant growth. Instructions can be provided for delivering in a liquid fertilizer and in an amount suitable to benefit plant growth, a combination of the first and second compositions to seed of the plant, roots of the plant, a cutting of the plant, a graft of the plant, callus tissue of the plant; soil or growth medium surrounding the plant; soil or growth medium before sowing seed of the plant in the soil or growth medium; or soil or growth medium before planting the plant, the plant cutting, the plant graft, or the plant callus tissue in the soil or growth medium.

In one embodiment of the present invention a product is provided, the product comprising: a first composition having a biologically pure culture of spores of Bacillus pumilus RTI279 deposited as PTA-121164; a second composition having a bifenthrin insecticide formulated as a liquid fertilizer, wherein the first and second compositions are separately packaged, and wherein each component is in an amount suitable to benefit plant growth; and instructions for delivering in a liquid fertilizer and in an amount suitable to benefit plant growth, a combination of the first and second compositions to: seed of the plant, roots of the plant, a cutting of the plant, a graft of the plant, callus tissue of the plant; soil or growth medium surrounding the plant; soil or growth medium before sowing seed of the plant in the soil or growth medium; or soil or growth medium before planting the plant, the plant cutting, the plant graft, or the plant callus tissue in the soil or growth medium.

In one embodiment, a product is provided comprising: a first container containing a first composition comprising a biologically pure culture of a Bacillus pumilus RTI279 (ATCC Accession No. PTA-121164); and a second container containing a second composition comprising bifenthrin, wherein each of the first and second compositions is in a formulation compatible with a liquid fertilizer. The Bacillus pumilus RTI279 may be present at a concentration of from 1.0×10⁹ CFU/g to 1.0×10¹² CFU/g. The second composition may further comprise a hydrated aluminum-magnesium silicate, and at least one dispersant selected from the group consisting of a sucrose ester, a lignosulfonate, an alkylpolyglycoside, a naphthalenesulfonic acid formaldehyde condensate and a phosphate ester. The first and second containers can be contained within one package or separately packaged and combined in a single product. Each composition is in an amount suitable to benefit plant growth. Instructions can be provided for delivering in a liquid fertilizer and in an amount suitable to benefit plant growth, a combination of the first and second compositions to seed of the plant, roots of the plant, a cutting of the plant, a graft of the plant, callus tissue of the plant; soil or growth medium surrounding the plant; soil or growth medium before sowing seed of the plant in the soil or growth medium; or soil or growth medium before planting the plant, the plant cutting, the plant graft, or the plant callus tissue in the soil or growth medium.

In one embodiment of the present invention a method is provided for benefiting plant growth, the method comprising: delivering to a plant in a liquid fertilizer a composition having a growth promoting microorganism and a soil insecticide, wherein the composition comprises: spores of a biologically pure culture of a Bacillus pumilus RTI279 deposited as PTA-121164 and a bifenthrin insecticide in a formulation suitable as a liquid fertilizer, wherein each of the Bacillus pumilus RTI279 and the bifenthrin insecticide is present in an amount sufficient to benefit plant growth, wherein the composition is delivered in the liquid fertilizer in an amount suitable for benefiting plant growth to: seed of the plant, roots of the plant, a cutting of the plant, a graft of the plant, callus tissue of the plant, soil or growth medium surrounding the plant, soil or growth medium before sowing seed of the plant in the soil or growth medium, or soil or growth medium before planting the plant, the plant cutting, the plant graft, or the plant callus tissue in the soil or growth medium.

In one embodiment of the present invention a method is provided for benefiting plant growth, the method comprising: delivering to a plant in a liquid fertilizer a composition having a growth promoting microorganism and a soil insecticide, wherein the composition comprises: spores of a biologically pure culture of a Bacillus licheniformis CH200 deposited as accession No. DSM 17236 and a bifenthrin insecticide in a formulation suitable as a liquid fertilizer, wherein each of the Bacillus licheniformis CH200 and the bifenthrin insecticide is present in an amount sufficient to benefit plant growth, wherein the composition is delivered in the liquid fertilizer in an amount suitable for benefiting plant growth to: seed of the plant, roots of the plant, a cutting of the plant, a graft of the plant, callus tissue of the plant, soil or growth medium surrounding the plant, soil or growth medium before sowing seed of the plant in the soil or growth medium, or soil or growth medium before planting the plant, the plant cutting, the plant graft, or the plant callus tissue in the soil or growth medium.

In one embodiment of the present invention a method is provided for benefiting plant growth, the method comprising: delivering in a liquid fertilizer in an amount suitable for benefiting plant growth a combination of: a first composition having a biologically pure culture of Bacillus licheniformis CH200 deposited as accession No. DSM 17236; and a second composition having a bifenthrin insecticide, wherein each composition is in a formulation suitable as a liquid fertilizer and wherein each component is in an amount suitable to benefit plant growth, and wherein the combination is delivered to: seed of the plant, roots of the plant, a cutting of the plant, a graft of the plant, callus tissue of the plant; soil or growth medium surrounding the plant; soil or growth medium before sowing seed of the plant in the soil or growth medium; or soil or growth medium before planting the plant, the plant cutting, the plant graft, or the plant callus tissue in the soil or growth medium.

In one embodiment of the present invention a method is provided for benefiting plant growth, the method comprising: delivering in a liquid fertilizer in an amount suitable for benefiting plant growth a combination of: a first composition having a biologically pure culture of Bacillus pumilus RT1279 deposited as PTA-121164; and a second composition having a bifenthrin insecticide, wherein each composition is in a formulation suitable as a liquid fertilizer and wherein each component is in an amount suitable to benefit plant growth, and wherein the combination is delivered to: seed of the plant, roots of the plant, a cutting of the plant, a graft of the plant, callus tissue of the plant; soil or growth medium surrounding the plant; soil or growth medium before sowing seed of the plant in the soil or growth medium; or soil or growth medium before planting the plant, the plant cutting, the plant graft, or the plant callus tissue in the soil or growth medium.

### EXAMPLES

The following Examples have been included to provide guidance to one of ordinary skill in the art for practicing representative embodiments of the presently disclosed subject matter. In light of the present invention and the general level of skill in the art, those of skill can appreciate that the following Examples are intended to be exemplary only and that numerous changes, modifications, and alterations can be employed without departing from the scope of the presently disclosed subject matter.

### Example 1

### Identification of a Bacterial Isolate as a Bacillus Pumilus Through Sequence Analysis

A plant associated bacterial strain, designated herein as RTI279, was isolated from the rhizosphere soil of merlot vines growing at a vineyard in NY. The 16S rRNA and the rpoB genes of the RTI279 strain were sequenced and subsequently compared to other known bacterial strains in the NCBI and RDP databases using BLAST. It was determined that the 16S RNA sequence of RTI279 (SEQ ID NO: 1) is identical to the 16S rRNA gene sequence of eight other strains of B. pumilus, including B. pumilus SAFR-032. This confirms that RTI279 is a B. pumilus. It was determined that the rpoB gene sequence of RTI279 (SEQ ID NO: 2) has the highest level of sequence similarity to the gene in the B. pumilus SAFR-032 strain (i.e. 99% sequence identity); however, there is a 47 nucleotide difference on the DNA level, indicating that RTI279 is a new strain of B. pumilus.

### Example 2

### Genes Related to Osmotic Stress Response in RTI279 Bacillus Pumilus

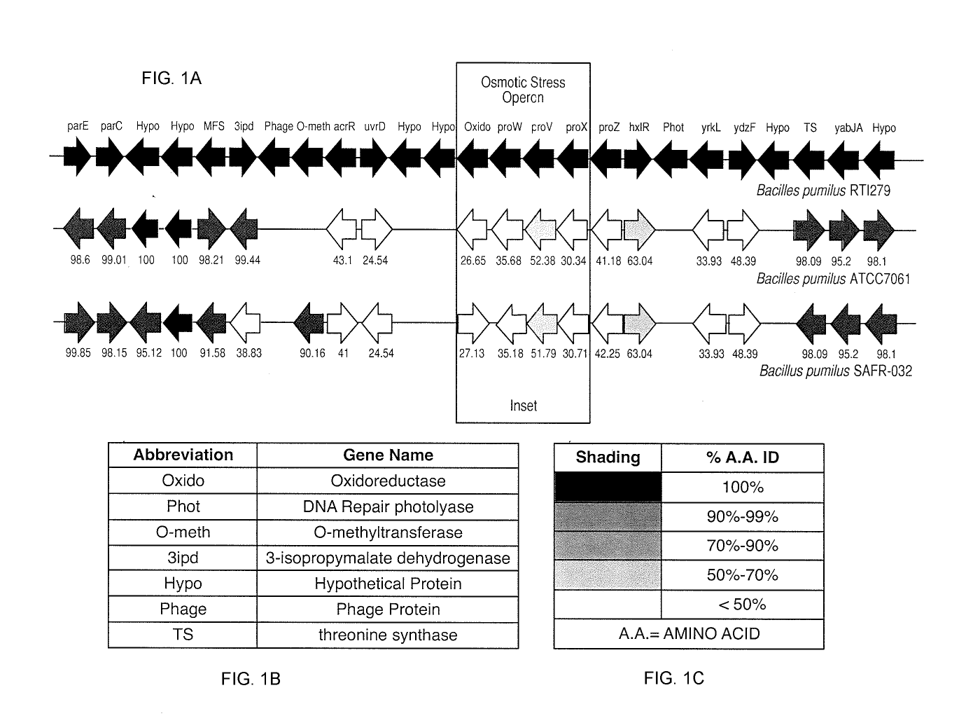

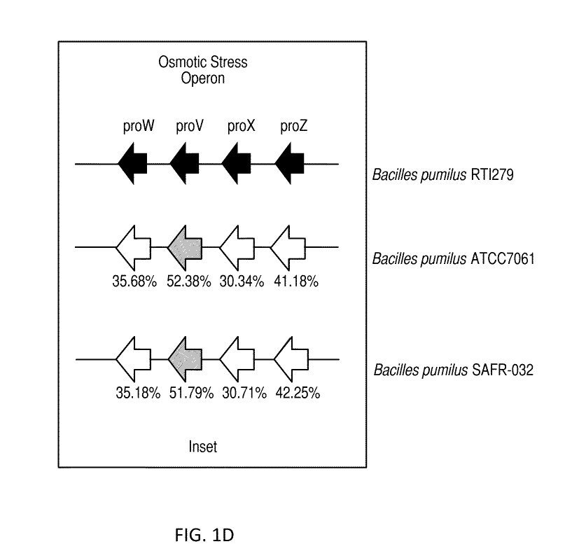

Further sequence analysis of the genome of Bacillus pumilus strain RTI279 revealed that this strain has genes related to osmotic stress response, for which there are no homologues in the other closely related B. pumilus strains. This is illustrated in FIG. 1, which shows a schematic diagram of the genomic organization surrounding and including the osmotic stress response operon found in Bacillus pumilus RTI279. In FIG. 1A, the top set of arrows represents protein coding regions for the RTI279 strain with relative direction of transcription indicated. For comparison, the corresponding regions for two Bacillus pumilus reference strains, ATCC7061 and SAFR-032, are shown below the RTI279 strain. Genes are identified by their 4 letter designation unless no designation could be found. If no designation could be found, the gene abbreviations are indicated in the legend shown in FIG. 1B. The degree of amino acid identity of the proteins encoded by the genes of RTI279 as compared to the two reference strains is indicated both by the degree of shading of the representative arrows (see FIG. 1C for the legend) as well as a percentage identity indicated below the arrow. The inset shows the osmotic stress response operon identified in RTI279 and the percent amino acid identity to the corresponding encoded regions from the two reference strains. It can be observed from FIG. 1 that there is a high degree of sequence identity in the genes from the 3 different strains in the regions surrounding the osmotic stress operon, but only a low degree of sequence identity within the osmotic stress response operon (i.e., less than 55% within the osmotic stress operon but greater than 90% in the surrounding regions).

FIG. 1D shows an enlarged version of the osmotic stress operon inset from FIG. 1A. The 4 genes in the osmotic stress operon in the B. pumilus RTI279 strain were initially identified using RAST and their identities then refined using BLASTp as: proline/glycine betaine ABC transport permease (proW in FIG. 1D) based on 97% amino acid identity to Paenibacillus sp. FSL R5-192; proline/glycine betaine ATPase (proV in FIG. 1D) based on 97% amino acid identity to Paenibacillus sp. FSL R7-277, proline/glycine betaine ABC transport periplasmic component (proX in FIG. 1D) based on 97% amino acid identity to Paenibacillus sp. FSL R7-277; and proline/glycine betaine ABC permease (proZ in FIG. 1D) based on 93% amino acid identity to Paenibacillus sp. FSL R5-192. The organizational structure of the osmotic stress operon in RTI279 differs from the canonical operon organization, however all the genes required are present in the operon of RTI279. While the protein product of each of the 4 pro genes identified in the RTI279 strain has over 90% sequence identity with corresponding sequences in the genome of Paenibacillus strains deposited in the NCBI sequence database, there is only 30-52% sequence identity between these sequences and the corresponding regions in the B. pumilus strains most similar to the RTI279 strain. Thus, this osmotic stress operon is a novel feature for a B. pumilus strain.

### Example 3

### Growth Effects of Bacillus Pumilus Isolate RTI279 on Wheat

The effect of application of the bacterial isolate on early plant growth and vigor in wheat was determined. The experiment was performed by inoculating surface sterilized germinated wheat seeds for 2 days in a suspension of 10⁺⁷ bacterial cfu/ml at room temperature under shaking (a control was performed without bacterial cells). Subsequently, the control and inoculated seeds were planted in 4″ pots in duplicate in sand mixture. Each pot was seeded with five seeds of wheat variety HARD RED at 1-1.5 cm depth. Pots were incubated in growth chamber at 24° C./18° C. with light and dark cycle of 14/10 hrs and watered as needed for 13 days. Dry weight was determined as a total weight per 10 seeds resulting in a total weight equal to 363 mg for the plants inoculated with the RTI279 strain versus a total weight equal to 333.8 mg for the non-inoculated control which is an 8.7% increase in dry weight over the non-inoculated control.

### Example 4

### Growth Effects of Bacillus Pumilus Isolate RTI279 on Corn

The effect of application of the bacterial isolate RTI279 on growth and vigor in corn was determined and the data are shown in Table I below. The experiment was performed by inoculating surface sterilized germinated corn seeds for 2 days in a suspension of 10⁺⁸ cfu/ml of the bacterium at room temperature under shaking. Subsequently, the inoculated seeds were planted in 1 gallon pots filled with PROMIX BX. For each treatment 9 pots were seeded with a single corn seed planted at 5 cm depth. Pots were incubated in the greenhouse at 22° C. with light and dark cycle of 14/10 hrs and watered twice a week as needed. After 42 days, plants were harvested and their height, fresh, and dry weight were measured and compared to data obtained for non-inoculated control plants. The results are shown below in Table I.

TABLE I
Growth promoting properties of Bacillus
pumilus isolate RTI279 in corn
Length of experiment 7 weeks
Location Greenhouse

| | Normalized | Normalized | |
|---|---|---|---|
| | Fresh Shoot | Dry Shoot | Height at |
| Treatment | Biomass | Biomass | 42 days |
| Control | 212.3 g | 16.99 g | 164.94 cm |
| RTI279 | 229.3 g | 19.77 g | 175.97 cm |
| % Increase | 8% | 16.3% | 6.7% |
| over control | | | |

### Example 5

### Anti-Microbial Properties of Bacillus Pumilus Isolate RTI279

The antagonistic ability of the isolate against major plant pathogens was measured in plate assays. A plate assay for evaluation of antagonism against plant fungal pathogens was performed by growing the bacterial isolate and pathogenic fungi side by side on 869 agar plates at a distance of 4 cm. Plates were incubated at room temperature and checked regularly for up to two weeks for growth behaviors such as growth inhibition, niche occupation, or no effect. The data for the antagonism activity is shown in Table II below.

TABLE II
Antagonistic properties of Bacillus pumilus isolate
RTI279 against major plant pathogens

| Anti-Microbial Assays | RTI279 |
|---|---|
| Aspergillus flavus | + |
| Erwinia carotovora | + |
| Fusarium graminearum | + |
| Fusarium oxysporum | +− |
| Magnaporthe grisea | + |
| Rhizoctonia solani | ++ |
| Xanthomonas axonopodis | − |

+++ very strong activity,
++ strong activity,
+ activity,
+− weak activity,
− no activity observed

### Example 6

### Phenotypic Traits of Bacillus Pumilus RTI279

In addition to the positive effects on plant growth and antagonistic properties, various phenotypic traits were also measured for the RTI279 strain and the data are shown below in Table III. The assays were performed according to the procedures described in the text below Table III.

TABLE III
Phenotypic Assays: phytohormone production, acetoin
and indole acetic acid (IAA), and nutrient Cycling
of Bacillus pumilus isolate RTI279.

| Characteristic Assays | RTI279 |
|---|---|
| Acid Production (Methyl Red) | ++ |
| Acetoin Production (MR-VP) | +++ |
| Chitinase activity | − |
| Indole-3-Acetic Acid production | − |
| Protease activity | +++ |
| Phosphate Solubilization | + |
| Lowest growth temperature | 10° C. |
| Phenotype | Cream |

+++ very strong,
++ strong,
+ some,
+− weak,
− none observed

Acid and Acetoin Test.

20 μl of a starter culture in rich 869 media was transferred to 1 ml Methy Red—VOGES PROSKAUER media (Sigma Aldrich 39484). Cultures were incubated for 2 days at 30° C. 200 rpm. 0.5 ml culture was transferred and 50 μl 0.2 g/l methyl red was added. Red color indicated acid production. The remaining 0.5 ml culture was mixed with 0.3 ml 5% alpha-napthol (Sigma Aldrich N1000) followed by 0.1 ml 40% KOH. Samples were interpreted after 30 minutes of incubation. Development of a red color indicated acetoin production. For both acid and acetoin tests non-inoculated media was used as a negative control (Isenberg, H. D. (ed.). 2004. Clinical microbiology procedures handbook, vol. 1, 2 and 3, 2nd ed. American Society for Microbiology, Washington, D.C.).

Indole-3-Acetic Acid.

20 μl of a starter culture in rich 869 media was transferred to 1 ml 1/10 869 Media supplemented with 0.5 g/l tryptophan (Sigma Aldrich T0254). Cultures were incubated for 4-5 days in the dark at 30° C., 200 RPM. Samples were centrifuged and 0.1 ml supernatant was mixed with 0.2 ml Salkowski's Reagent (35% perchloric acid, 10 mM FeCl3). After incubating for 30 minutes in the dark, samples resulting in pink color were recorded positive for IAA synthesis. Dilutions of IAA (Sigma Aldrich 15148) were used as a positive comparison; non inoculated media was used as negative control (Taghavi et al. 2009, Applied and Environmental Microbiology 75: 748-757.).

Phosphate Solubilizing Test.

Bacteria were plated on Pikovskaya (PVK) agar medium consisting of 10 g glucose, 5 g calcium triphosphate, 0.2 g potassium chloride, 0.5 g ammonium sulfate, 0.2 g sodium chloride, 0.1 g magnesium sulfate heptahydrate, 0.5 g yeast extract, 2 mg manganese sulfate, 2 mg iron sulfate and 15 g agar per liter, pH7, autoclaved. Zones of clearing were indicative of phosphate solubilizing bacteria (Sharma et al. 2011, Journal of Microbiology and Biotechnology Research 1: 90-95).

Chitinase Activity.

10% wet weight colloidal chitin was added to modified PVK agar medium (10 g glucose, 0.2 g potassium chloride, 0.5 g ammonium sulfate, 0.2 g sodium chloride, 0.1 g magnesium sulfate heptahydrate, 0.5 g yeast extract, 2 mg manganese sulfate, 2 mg iron sulfate and 15 g agar per liter, pH7, autoclaved). Bacteria were plated on these chitin plates and the plates were incubated at room temperature; zones of clearing indicated chitinase activity (N. K. S. Murthy and Bleakley. 2012, The Internet Journal of Microbiology. 10(2)).

Protease Activity.

Bacteria were plated on 869 agar medium supplemented with 10% milk and the plates were incubated at room temperature. Clearing zones indicated the ability to break down proteins suggesting protease activity (Sokol et al. 1979, Journal of Clinical Microbiology. 9: 538-540).

Growth Profile.

An overnight culture of B. pumilus strain RTI279 was grown overnight at 30° C. A 10⁻⁶ dilution of the RTI279 culture was made, plated on 869 agar medium, and incubated at temperatures ranging from 5° C. to 37° C. Emergence and growth of individual colonies on different temperatures was monitored for 2 weeks.

### Example 7

### Effect of Bacillus Pumilus RTI279 and Bacillus Licheniformis CH200 on Seed Germination, Root Development and Architecture

Experiments were performed to determine the effects of application of the B. pumilus RTI279 strain to seed on seed germination and root development and architecture. Experiments were performed as described below using both vegetative cells and spores of RTI279.

Vegetative Cells:

Assays with vegetative cells of RTI279 were performed using seed from corn, cotton, cucumber, soy, tomato, and wheat. RTI279 was plated onto 869 media from a frozen stock and grown overnight at 30° C. An isolated colony was taken from the plate and inoculated into a 50 mL conical tube containing 20 mL of 869 broth. The culture was incubated overnight with shaking at 30° C. and 200 RPM. The overnight culture was centrifuged at 10,000 RPM for 10 minutes. Supernatant was discarded and pellet was resuspended in MgSO₄ to wash. The mixture was centrifuged again for 10 minutes at 10,000 RPM. The supernatant was discarded and the pellet was resuspended in Modified Hoagland's solution. The mixture was then diluted to provide an initial concentration (10⁰). From this 10⁻¹, 10⁻², 10⁻³, 10⁻⁴ and 10⁻⁵ dilutions of the RTI279 culture were made. For the experiments for each type of seed, 100 mm petri dishes were labeled with RTI279 or control, the dilution, and the date. A sterile filter paper was placed in the bottom of each dish. Five to 8 seeds were placed in a single petri dish depending on the type of seed (e.g., larger seeds such as corn had smaller numbers of seed/plate). 5 mL of each dilution of RTI279 was added to the plates and the seeds were incubated at 21° C. Corn, cotton, cucumber, tomato, and wheat seeds were tested at the 10°, 10⁻¹, and 10⁻² dilutions. Soy seed was tested at the full range of dilutions. Control plates contained seeds and Modified Hoagland's solution without added bacteria. Images of the plates were taken after 4 and 7 days. Sterile DI water was added to the plates when they began to dry out. The data are shown in Table IV below. In addition, FIGS. 2A-2D are images of soy showing the positive effects on root hair development after inoculation by vegetative cells of RTI279 diluted by 10⁻³ (B), 10⁻⁴ (C), and 10⁻⁵ (D), corresponding to (B) 1.04×10⁶ CFU/ml, (C) 1.04×10⁵ CFU/ml, and (D) 1.04×10⁴ CFU/ml, respectively, after 7 days of growth as compared to untreated control (A). The data show that addition of the RTI279 cells stimulated formation of fine root hairs compared to uninoculated control seeds. Fine root hairs are important in the uptake of water, nutrients and plant interaction with other microorganisms in the rhizosphere.

TABLE IV
Seed germination assay for treatment with vegetative cells of RTI279

| Vegetative Cells | | Dilution | | | | | |
|---|---|---|---|---|---|---|---|
| Crop | Starting CFU/ml | 10⁰ | 10⁻¹ | 10⁻² | 10⁻³ | 10⁻⁴ | 10⁻⁵ |
| Corn | 2.4 × 10⁸ | = | = | = | n.d. | n.d. | n.d. |
| Cotton | 1.04 × 10⁹ | − | − | = | n.d. | n.d. | n.d. |
| Cucumber | 1.04 × 10⁹ | + | ++ | ++ | n.d. | n.d. | n.d. |
| Soybean | 1.04 × 10⁹ | −− | −− | −− | ++ | ++ | + |
| Tomato | 1.04 × 10⁹ | + | + | + | n.d. | n.d. | n.d. |
| Wheat | 1.04 × 10⁹ | = | = | + | n.d. | n.d. | n.d. |

+++ very pronounced growth benefit,
++ strong growth benefit,
+ growth benefit,
+− weak growth benefit,
= no effect observed,
− weak inhibition,
−− strong inhibition,
n.d. not determined

Spores:

For the experiments using spores of RTI279, the strain was sporulated in 2XSG medium in a 14 L fermenter. Spores were collected but not washed afterwards at a concentration of 1.08×10¹⁰ CFU/mL. This was diluted down to 1.0×10⁷, 10⁶, and 10⁵ CFU/mL concentrations. A sterile filter paper was placed in the bottom of each sterile plastic growth chamber, and ten cucumber, radish and tomato seeds were placed in each container. 3 mL of each dilution of RTI279 spores was added to the growth chambers, which were closed and incubated at 19° C. for 7 days, after which the seedlings were imaged. A positive effect on growth of the seedlings was confirmed by increased overall root size, number of root hairs, and shoot length of the seedlings. A positive effect of strain RTI279 was observed at the concentration of 1.08×10⁶ CFU/ml for cucumber and radish, and at the concentration of 1.0×10⁵ CFU/ml for tomato and Kentucky blue grass.

Coated Seed Treatment:

For the experiments using seed coated with a composition containing RTI279, the following was performed. Seed treatment was performed by mixing 100 seeds with 250 μl solution containing a total of 5×10⁶, 5×10⁷, or 5×10⁸ cfu of strain RTI279, resulting in an average of 5×10⁴, 5×10⁵, or 5×10⁶ cfu per seed. Seeds were also coated with the antifungal compounds Fludioxonil and Metalaxyl. For seed germination, a sterile filter paper was placed in a sterile transparent box. Approximately 6 to 10 seeds were placed on top of the filter paper using sterile forceps and evenly spaced. Subsequently, 15 milliliters of Modified Hoagland solution was added to each box. The boxes were then covered and stored in a dark place to reduce experimental variation. The crops were observed every 4 days for a total duration of 12 days for seed germination and notable differences in shoot and root growth. Modified Hoagland solution was also added periodically to ensure plant germination. The effects of the seed coating with B. pumilus RT1279 were compared to Fludioxonil and Metalaxyl treated seeds to which no bacteria were added. The data are shown below in Table V.

TABLE V
Results of seed germination and growth after
seed treatment with RTI279.

| Seed | | | |
|---|---|---|---|
| Germination | | | |
| Assays | Concentration CFU/seed | | |
| Crop | 5 × 10⁴ | 5 × 10⁵ | 5 × 10⁶ |
| Canola | − | ++ | + |
| Corn | = | − | − |
| Cotton | − | + | − |
| Rice | ++ | ++ | = |

Effect on growth: ++ strong positive effect, + some improvement, = no effect observed, − weak inhibition

### Spores:

For the experiments using spores of CH200, the strain was sporulated in 2XSG medium in a 14 L fermenter. Spores were collected but not washed afterwards at a concentration of 7.7×10⁹ CFU/mL. This was diluted down to 1.0×10⁸, 10⁷, and 10⁶ CFU/mL concentrations using sterile Modified Hoagland solution. A sterile filter paper was placed in the bottom of each sterile plastic growth chamber and 6 corn, 5 cucumber, 6 soy, 5 squash, and 10 tomato seeds were placed in each container. 3 mL of each dilution of CH200 spores was added to the growth chambers, which were closed and incubated at 21° C. for 5 days, after which the seedlings were imaged. A positive effect on growth of the seedlings was confirmed by increased overall root size, number of root hairs, and shoot length of the seedlings. A positive effect of strain CH200 was observed at the concentration of 1.0×10⁶ CFU/ml for corn and 1.0×10⁷ CFU/ml for cucumber and soy. No deleterious effects on seed germination for any crop were seen at any concentration of CH200.

### Example 8

### Simulated In-Furrow Application of Growth Promoting Bacillus Strains to Corn Seed with Bifenthrin Insecticide Plus Liquid Fertilizer

The following simulated in-furrow experiments were performed in a greenhouse to measure the ability of a growth promoting strain of bacteria to enhance plant growth when applied in combination with a soil insecticide and a liquid fertilizer at the time of planting seed. The experiments were performed as described below for Bacillus pumilus RTI279, Bacillus licheniformis CH200 deposited as accession No. DSM 17236, Bacillus subtilis CH201 deposited as accession No. DSM 17231, and a combination of the strains CH200+CH201. The results unexpectantly showed that the addition of these growth promoting bacterial strains ameliorated the temporary growth inhibitory effect that can be caused by application of a liquid fertilizer to seed in sandy, lower pH-type soils or otherwise under conditions of osmotic stress. The results further showed significant improvements in plant growth and development as a result of treatment with the growth promoting strains, for example, a 10-20% increase in shoot height within the first week after emergence and a 20-48% increase in the longest nodal root length.

The experiments were performed as follows. At 7 days prior to application, B. pumilus RTI279 spores were resuspended in 10 ml of water+0.1% TWEEN 20 to prepare a solution at 1.5×10⁹ cfu/ml, which was held at 4° C. in dark conditions. Because it was determined that NEMIX C (CHR HANSEN, Hørsholm Denmark), having active ingredients Bacillus licheniformis CH200 deposited as accession No. DSM 17236 and Bacillus subtilis CH201 deposited as accession No. DSM 17231, was incompatible with the liquid fertilizer, a combination of the CH200+CH201 strains was used in the experiments instead of the product NEMIX C. Spores of each of the CH200 and CH201 strains were suspended in 10 ml of water+0.1% TWEEN 20 to prepare solutions at 1.0×10¹⁰ cfu/ml on the day of application.

Pennington soil or Midwestern soil was added to 2″ circular tubes measuring 9″ in length 5 days prior to test initiation. Tubes were held in growth chamber until a day prior to start of the experiment (−1DAP) and watered as needed in order to maintain moisture throughout the soil column. A space of 1.5″ remained between the soil surface and the upper rim of the tube. Pennington soil is a loam based soil (37% sand, 45% silt, 18% clay) with a pH of 5.25, analyzed to have 36 ppm (P), 154 ppm (K), 206 ppm (Mg), 1420 ppm (Ca), 15.63 ppm (Zn), 4.51 ppm (Cu), 48.33 ppm (Mn), 0.39 ppm (B), 294 ppm (Fe), and containing 2.9% organic matter. Conversely, the Midwestern soil from Wyoming, Ill. has a pH of 7.1, analyzed to have 36 ppm (P), 143 ppm (K), 772 ppm (Mg), 3744 ppm (Ca), 1.6 ppm (Zn), 2.9 ppm (Cu), 87 ppm (Mn), 1.4 ppm (B), 291 ppm (Fe), and contains 4.3% organic matter. The soils were microbially active. Tubes were held in greenhouse and arranged in a completely randomized design. Tubes were held in flats that could support a total of 32 plants each. Flats were not relocated or moved during the test.

The experiment was performed with a bifenthrin chemical insecticide at 112 g/Ai/HA; (CAPTURE LFR; FMC Corporation, Philadelphia, Pa.) plus a liquid fertilizer at 46.77 L/HA (NUCLEUS O-PHOS: 8-24-0; Helena Chemical Company, Angier, N.C.) alone as a control and with the further addition of varying amounts of spores of the growth promoting bacterial strains. Specifically, treatments were as follows for the RT1279 strain: 1) untreated 2) liquid fertilizer alone (Fertilizer); 3) insecticide+liquid fertilizer (CAPTURE LFR+Fertilizer); 4) insecticide+liquid fertilizer+RT1279 at 6.25×10⁹ CFU (RT1279 low rate); 5) insecticide+liquid fertilizer+RT1279 at 1.25×10¹¹ CFU (RT1279 mid rate); and 6) insecticide+liquid fertilizer+RT1279 at 2.5×10¹² CFU (RT1279 high rate).

Treatments for the remaining strains were as follows: 1) untreated 2) liquid fertilizer alone (Fertilizer); 3) insecticide+liquid fertilizer (CAPTURE LFR+Fertilizer); 4) insecticide+liquid fertilizer+CH200 at 2.5×10¹² CFU (CH200); 5) insecticide+liquid fertilizer+CH201 at 2.5×10¹² CFU (CH201); and 6) insecticide+liquid fertilizer+CH200+CH201 at 2.5×10¹² CFU (CH200+CH201).

On the day of initiation of the experiment (ODAP), the RT1279 spore stock solution was removed from the refrigerator; all other treatments were weighed out on the morning of ODAP. With the exception of the untreated check, all treatments were suspended in a liquid solution of the fertilizer and applied to the center of each pot at a volume of 1814. Previous spore viability tests had confirmed that the fertilizer had no adverse effect on spore germination. Plastic cups containing each treatment were swirled/agitated between each discharge of the pipette. Subsequently, an individual corn seed (PIONEER 33M53) was placed over the treated soil area and covered with precisely 1.5″ of untreated soil. The volume of soil required to cover each seed was predetermined and plastic cups were cut down to a specific size to ensure uniform soil volumes between pots and treatments. Treatments were watered in with 0.5″ of over head irrigation via a hose and sprayer attachment. There were 40 replicates per treatment. Percent emergence evaluations were recorded at 4, 5, 6, and 7DAP. Plant heights from the soil to the longest leaf were calculated at 8DAP. All treated pots were moved into cold growth chambers (15° C.) at 12DAP in order to curtail additional root and shoot growth and development.

Emergence responses differed by soil type. In Pennington soils, reduced plant emergence was detected at 5DAP for all treatments that included the liquid fertilizer; however, this negative response was not detected in tubes containing the Midwestern soil. All treatments with liquid fertilizer had increased emergence at 5DAP when applied to Midwestern soils; the increase in percent emergence ranged from 7.5% to as great as 45% for RT1279 treated seeds.

At 12DAP, the pots were destructively sampled over the course of 4 days. Measurements included seminal root length, longest nodal root length, average shoot length, dry shoot weight, and dry root weight. Roots and shoots were stored on trays, kept in ambient laboratory conditions of the Insectary, and dry weights were collected after 7 days of drying time. The data are shown in FIGS. 3-7 and Table VI below.

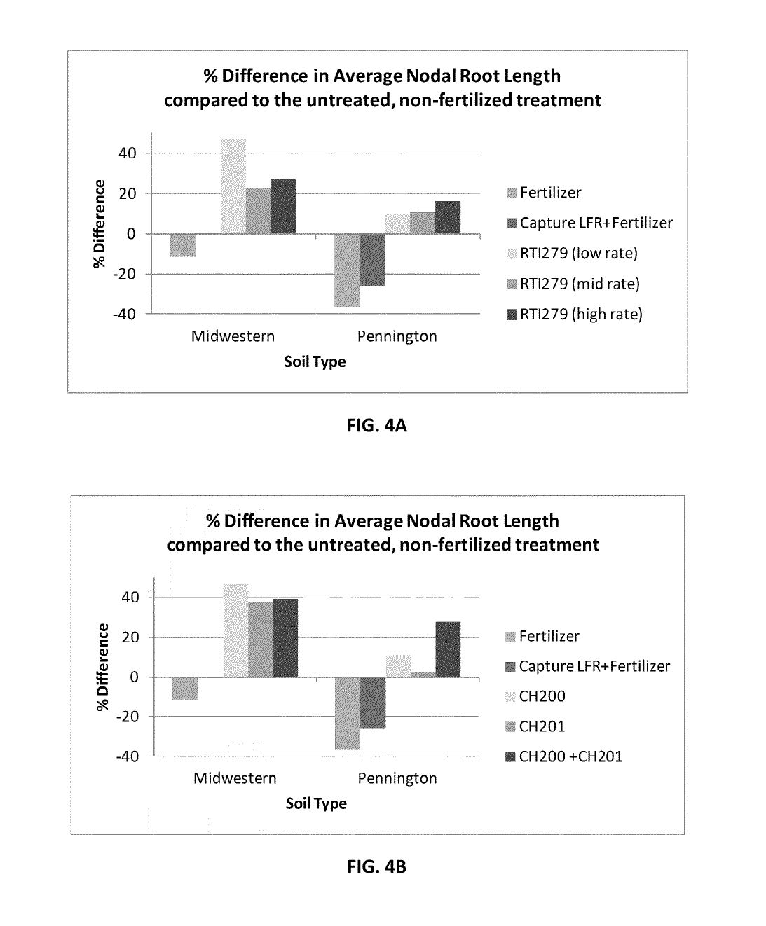

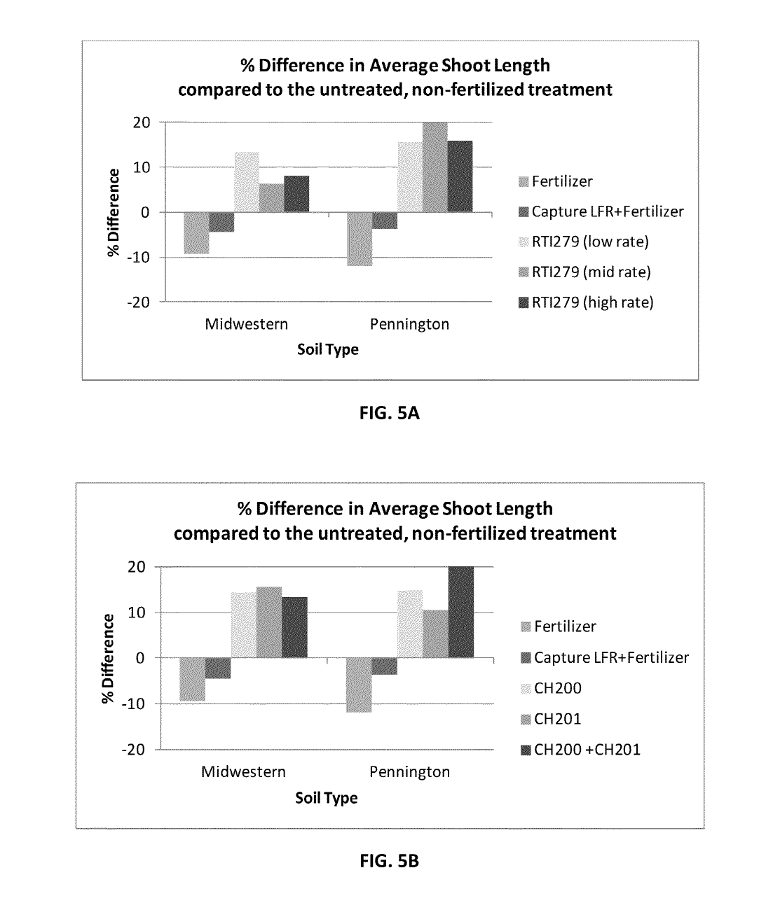

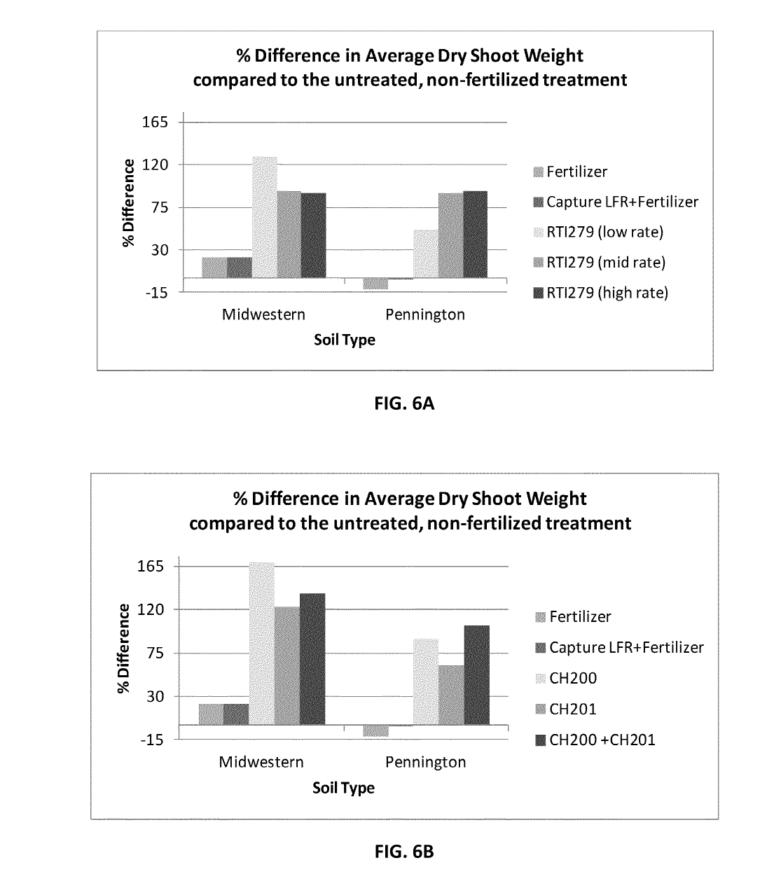

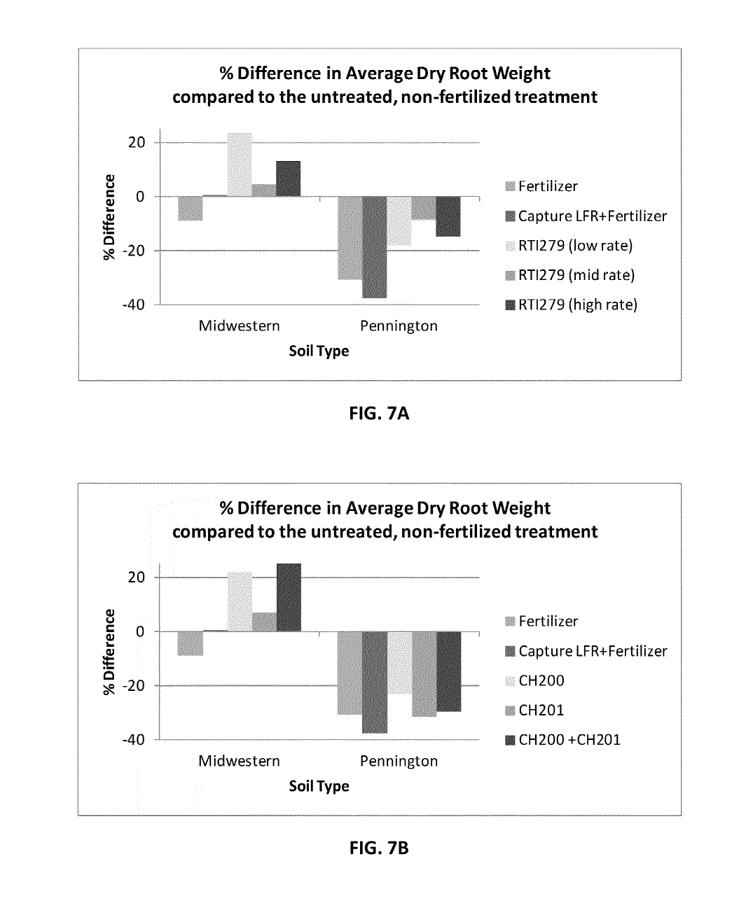

Specifically, FIGS. 3A-3B are bar graphs showing a comparison of the average seminal root length per corn plant 12 days after planting corn seeds treated with spores of a growth promoting bacterial strain in combination with an insecticide and a liquid fertilizer as compared to unfertilized seeds in each of Pennington soil and Midwestern soil soil. FIGS. 4A-4B are the same type of graphs showing a comparison of the nodal root length per plant treated with spores of the growth promoting strains as as compared to unfertilized seeds. FIGS. 5A-5B are the same type of graphs showing a comparison of the average shoot length per plant treated with spores of the growth promoting strains as as compared to unfertilized seeds. FIGS. 6A-6B are the same type of graphs showing a comparison of the average dry shoot weight per plant treated with spores of the growth promoting strains as as compared to unfertilized seeds. FIGS. 7A-7B are the same type of graphs showing a comparison of the average dry root weight per plant treated with spores of the growth promoting strains as as compared to unfertilized seeds.

In both Pennington soil and Midwestern soil, the average seminal root lengths were longest in the untreated check revealing a negative effect of the fertilizer treatment (FIGS. 3A-3B); however, this negative effect was partially reversed with addition of the RT1279 growth promoting spores in the Pennignton soil. In Pennington soil, the average dry root weight was also greatest in the untreated check, and the addition of RT1279 spore treatments ameilieorated the negative fertilizer effect (FIG. 7A). However a large negative fertilizer effect was not observed in Midwestern soil on dry root weights, and addition of spores of all of the growth promoting strains resulted in significantly greater dry root weights (FIGS. 7A-7B). In both Pennington and Midwestern soils, a longer nodal root was detected for addition of spores of all of the growth promoting strains in comparison to the untreated check (FIGS. 4A-4B).

In both Pennington and Midwestern soils a negative effect was observed on shoot length in the fertilizer alone treatments. Addition of spores of all of the growth promoting strains resulted in increased shoot lengths in both soil types as compared to the untreated check (FIGS. 5A-5B). Dry shoot weights were heavier in plants grown in Midwestern soil than those grown in Pennington soil for treatments lacking spores of the growth promoting strains (FIGS. 6A-6B). However, again, in both Pennington soil and Midwestern soil the average dry shoot weights were significantly increased for seeds treated with spores of all of the growth promoting strains (FIG. 6A-6B).

Midwestern Soil:

At 8DAP, RT1279 cell treatments applied at the highest rate (2.5×10¹² CFU) to Midwestern soil did not differ by more than 1 cm in overall plant height compared to the untreated check (data not shown). However, by 12DAP, average shoot length across all rates for RT1279 cells was 256 mm and was 21.8 mm longer than the untreated check. The fertilizer only treatment had the shortest shoots at the end of the test and was 9% shorter than the untreated non-fertilized treatment. Within Midwestern soil, roots exposed to RT1279 cell treatments were heavier than the untreated check, fertilizer only, and CAPTURE LFR+fertilizer (FIG. 7A). In Midwestern soil, the CH200, CH201, and CH200+CH201 treatments produced the longest shoots, and in-furrow applications of CH201 produced the longest average shoots (271 mm). The fertilizer only treatment had the shortest shoots at the end of the test and was 9% shorter than the untreated, non-fertilized control (FIGS. 5A-5B).

Pennington Soil:

For RTI279 cell treatments, shoot heights were shorter at 12DAP when plants were grown in Pennington soil. On average, shoot lengths for RTI279 were 4% shorter in Pennington soils. By 12DAP, all application rates of RTI279 had statistically longer shoots vs. the untreated, fertilizer only, and CAPTURE LFR+fertilizer groups. Average shoot lengths across all rates for RTI279 cell treatments was 246 mm and was 37 mm longer than the untreated check.

Data comparing treatment of corn seed at planting with CAPTURE LFR plus liquid fertilizer with and without addition of spores of a growth promoting bacterial strain in Midwestern soil are shown in Table VI below. The data in the Table indicate that the treatment of the corn seeds with the growth promoting strains provided a 10-20% increase in shoot height within the first week after emergence and a very significant increase (20-48%) in the longest nodal root length. Nodal roots contribute to a solid stand. Stand success is largely dependent on the initial development of nodal roots from stage V2 to V6 (Nielson, R. L. 2013). In Midwestern soil, the addition of a growth promoting strain increased the length of the longest nodal root and may help prevent “rootless corn syndrome” which occurs with reduced nodal root systems (Thomison, P. 2012).

TABLE VI
Comparison of shoot and longest nodal root length in corn after
treatment with chemical insecticide CAPTURE LFR plus liquid
fertilizer with and without growth promoting bacterial spores in
Midwestern soil.

| | Shoots in | | Nodal Roots in | |
|---|---|---|---|---|
| | Midwestern Soil | | Midwestern Soil | |
| | Mean Length | % | Mean Length | % |
| Treatment | (mm) | Increase | (mm) | Increase |
| CAPTURE + Fertilizer | 224 | — | 77.6 | — |
| RTI279 (Low Rate) | 266 | 18.7 | 114.6 | 47.7 |
| RTI279 (Med Rate) | 249 | 11.4 | 95.3 | 22.8 |
| RTI279 (High Rate) | 253 | 13.1 | 99.0 | 27.7 |
| CH200 | 268 | 19.7 | 113.9 | 46.8 |
| CH201 | 271 | 20.9 | 106.9 | 37.8 |
| CH200 + CH201 | 266 | 18.7 | 108.1 | 39.3 |

In summary, based on soil type, differing responses were observed related to emergence. In Pennington soils, the percentage of plants that had emerged was reduced at 5DAP for all treatments that included the liquid fertilizer as the carrier. Similar observations were made in an additional study when the liquid fertilizer was applied to Pennington soil 24 h prior to test initiation. At 12DAP, dry root weights of corn grown in Pennington soil were heaviest for the treatment without liquid fertilizer and were consistent with earlier data. The phenomenon of decreased early plant emergence and/or dry root weights associated with the utilization of the fertilizer was not detected in the Midwestern soils.

One major difference between the two soil types is pH (Pennington=5.25, Midwestern=7.1). Other differences associated with macro and micro nutrients are listed herein above. The fertilizer treatment may have had a transient adverse effect on the young germinating seedlings within Pennington soil. However, seed treated with CAPTURE LFR and fertilizer plus the growth promoting bacterial spores, resulted in longer nodal roots and longer/heavier shoots, and the seelings were larger than fertilizer-free and CAPTURE LFR plus fertilizer controls. The addition of the growth promoting bacterial spores had an immediate at-planting effect and apparently helped to protect the young seedlings against fertilizer burn.

### Example 9

### In-Furrow Delivery of Bacillus Pumilus RTI279 in Liquid Fertilizer in Combination with a Soil Insecticide

The following experiments were performed to measure the effect of Bacillus pumilus RTI279 on plant growth when applied in furrow with seed planting in combination with application of an insecticide and a liquid fertilizer in field conditions across the Midwest corn belt.

The experiments were performed with corn. The RTI279 strain was applied with a special application rig used to apply an insecticide and a liquid fertilizer. The fertilizer (NUCLEUS O-PHOS: 8-24-0; Helena Chemical Company, Angier, N.C.) was applied at rate of 5 gal per acre to all combinations except the untreated check. The insecticide (CAPTURE LFR (bifenthrin); FMC Corporation, Philadelphia, Pa.) was applied at 112 g/Ai/HA to all treatments except the untreated check and the fertilizer only check standard. These studies also included a CAPTURE LFR plus fertilizer treatment. RTI279 was applied at three rates which were 1.25×10¹¹ cfu/Ha (low rate), 2.5×10¹² cfu/Ha (medium rate) and 2.5×10¹³ cfu/Ha (high rate) in combination with the CAPTURE LFR and fertilizer. Specifically, treatments were as follows: 1) untreated; 2) liquid fertilizer alone; 3) CAPTURE LFR+liquid fertilizer; 4) CAPTURE LFR+liquid fertilizer+RTI279 low rate; 5) CAPTURE LFR+liquid fertilizer+RTI279 mid rate and 6) CAPTURE LFR+liquid fertilizer+RTI279 high rate.

Each treatment was applied in furrow at the time of corn planting at 20 different locations in the following states: IN, IA, NE, SD, ND, KS, OH, MN, IL, WI, LA and GA. The environmental across these was optimal with good growing conditions throughout the corn belt. Each trial had six replications for each treatment. The yield was determined for each of the trials and the data are shown in FIGS. 8-10.

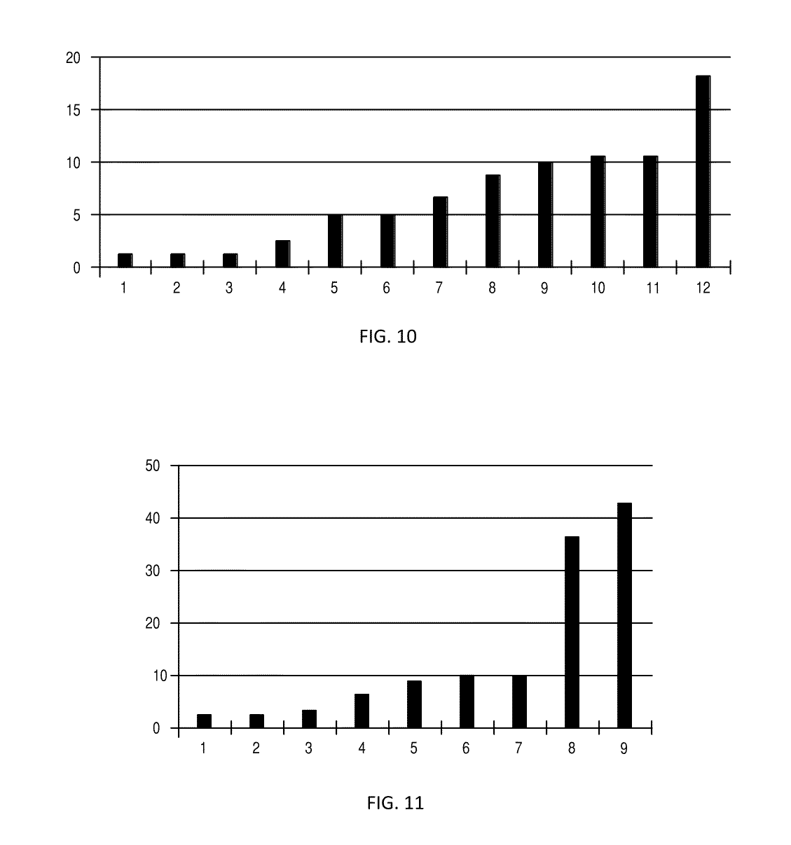

FIG. 8 is a bar graph showing the increase in corn yield that resulted in 10 of the 20 sites for the high rate of Bacillus pumilus RT1279 (2.5×10¹³ cfu/Ha) in combination with CAPTURE LFR plus liquid fertilizer over the application of CAPTURE LFR plus liquid fertilizer alone. The increase in yield (bushel/acre) is shown on the y axis and the bars on the x axis represent the 10 different sites that resulted in an increase in yield. FIG. 9 is a similar bar graph except that it shows the data for application of the medium rate of Bacillus pumilus RT1279 (2.5×10¹² cfu/Ha), which resulted in 12 of the 20 sites showing an increase in yield. FIG. 10 is a similar bar graph except that it shows the data for application of the low rate of Bacillus pumilus RT1279 (1.25×10¹¹ cfu/Ha), which also resulted in 12 of the 20 sites showing an increase in yield. The average increase in yield over the 20 field trials as a function of application rate of RT1279 in combination with liquid fertilizer plus CAPTURE LFR over CAPTURE LFR plus liquid fertilizer alone was 3.65, 2.1, and 2.2 bushels per acre for the high, medium and low application rate, respectively.

### Example 10

### In-Furrow Delivery of Bacillus Licheniformis CH200 in Liquid Fertilizer in Combination with a Soil Insecticide

The following experiments were performed to measure the effect of Bacillus Licheniformis CH200 on plant growth when applied in furrow with seed planting in combination with application of an insecticide and a liquid fertilizer in field conditions across the Midwest corn belt.

The experiments were performed with corn. The CH200 strain was applied with a special application rig used to apply insecticide and fertilizer. The fertilizer (NUCLEUS O-PHOS: 8-24-0; Helena Chemical Company, Angier, N.C.) was applied at rate of 5 gal per acre to all combination except the untreated check. The insecticide (CAPTURE LFR (bifenthrin); FMC Corporation, Philadelphia, Pa.) was applied at 112 g/Ai/HA to all treatments except the untreated check and the fertilizer only check standard. These studies also included a CAPTURE LFR plus fertilizer treatment. CH200 was applied at three rates which were 1.25×10¹¹ cfu/Ha (low rate), 2.5×10¹² cfu/Ha (medium rate) and 2.5×10¹³ cfu/Ha (high rate) in combination with the CAPTURE LFR and fertilizer. Specifically, treatments were as follows: 1) untreated; 2) liquid fertilizer alone; 3) CAPTURE LFR+liquid fertilizer; 4) CAPTURE LFR+liquid fertilizer+CH200 low rate; 5) CAPTURE LFR+liquid fertilizer+CH200 mid rate and 6) CAPTURE LFR+liquid fertilizer+CH200 high rate.

Each treatment was applied in furrow at the time of corn planting at 20 different locations in the following states: IN, IA, NE, SD, ND, KS, OH, MN, IL, WI, LA and GA. The environmental across these was optimal with good growing conditions throughout the corn belt. Each trial had six replications for each treatment. The yield was determined for each of the trials and the data are shown in FIGS. 11-13.

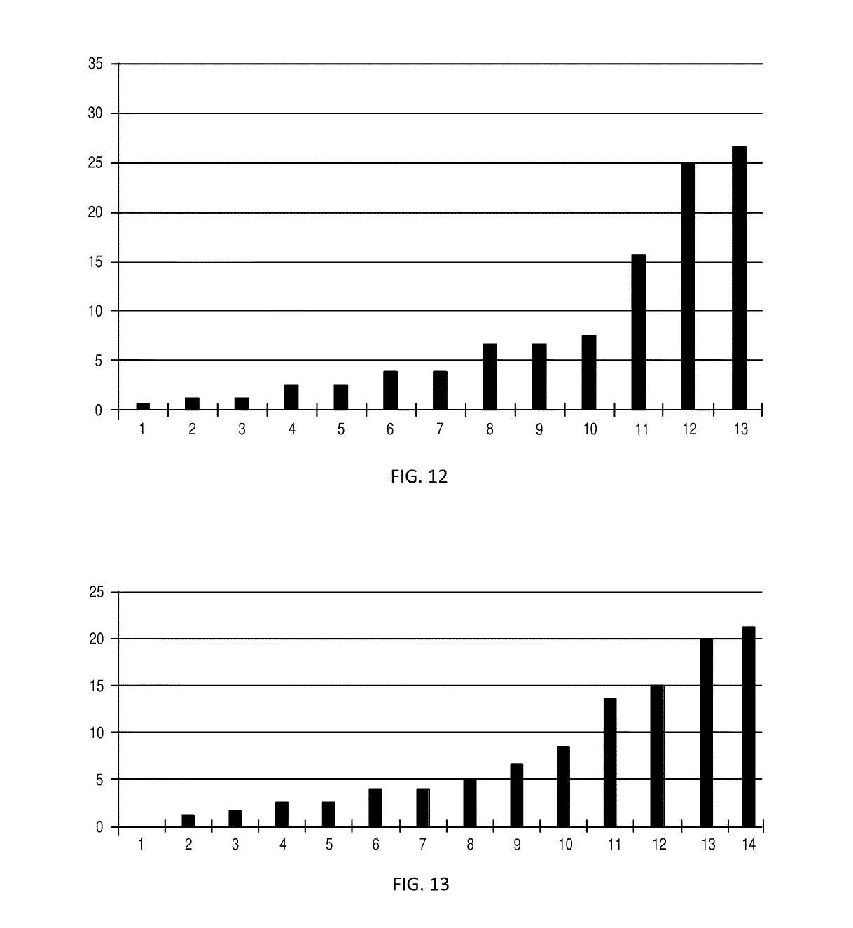

FIG. 11 is a bar graph showing the increase in corn yield that resulted in 9 of the 20 sites for the high rate of Bacillus licheniformis CH200 (2.5×10¹³ cfu/Ha) in combination with CAPTURE LFR plus liquid fertilizer over the application of CAPTURE LFR plus liquid fertilizer alone. The increase in yield (bushel/acre) is shown on the y axis and the bars on the x axis represent the 9 different sites that resulted in an increase in yield. FIG. 12 is a similar bar graph except that it shows the data for application of the medium rate of Bacillus licheniformis CH200 (2.5×10¹² cfu/Ha), which resulted in 13 of the 20 sites showing an increase in yield. FIG. 13 is a similar bar graph except that it shows the data for application of the low rate of Bacillus licheniformis CH200 (1.25×10¹¹ cfu/Ha), which resulted in 14 of the 20 sites showing an increase in yield.

The average increase in yield over the 20 field trials as a function of application rate of CH200 in combination with liquid fertilizer plus CAPTURE LFR over CAPTURE LFR plus liquid fertilizer alone was 4.65, 4.1, and 2.2 bushels per acre for the high, medium and low application rate, respectively.

### Example 11

### In-Furrow Delivery of Bacillus Licheniformis CH200 in Liquid Fertilizer in Combination with a Soil Insecticide—Normal Moisture and Drought Stress

A greenhouse study was conducted to evaluate the role of the B. Licheniformis CH200 strain on corn growth under optimal and drought stress conditions. Results of these studies showed that in-furrow application of bacterial strain CH200 with CAPTURE LFR+fertilizer (8-24-0) under two water regimes can provide an early growth benefit to corn. In water stressed soil conditions, fertilizer negatively impacted early developing root systems; however, by 41DAP (V6 stage) those plants in CAPTURE LFR+CH200 had statistically thicker stalks, statistically heavier dry shoot weights, and statistically heavier dry root weights (see, for example, FIGS. 14A-14C). In optimal watering conditions, limited statistical differences were detected between CAPTURE LFR and CAPTURE LFR+CH200; with the exception that statistically thicker stalks were measured at 41DAP when corn was treated with the CH200 strain.

Materials and Methods:

A greenhouse study was conducted to study the effect of the B. Licheniformis CH200 strain in combination with CAPTURE LFR on corn growth in the presence of continuous water stress or optimal water conditions.

Treatment Detail:

The B. Licheniformis CH200 strain was co-applied with CAPTURE LFR (bifenthrin 17.15%) plus 8-24-0 fertilizer (NUCLEUS O-PHOS) and compared to applications of CAPTURE LFR plus fertilizer alone and a non-treated check. Application rates of the CAPTURE LFR, fertilizer and CH200 strain are given in Table VII. The Midwestern soil (Wyoming, Ill.) was microbially active. Treatments were applied at the time of planting to mimic in-furrow application. Seed selection eliminated oddly shaped and/or small seeds. The day of the study initiation was designated “ODAP” and the study ended at the V6 growth stage 41 days later “41DAP”.

TABLE VII
Study protocol: CAPTURE LFR plus B. Licheniformis CH200

| | | | | | | |
|---|---|---|---|---|---|---|
| | | CAPTURE | NUCLEUS O- | | | |
| | | LFR Rate | PHOS (Fertilizer) | Rate | Application | Application |
| TRT # | Treatments | g ai/ha | Rate L/ha | CFU's/ha | Type | Timing |

Water Stress

| | | | | | | |
|---|---|---|---|---|---|---|
| 1 | Non-treated check | — | — | — | — | — |
| 2 | CAPTURE LFR + | 112 g ai/ha | 46.77 L/ha | — | In-Furrow | At Planting |
| | Fertilizer | | | | | |
| 3 | CH200 + CAPTURE | 112 g ai/ha | 46.77 L/ha | 2.50E+12 | In-Furrow | At Planting |
| | LFR + | | | | | |
| | Fertilizer | | | | | |

Optimal

| | | | | | | |
|---|---|---|---|---|---|---|
| 4 | Non-treated check | — | — | — | — | — |
| 5 | CAPTURE LFR + | 112 g ai/ha | 46.77 L/ha | — | In-Furrow | At Planting |
| | Fertilizer | | | | | |
| 6 | CH200 + CAPTURE | 112 g ai/ha | 46.77 L/ha | 2.50E+12 | In-Furrow | At Planting |
| | LFR + | | | | | |
| | Fertilizer | | | | | |

Watering Conditions:

Drought stress and optimal watering regimes were included in the assay design with daily monitoring of soil moisture conducted. Soil moisture was determined with a soil moisture probe (RAPITEST MOISTURE METER, LUSTER LEAF PRODUCTS, INC.) using a scale of 0=no moisture and 10=completely saturated. The probe was inserted into 5 separate pots of each moisture type and at 5 depths between 0.064 cm and 20.32 cm. Averages at each depth were recorded on a raw data sheet. The optimal soil moisture for corn growth is 7 (based on the soil moisture chart; no units are provided on the soil moisture meter). Specific volumes of water were added to each pot to maintain developing corn plants in either drought stress or optimal growing conditions throughout the study.

Assay Design:

Each treatment with regards to a water condition was replicated 60 times and the experiment was conducted in split plot design. The study was conducted for 41 days. At 3 dates, a subset of plants (n=20) were destructively sampled and assessed. Growth and development parameters were evaluated at the V2, V4, and V6 growth stage.

Planting Detail:

Corn was planted in 3″×9″ (7.62 cm×22.86 cm) plastic pots. Pots were filled with Midwestern soil from Wyoming, Ill. by leaving 1.75″ space from the top. A coffee filter was placed at the bottom of each pot to prevent soil loss. Soil-filled pots were held in greenhouse for 7 days and pots were watered as needed in order to maintain moisture throughout the soil column in order to initiate the soil microbial activity. On the day of planting (ODAP), soil moisture was assessed with the moisture probe; optimal soil had a value of 7 and water stressed soil had a value of 2. Corn was planted at 1.5″ deep and covered with the soil to leave 0.25″ space at the top of each pot.

Based on soil testing lab results, Midwestern soil has a pH of 7.1, analyzed to have 36 ppm (P), 143 ppm (K), 772 ppm (Mg), 3744 ppm (Ca), 1.6 ppm (Zn), 2.9 ppm (Cu), 87 ppm (Mn), 1.4 ppm (B), 291 ppm (Fe), and contains 4.3% organic matter (AT2805). On the day of test initiation (0 DAP), the CAPTURE LFR insecticide and CH200 bacterial spores at 2.83×10¹¹ CFU/g were weighed out. With the exception of the non-treated check, all treatments were suspended in fertilizer (NUCLEUS O-PHOS) and applied to the center of each pot at a volume of 272 μL. Plastic cups containing each treatment were agitated before each treatment application. Only water was applied in the non-treated check. Subsequently, an individual corn seed (PIONEER 33M53) was placed over the treated soil area and covered with precisely 1.5″ of non-treated soil. The volume of soil required to cover each seed was predetermined to ensure uniform soil volumes between pots and treatments.

One day prior to extracting plants from soil, all shoot lengths were measured. Subsequently, each treatment was sorted from shortest to tallest. At the V2 assessment, every 3^{rd} plant from smallest to tallest was selected in order to ensure that a normal distribution of plant sizes across the bell curve was assessed and to prevent biases.

Twenty corn plants were removed from soil at 15DAP, 28DAP, and 41DAP with minimal breakage of plant roots. Soil was removed from the corn roots very gently to prevent the breakage of roots. Corn roots were washed with tap water until completely clean. The 5 largest and 5 smallest plants were excluded and the middle 10 plants per treatment were photographed. Wet roots were immediately covered with wet paper towel to avoid the drying of plants. Corn shoot and roots were separated to determine above ground dry biomass and dry root biomass (mg). Corn seed was removed before separating the corn shoot and root and was not included in the dry biomass evaluations. Plant parts were stored in oven at 50° C. for 10 days and dry plant parts were weighed using a balance. Data were analyzed using MINITAB statistical software (ANOVA, GLM) at 90% confidence interval.

### Results

Water Stressed:

Shoot Height:

The untreated check and CAPTURE LFR+CH200 had statistically longer shoots at 13DAP (Table VIII). By the V4 stage and onward (26DAP), both treatments with fertilizer were statistically the same and statistically longer than the untreated check.

### Shoot Width:

CAPTURE LFR+CH200 had statistically thicker stalks at 41DAP with an average diameter of 9.4 mm at the 3^{rd} leaf collar. This was a 9% increase vs. CAPTURE LFR (8.6 mm) (Table IX).

TABLE VIII
Average height (mm) of corn shoots (±SE) maintained in Midwestern soil under drought
stress conditions and grown to the V6 growth stage

| Watering | | | | | | |
|---|---|---|---|---|---|---|
| Condition | Treatment | 13DAP | 15DAP | 26DAP | 28DAP | 41DAP |
| Stressed | Non- | 165.20 (±3.09)a | 233.70 (±10.30)a | 364.13 (±5.54)b | 374.80 (±6.45)b | 458.70 (±11.10)b |
| | treated | | | | | |
| | check | | | | | |
| Stressed | Capture | 151.83 (±3.12)b | 234.55 (±08.60)a | 419.00 (±6.08)a | 429.30 (±8.65)a | 546.70 (±11.70)a |
| | LFR + | | | | | 553.90 (±10.10)a |
| | Fertilizer | | | | | |
| Stressed | Capture | 162.67 (±3.79 a | 238.90 (±10.70)a | 424.57 (±5.54)a | 446.57 (±8.68)a | 553.90 (±10.10)a |
| | LFR + | | | | | |
| | Fertilizer + | | | | | |
| | CH200 | | | | | |

Note:
Mean associated with the same letter in a column are not significantly different.

TABLE IX
Shoot width (mm) recorded from 20 plants on
the last day of the greenhouse bioassay
measured at the collar of the 3^{rd} leaf

V6 (41DAP)

| Treatment | Stressed | Optimal |
|---|---|---|
| Non-treated check | 5.c | 10.c |
| Capture LFR + Fertilizer | 8.b | 11.b |
| Capture LFR + Fertilizer + CH200 | 9.a | 12.a |

Note:
Mean within a column sharing the same letter are not significantly different at 90% level of significance.

### Dry Shoot Weights:

CAPTURE LFR+CH200 treated plants had a 29% increase and statistically heavier dry shoot weights (1416 mg) at the V6 stage vs. CAPTURE LFR alone (1095 mg) (Table X).

TABLE X
Dry shoot and root weights (mg) at 3 sampling dates
when plants maintained in drought stress conditions.

Dry Shoot Weights in
Drought Stress Conditions

| | | V2 | V4 | V6 |
|---|---|---|---|---|
| | Untreated | 68.2 | 305.2 | 517.3 |
| | Capture LFR | 80.6 | 480.8 | 1094.7 |
| | Capture LFR + CH200 | 94.7 | 498.2 | 1416 |
| ANOVA | Untreated | b | b | c |
| 90% CI | Capture LFR | ab | a | b |
| | Capture LFR + CH200 | a | a | a |

Chlorophyll Analysis:

CAPTURE LFR and Capture LFR+CH200 treated corn had a 28% increase in chlorophyll content and a statistically higher chlorophyll values at 26DAP (V4) vs. the untreated (Table XI).

TABLE XI
SPAD 502 PLUS CHLOROPHYLL METER readings of
corn plants with 3 differing at plant treatment
applications and grown under continuous water
stress or optimal water conditions.

| | |
|---|---|
| 13DAP (n = 60) | 26DAP (n = 40) |

| Treatment | Stressed | Optimal | Stressed | Optimal |
|---|---|---|---|---|
| Non-treated | 44.15 a | 46.29 b | 43.26 b | 39.08 b |
| check | | | | |
| Capture LFR + | 43.89 a | 49.99 a | 55.50 a | 48.46 a |
| Fertilizer | | | | |
| Capture LFR + | 44.30 a | 50.80 a | 54.71 a | 47.27 a |
| Fertilizer + | | | | |
| CH200 | | | | |

Note:
Mean associated with the same letter in a column are not significantly different.

### Seminal Roots:

There was no statistical difference in the average seminal root length between treatments at any evaluation date (data not shown). No measurements were taken at the V6 stage because roots were consistently touching the bottom of the pots.

### Nodal Roots:

The longest nodal root was longest in plants treated with CAPTURE LFR and CAPTURE LFR+CH200 (Table XII). No measurements were taken at V6 because roots had consistently reached the bottom of the pots.

TABLE XII
Average length (mm) of corn roots maintained in
Midwestern soil under drought stress conditions
at the V2 and V4 growth stage.

| | | Seminal Root | | Nodal Root | |
|---|---|---|---|---|---|
| | | Length (mm) | | Length (mm) | |
| Watering | | V2 | V4 | V2 | V4 |
| Condition | Treatment | (15DAP) | (28DAP) | (15DAP) | (28DAP) |
| Stressed | Non-treated | 226.5 a | 274.2 a | 92.3 a | 141.1 b |
| | check | | | | |
| Stressed | Capture | 212.0 a | 265.9 a | 75.8 a | 165.9 a |
| | LFR + | | | | |
| | Fertilizer | | | | |
| Stressed | Capture | 224.6 a | 272.0 a | 69.0 a | 167.1 a |
| | LFR + | | | | |
| | Fertilizer + | | | | |
| | CH200 | | | | |

Note:
Mean associated with the same letter in a column are not significantly different.

### Dry Root Weights:

CAPTURE LFR+CH200 treated plants had a 23% increase and statistically heavier dry root weights (841 mg) at the V6 stage vs. CAPTURE LFR (683 mg) (Table XIII).

TABLE XIII
Dry shoot and root weights (mg) at 3 sampling dates
when plants maintained in drought stress conditions.

Dry Root Weights in
Drought Stress Conditions

| | | V2 | V4 | V6 |
|---|---|---|---|---|
| | Untreated | 71.9 | 297.4 | 466.3 |
| | Capture LFR | 51.5 | 285.9 | 682.9 |
| | Capture LFR + CH200 | 56.4 | 265.5 | 841.4 |
| ANOVA | Untreated | a | a | c |
| 90% CI | Capture LFR | b | a | b |
| | Capture LFR + CH200 | b | a | a |

### WinRhizo Root Scan Analysis:

52 parameters were assessed per root system. Only statistically differences are reported in the table (Table 15a and b). Untreated check roots were often times statistically better than those with liquid fertilizer as the carrier.

Optimal Watering Conditions:

Shoot Height:

CAPTURE LFR and CAPTURE LFR+CH200 treated corn had statistically longer shoots than the untreated check between 13DAP (V2) and 28DAP (V4) (Table XIV). On the last measurement date the untreated check was equivalent in length the treatments containing fertilizer.

TABLE XIV
Average height (mm) of corn shoots (±SE) maintained in Midwestern soil under optimal
watering conditions and grown to the V6 growth stage

| Watering | | | | | | |
|---|---|---|---|---|---|---|
| Condition | Treatment | 13DAP | 15DAP | 26DAP | 28DAP | 41DAP |
| Optimal | Non- | 161.38 (±3.24)b | 267.85 (±4.63)b | 435.13 (±7.31)b | 453.00 (±9.53)b | 645.30 (±11.30)a |
| | treated | | | | | |
| | check | | | | | |
| Optimal | Capture | 177.00 (±3.74)a | 289.55 (±8.81)a | 532.63 (±7.52)a | 573.00 (±13.20)a | 662.30 (±14.80)a |
| | LFR + | | | | | |
| | Fertilizer | | | | | |
| Optimal | Capture | 180.07 (±2.82)a | 296.40 (±4.80)a | 535.67 (±7.27)a | a 583.90 (±10.40)a | 683.10 (±13.10)a |
| | LFR + | | | | | |
| | Fertilizer + | | | | | |
| | CH200 | | | | | |

Note:
Mean associated with the same letter in a column are not significantly different.

### Shoot Width:

At 41DAP (V6), Capture LFR+CH200 treated corn were 8.5% thicker with statistically greater girth at the 3^{rd} leaf collar compared to Capture LFR (see Table IX above).

### Dry Shoot Weights:

Both Capture LFR alone and in combination with CH200 had a 46% increase in shoot weights at V6 compared to the untreated check (Table XV).

TABLE XV
Dry shoot weights (mg) at 3 sampling dates when
plants maintained in optimal watering conditions.

| | Dry Shoot Weights in | | | |
|---|---|---|---|---|
| | Normal Watering Conditions | | | |
| | | V2 | V4 | V6 |
| | Untreated | 97.1 | 544.2 | 1799.3 |
| | Capture LFR | 110.2 | 1061.2 | 2678 |
| | Capture LFR + CH200 | 134.4 | 1125.5 | 2640 |
| ANOVA | Untreated | b | b | b |
| 90% CI | Capture LFR | b | a | a |
| | Capture LFR + CH200 | a | a | a |

### Chlorophyll Analysis:

Capture LFR and Capture LFR+CH200 treated corn had an approximate 20% increase and statistically higher chlorophyll values at 13DAP (V2) and 26DAP (V4) compared to the untreated check (see Table XI above).

### Seminal Roots:

There was no statistical difference in the average seminal root length between treatments at 15DAP (V2) (Table XVI); however, seminal root length of plants treated with CAPTURE LFR+CH200 were shortest at 28DAP (V4). No measurements were taken at the V6 stage because roots were consistently touching the bottom of the pots.

### Nodal Roots:

At 15DAP (V2), the longest nodal roots were in plants treated with CAPTURE LFR+CH200 (Table XVI); however, no differences were detected at 28DAP (V4). No measurements were taken at the V6 stage because roots were consistently touching the bottom of the pots.

TABLE XVI
Average length (mm) of corn roots maintained in
Midwestern soil under optimal watering conditions
at the V2 and V4 growth stage.

| | | Seminal Root | | Nodal Root | |
|---|---|---|---|---|---|
| | | Length (mm) | | Length (mm) | |
| Watering | | V2 | V4 | V2 | V4 |
| Condition | Treatment | (15DAP) | (28DAP) | (15DAP) | (28DAP) |
| Optimal | Non-treated | 207.8 a | 308.6 a | 117.3 b | 201.5 a |
| | check | | | | |
| Optimal | Capture | 202.8 a | 299.3 ab | 131.3 ab | 190.5 a |
| | LFR + | | | | |
| | Fertilizer | | | | |
| Optimal | Capture | 203.4 a | 283.1 b | 143.3 a | 213.0 a |
| | LFR + | | | | |
| | Fertilizer + | | | | |
| | CH200 | | | | |

Note:
Mean associated with the same letter in a column are not significantly different.

### Dry Root Weights:

CAPTURE LFR and CAPTURE LFR+CH200 treated plants had statistically heavier dry root weights at the V4 and V6 stage (Table XVII). At V6, there was a 65% increase compared to the untreated check.

TABLE XVII
Dry root weights (mg) at 3 sampling dates when
plants maintained in optimal watering conditions.

Dry Root Weights in
Normal Watering Conditions

| | | V2 | V4 | V6 |
|---|---|---|---|---|
| | Untreated | 53 | 371.6 | 998.9 |
| | Capture LFR | 46.9 | 523.2 | 1576.2 |
| | Capture LFR + CH200 | 48.1 | 521.9 | 1647 |
| ANOVA | Untreated | a | b | b |
| 90% CI | Capture LFR | a | a | a |
| | Capture LFR + CH200 | a | a | a |

Overall, treatments having bacterial strain CH200 provided thicker corn stalks at 41DAP in both water stressed and optimal watering conditions compared to CAPTURE LFR+fertilizer or water alone (FIG. 15). Dry weights of both roots and shoots for plants maintained in drought stress conditions were heavier than CAPTURE LFR with fertilizer as the carrier or the untreated check (water) (FIG. 15). Plants growing in optimal soil conditions containing CH200 were further along in development. In general, plants growing in either optimal or drought soil conditions containing CH200 possessed an additional leaf coupled with a wider and longer 8^{th} or 9^{th} leaf (FIGS. 16A-16C and FIGS. 17A-17C).

### Example 12

### Effects of Drip Irrigation with Bacillus Licheniformis Isolate CH200 on Broccoli and Turnip

Experiments were performed to determine the effect of drip irrigation with spores of the B. licheniformis CH200 strain on broccoli and turnip. The effects on plant yield were determined according to the experiments described below.

A field trial was performed for broccoli plants where drip irrigation was used to apply 1.5×10¹¹, 2.5×10¹², or 2.5×10¹³ CFU/hectare of B. licheniformis CH200 spores at the time of planting, and again 2 weeks later. As compared to control plants in which B. licheniformis CH200 spores were not included in the irrigation, addition of the CH200 spores to the broccoli resulted in an increase in fresh weight yield broccoli from 3 kg (control) to 3.6 kg and 3.8 kg at each of the 2.5×10¹³ CFU/hectare and 2.5×10¹² CFU/hectare applications of CH200, which represents a 20% to 26% increase in weight, respectively.

A similar field trial was performed in which turnip plants were drip irrigated with 1.5×10¹¹, 2.5×10¹², or 2.5×10¹³ CFU/hectare of B. licheniformis CH200 spores at the time of planting and again 2 weeks later. As compared to control plants in which B. licheniformis CH200 spores were not included in the irrigation, addition of the CH200 spores to the turnip plants resulted in an increase in tuber weight yield from 3.3 kgs (control) to 5.8 kg (2.5×10¹³ CFU/hectare CH200), 4.2 kg (2.5×10¹² CFU/hectare CH200), and 4.9 kg (1.5×10¹¹ CFU/hectare CH200) or a 76%, 27%, and 48% increase in weight, respectively.

### Example 13

### Effects of Drip Irrigation with Bacillus Pumilus Isolate RTI279 on Squash and Turnip

Experiments were performed to determine the effect of drip irrigation with spores of the B. pumilus RTI279 strain on squash and turnip. The effects on plant growth and yield were determined according to the experiments described below.

A field trial was performed for squash plants where drip irrigation was used to apply 1.5×10¹¹ or 2.5×10¹² CFU/hectare of B. pumilus RTI279 spores at the time of planting, and again 2 weeks later. As compared to control plants in which B. pumilus RTI279 spores were not included in the irrigation, addition of the RTI279 spores resulted in an increase in yield for both total and marketable squash. Specifically, RTI279 treated plants (application rate 2.5×10¹² CFU/hectare) resulted in an average of 36 kg of total squash of which 30 kg was marketable, as compared to 22 kg of total squash of which 17 kg was marketable for the untreated control plants (FIG. 18A (control plants) & 18B (RTI279 at application rate 2.5×10¹² CFU/hectare)).

A similar field trial was performed in which turnip plants were drip irrigated with 2.5×10¹¹ or 2.5×10¹² CFU/hectare of B. pumilus RTI279 spores at the time of planting and again 2 weeks later. As compared to control plants in which B. pumilus RTI279 spores were not included in the irrigation, addition of the RTI279 spores at both concentrations resulted in a consistent increase in yield of 67% as measured in tuber weight.

### Example 14

### Effects of Coating Corn Seed with Bacillus Pumilus Isolate RTI279

Experiments were performed to determine the effect of coating corn seed with spores of the B. pumilus RTI279 strain in addition to a typical chemical control. The effects on time to plant emergence, plant stand, plant vigor, and grain yield were measured for multiple field trials in Wisconsin. Experiments were performed as described below.

Formulations:

A B. pumilus RTI279 spore concentrate (1.0×10⁺¹° cfu/ml) in water was applied at an amount of 1.0×10⁺⁵ cfu/seed.

MAXIM (SYNGENTA CROP PROTECTION, INC) was applied to seed at 0.0064 mg AI/kernel (fludioxonil).

Metalaxyl was applied to seed at 0.005 mg AI/kernel.

PONCHO 250 and PONCHO 500 (BAYER CROP SCIENCE) were applied to seed at 0.25 mg AI/kernel and 0.50 mg AI/kernel, respectively (Clothianidin).

Ipconazole was applied to seed at 0.0064 mg AI/kernel.

Treatment Application Method:

In one experiment, seed treatment was performed by mixing corn seeds with a solution containing spores of B. pumilus RTI279 and chemical control MAXIM+Metalaxyl+PONCHO 250 that resulted in an average of 1×10⁵ cfu per seed and the chemical active ingredients at the label-indicated concentrations as detailed above. The experiment was performed with untreated seed and seed treated with the chemical control alone as controls. The untreated seed and each of the treated corn seed were planted in three separate field trials in Wisconsin and analyzed by length of time to plant emergence, plant stand, plant vigor, and grain yield in bushels/acre. Using an average of the data from the three field trials, addition of the chemical control as compared to untreated seed resulted in a statistically significant increase in each of time to plant emergence, plant stand, plant vigor, and grain yield. Inclusion of the B. pumilus RTI279 in the seed treatment as compared to the seed treated with chemical control alone did not have a statistically significant effect on time to plant emergence, plant stand, or plant vigor, but did result in an increase of 12 bushels/acre of grain (from 231 to 243 bushels/acre) representing a 5.2% increase in grain yield.

A related trial was performed as described above, except that the corn plants were challenged separately with the pathogens Rhizoctonia and Fusarium graminearum. Disease severity was rated by visual inspection on a scale of 1 to 5. Treatment of the seed with B. pumilus RT1279 as compared to seed treated with chemical control alone resulted in a statistically significant decrease in disease severity for Fusarium graminearum.

In a separate experiment, seed treatment was performed by mixing corn seeds (2 different varieties were tested per trial) with a solution containing spores of B. pumilus RT1279 and chemical control Ipconazole+Metalaxyl+PONCHO 500 that resulted in an average of 1×10⁵ cfu per seed and the chemical active ingredients at the label-indicated concentrations as detailed above. Nineteen trials were performed with the untreated seed and each of the treated corn seeds in 11 locations across 7 states and analyzed by grain yield in bushels/acre. Using an average of the data from 16 of the field trials, addition of the chemical control as compared to untreated seed resulted in a statistically significant increase (9.8 bushels/acre) in grain yield. Inclusion of the B. pumilus RT1279 in the seed treatment as compared to the seed treated with chemical control alone resulted in an additional increase of 3 bushels/acre of grain representing a 1.5% increase in grain yield.

### Example 15

### Growth Effects of Cucumber and Tomato when Grown in Potting Soil Enhanced with Spores of Bacillus Licheniformis CH200

The ability of the isolated strain of Bacillus licheniformis CH200 to improve growth and health of tomato and cucumber was determined by planting seeds in potting soil to which the spores of the Bacillus licheniformis CH200 strain had been added.

The Bacillus licheniformis CH200 strain was deposited on Apr. 7, 2005 at Deutsche Sammlung von Mikroorganismen and Zellkulturen GmbH, Mascheroder Weg 1 b, D-38124 Braunschweig (DSMZ) and given the accession No. DSM 17236.

For the experiments using spores of CH200, the strain was each sporulated in 2XSG in a 14 L fermenter. Spores were collected but not washed afterwards at a concentration of at least 1.0×10⁷ to 10⁹ CFU/mL.

The effect of the presence of spores of the bacterial isolate CH200 when present in potting soil on growth and vigor for cucumber and tomato was determined. In this experiment, cucumber and tomato seeds were planted in SCOTTS MIRACLE GROW (SCOTTS MIRACLE GRO, Co; Marysville, Ohio) soil tossed with 1×10⁷ spores/g Bacillus licheniformis strain CH200. Specifically, the soil to which the CH200 spores had been added was SCOTTS MIRACLE GRO soil (pH~5.5). Tomato was tested in 4″ pots and cucumber was tested in 6″ pots. One seed was planted per pot and there were 8 replicates per treatment. Images of the tomato plants at week 5 are shown in FIGS. 19A-19B and of the cucumber plants in FIGS. 20A-20B. Visual inspection of both the tomato and cucumber plants showed enhanced growth and increased biomass for all the plants grown in the SCOTTS MIRACLE GRO soil with added Bacillus licheniformis CH200 over the unaltered SCOTTS MIRACLE GRO soil. Specifically, FIGS. 19A-19B are images showing the positive effects on tomato growth as a result of addition of Bacillus licheniformis CH200 spores to SCOTTS MIRACLE-GRO soil at a pH of 5.5. A) Plants grown in soil with added Bacillus licheniformis CH200 spores at 1×10⁷ spores/g. B) Control plants grown in the same soil without added Bacillus licheniformis CH200. FIGS. 20A-20B are images showing the positive effects on cucumber growth in SCOTTS MIRACLE-GRO (SCOTTS MIRACLE GRO, Co; Marysville, Ohio) soil at pH 5.5 after addition of Bacillus licheniformis CH200 spores to the soil. A) Control plants grown in soil without addition of Bacillus spp. spores; and B) Plants grown in soil with addition of 1×10⁷ spores/g Bacillus licheniformis CH200 spores.

### Example 16

### Growth Effects of In-Furrow Application of Bacillus Licheniformis CH200 on Corn

The following experiments were performed to measure the effect of Bacillus licheniformis CH200 on corn plant growth when applied in furrow with seed at planting in combination with application of a liquid insecticide and a liquid fertilizer in field conditions.

Spores of the CH200 strain were applied in furrow at 2.5×10¹² cfu/Ha as a liquid in combination with an insecticide and fertilizer to corn seed in field trials. The insecticide (CAPTURE LFR (bifenthrin); FMC Corporation, Philadelphia, Pa.) was applied at 112 g/Ai/HA.

FIGS. 21A-21D are line drawings of photographs showing the positive effects on corn seed germination and root development after treatment of the seeds with spores of growth promoting bacterial strain Bacillus licheniformis CH200 (2.5×10¹² cfu/Ha) in-furrow in combination with the insecticide, CAPTURE LFR, and a liquid fertilizer. A) Seeds treated at planting with CAPTURE LFR, liquid fertilizer, and Bacillus licheniformis CH200 spores 7 days after planting; B) Control seeds treated at planting with CAPTURE LFR and liquid fertilizer 7 days after planting; C) Seeds treated at planting with CAPTURE LFR, liquid fertilizer, and Bacillus licheniformis CH200 spores 14 days after planting; and D) Control seeds treated at planting with CAPTURE LFR and liquid fertilizer 14 days after planting. The substantially increased root growth and the substantially increased size of the plant treated with CH200 in combination with CAPTURE LFR in FIG. 21A and FIG. 21C, respectively, relative to the control plants demonstrates the positive effect on seed germination and early plant growth and vigor provided by treatment with the CH200 spores.

FIGS. 22A-22B are line drawings of photographs taken 24 days after planting that are showing the positive effects on root development in corn seedlings in a field trial after treatment of the corn seeds in-furrow upon planting with spores of growth promoting bacterial strain Bacillus licheniformis CH200 (2.5×10¹² cfu/Ha) in combination with the insecticide, CAPTURE LFR, and a liquid fertilizer. A) Control plants treated with CAPTURE LFR and liquid fertilizer; and B) Plants treated with CAPTURE LFR, liquid fertilizer, and Bacillus licheniformis CH200 spores. The substantially increased root growth and the substantially increased size of the plant treated with CH200 in combination with CAPTURE LFR shown in FIG. 22B relative to the control plant demonstrates the positive growth effect on plant growth and vigor provided by treatment with the CH200 spores.

FIGS. 23A-23C are images showing the positive effects on root development in corn in a field trial after treatment of the corn seeds in-furrow upon planting with spores of growth promoting bacterial strain Bacillus licheniformis CH200 (2.5×10¹² cfu/Ha) in combination with the insecticide, CAPTURE LFR, and a liquid fertilizer. A) Roots of an uprooted corn plant 35 days after in-furrow treatment of the corn seed at planting with liquid fertilizer; B) Roots of an uprooted corn plant 35 days after in-furrow treatment of the corn seed at planting with liquid fertilizer and CAPTURE LFR; and C) Roots of an uprooted corn plant 35 days after in-furrow treatment of the corn seed at planting with liquid fertilizer, CAPTURE LFR, and Bacillus licheniformis CH200 spores. The substantially increased root mass, especially with regard to the secondary roots, for the plant treated with CH200 in combination with CAPTURE LFR shown in FIG. 23C relative to the control plants demonstrates the positive growth effect provided by treatment with the CH200 spores.

FIGS. 24A-24F are line drawings of photographs showing the positive effects on growth in corn in a field trial after treatment of the corn seeds upon planting with spores of growth promoting bacterial strain Bacillus licheniformis CH200 (2.5×10¹² cfu/Ha) in combination with the insecticide, CAPTURE LFR, and a liquid fertilizer. A) A leaf of a corn plant 35 days after in-furrow treatment of seed at planting with CAPTURE LFR, liquid fertilizer, and Bacillus licheniformis CH200 spores at 2.5×10¹² CFU/hectare, as compared to, B) a leaf of a control plant after the same in-furrow treatment of seed at planting, but without Bacillus licheniformis CH200 spores. C) An uprooted corn plant 35 days after in-furrow treatment of seed at planting with CAPTURE LFR, liquid fertilizer, and Bacillus licheniformis CH200 spores at 2.5×10¹² CFU/hectare, as compared to, D) an uprooted control corn plant after the same in-furrow treatment of seed at planting, but without Bacillus licheniformis CH200 spores. E) A stalk of a corn plant 35 days after in-furrow treatment of seed at planting with CAPTURE LFR, liquid fertilizer, and Bacillus licheniformis CH200 spores at 2.5×10¹² CFU/hectare, as compared to, F) a stalk of a control corn plant after the same in-furrow treatment of seed at planting, but without Bacillus licheniformis CH200 spores. The substantial increase in leaf size, overall plant size, and plant stalk width for the plants treated with CH200 in combination with CAPTURE LFR shown in FIGS. 24A, 24C, and 24E, respectively, relative to the control plants demonstrates the positive effect on plant growth and vigor provided by treatment with the CH200 spores.

### Example 17

### Growth Effects of Bacillus Licheniformis CH200 on Potato Plants Grown in Nematode-Infected Soil

In this experiment, the effect of application of the bacterial isolate Bacillus Licheniformis CH200 on growth and vigor for potato plants grown in nematode infected soil (Globedera sp., approximately 1750 live eggs and juveniles per 100 ml soil) was determined. Potatoes (variety “Bintje”) were planted in soil infected with Globodera sp. and enhanced with or drip irrigated with 10E⁺⁹ cfu spores per liter soil of Bacillus licheniformis strain CH200. Images of the plants after 48 days of growth in a greenhouse are shown in FIGS. 25A-25B. FIG. 25A shows the plants treated with CH200 and FIG. 25B shows the control plants that were not treated with the CH200 spores. The increased size of the plants treated with CH200 relative to the control plants demonstrates the positive growth effect provided by treatment with the CH200 spores.

### Example 18

### Growth Effects of Bacillus Licheniformis CH200 on Soybean in Field Trials

The following experiments were performed to measure the effect of Bacillus licheniformis CH200 on soybean plant growth when applied in furrow with seed at planting in combination with application of a liquid insecticide and a liquid fertilizer in field conditions.

Spores of the CH200 strain were applied in furrow as a liquid in combination with an insecticide and fertilizer to soybean seed in field trials. The insecticide (CAPTURE LFR (bifenthrin); FMC Corporation, Philadelphia, Pa.) was applied at 112 g Ai/HA.

FIGS. 26A-26B are photographs taken 14 days after planting and showing the positive effects on growth in soybean seedlings in a field trial after treatment of the soy seeds in-furrow upon planting with spores of growth promoting bacterial strain Bacillus licheniformis CH200 (2.5×10¹² cfu/Ha) in combination with the insecticide, CAPTURE LFR, and a liquid fertilizer. A) Three plants on the left were treated with CAPTURE LFR, liquid fertilizer, and Bacillus licheniformis CH200 spores; and B) Three control plants on the right were treated with CAPTURE LFR and liquid fertilizer. The substantially increased size of the plants treated with CH200 relative to the control plants demonstrates the positive effect on early growth and vigor provided by treatment with the CH200 spores.

All publications, patent applications, patents, and other references cited herein are incorporated herein by reference in their entireties.

That which is claimed:

1. A product comprising: a first container containing a first composition comprising at least one biologically pure culture of a bacterial strain having plant growth promoting properties; and a second container containing a second composition comprising at least one pesticide, wherein each of the first and second compositions is in a formulation compatible with a liquid fertilizer.

2. The product of claim 1 wherein the pesticide is an insecticide, a fungicide, an herbicide, or a nematicide.

3. The product of claim 1 wherein the pesticide is a soil insecticide selected from the group consisting of Pyrethroids, bifenthrin, tefluthrin, cypermethrin, zeta-cypermethrin, lambda-cyhalothrin, gamma-cyhalothrin, deltamethrin, cyfluthrin, alphacypermethrin, permethrin; Organophosphates, chlorpyrifos-ethyl, tebupirimphos, terbufos, ethoprophos, cadusafos; Nicotinoids, imidacloprid, thiamethoxam, clothianidin, Carbamates, thiodicarb, oxamyl, carbofuran, carbosulfan, Fiproles, fipronil, and ethiprole.

4. The product of claim 1 wherein the pesticide is bifenthrin.

5. The product of claim 4 wherein the second composition further comprises a hydrated aluminum-magnesium silicate, and at least one dispersant selected from the group consisting of a sucrose ester, a lignosulfonate, an alkylpolyglycoside, a naphthalenesulfonic acid formaldehyde condensate and a phosphate ester.

6. The product of claim 1 wherein at least one bacterial strain is in the form of spores or vegetative cells.

7. The product of claim 1 wherein at least one bacterial strain is a strain of Bacillus.

8. The product of claim 7 wherein at least one Bacillus is a Bacillus pumilus, a Bacillus licheniformis, or a combination thereof.

9. The product of claim 7 wherein at least one Bacillus is Bacillus pumilus RTI279 (ATCC Accession No. PTA-121164).

10. The product of claim 9 wherein at least one Bacillus pumilus RTI279 is present at a concentration of from 1.0×10⁹ CFU/g to 1.0×10¹² CFU/g.

11. The product of claim 7 wherein at least one Bacillus is Bacillus licheniformis CH200 (DSMZ Accession No. DSM 17236).

12. The product of claim 11 wherein at least one Bacillus licheniformis CH200 is present at a concentration of from 1.0×10⁹ CFU/g to 1.0×10¹² CFU/g.

13. A product comprising: a first container containing a first composition comprising a biologically pure culture of a Bacillus licheniformis CH200 (DSMZ Accession No. DSM 17236); and a second container containing a second composition comprising bifenthrin, wherein each of the first and second compositions is in a formulation compatible with a liquid fertilizer.

14. The product of claim 13 wherein the second composition further comprises a hydrated aluminum-magnesium silicate, and at least one dispersant selected from the group consisting of a sucrose ester, a lignosulfonate, an alkylpolyglycoside, a naphthalenesulfonic acid formaldehyde condensate and a phosphate ester.

15. A composition comprising a) a biologically pure culture of at least one bacterial strain having plant growth promoting properties, and b) at least one pesticide, wherein the composition is in a formulation compatible with a liquid fertilizer.

16. The composition of claim 15 wherein the pesticide is an insecticide, a fungicide, an herbicide, or a nematicide.

17. The composition of claim 15 wherein the pesticide is a soil insecticide selected from the group consisting of a Pyrethroid, bifenthrin, tefluthrin, cypermethrin, zeta-cypermethrin, lambda-cyhalothrin, gamma-cyhalothrin, deltamethrin, cyfluthrin, alphacypermethrin, permethrin; Organophosphates, chlorpyrifos-ethyl, tebupirimphos, terbufos, ethoprophos, cadusafos; Nicotinoids, imidacloprid, thiamethoxam, clothianidin, Carbamates, thiodicarb, oxamyl, carbofuran, carbosulfan, Fiproles, fipronil, and ethiprole.

18. The composition of claim 15 wherein the pesticide is bifenthrin.

19. The composition of claim 15 wherein at least one bacterial strain is in the form of spores or vegetative cells.

20. The composition of claim 15 wherein at least one bacterial strain is a strain of Bacillus.

21. The composition of claim 20 wherein at least one Bacillus is a Bacillus pumilus, a Bacillus licheniformis, or a combination thereof.

22. The composition of claim 20 wherein at least one Bacillus is Bacillus pumilus RTI279 (ATCC Accession No. PTA-121164).

23. The composition of claim 22 wherein at least one Bacillus pumilus RTI279 is present at a concentration of from 1.0×10⁹ CFU/g to 1.0×10¹² CFU/g.

24. The composition of claim 20 wherein at least one Bacillus is Bacillus licheniformis CH200 (DSMZ Accession No. DSM 17236).

25. The composition of claim 24 wherein at least one Bacillus licheniformis CH200 is present at a concentration of from 1.0×10⁹ CFU/g to 1.0×10¹² CFU/g.

26. A method for benefiting plant growth comprising delivering to a plant or a part thereof in a liquid fertilizer a composition comprising:
a) a biologically pure culture of at least one bacterial strain having plant growth promoting properties, and b) a soil insecticide, wherein each of the bacterial strain and the soil insecticide is present in an amount sufficient to benefit plant growth,
wherein the composition is delivered in the liquid fertilizer in an amount suitable for benefiting plant growth to: seed of the plant, roots of the plant, a cutting of the plant, a graft of the plant, callus tissue of the plant, soil or growth medium surrounding the plant, soil or growth medium before sowing seed of the plant in the soil or growth medium, or soil or growth medium before planting the seed of the plant, the plant cutting, the plant graft, or the plant callus tissue in the soil or growth medium.

27. The method of claim 26 wherein at least one bacterial strain is in the form of spores or vegetative cells.

28. The method of claim 26 wherein at least one bacterial strain is a strain of Bacillus.

29. The method of claim 26 wherein at least one bacterial strain is Bacillus pumilus RTI279 (ATCC Accession No. PTA-121164) or Bacillus licheniformis CH200 (DSMZ Accession No. DSM 17236) or a combination thereof.

30. The method of claim 26 wherein the soil insecticide is bifenthrin.
